(19) United States
(12) Patent Application Publication
(10) Pub. No.: US 2026/0303420 A1
(43) Pub. Date: Oct. 1, 2026

(54) AMBIENT POWER SYNCHRONIZATION FIELD

(71) Applicant: QUALCOMM Incorporated, San Diego, CA (US)

(72) Inventors: Stephen Jay SHELLHAMMER, Ramona, CA (US); Jialing Li CHEN, San Diego, CA (US); Pooria PAKROOH, San Diego, CA (US); Manideep DUNNA, San Jose, CA (US); Bin TIAN, San Diego, CA (US)

(21) Appl. No.: 19/635,598

(22) Filed: Mar. 31, 2026

Related U.S. Application Data
(60) Provisional application No. 63/781,930, filed on Apr. 1, 2025.
(60) Provisional application No. 63/822,058, filed on Jun. 11, 2025.
(60) Provisional application No. 63/837,098, filed on Jul. 1, 2025.
(60) Provisional application No. 63/841,243, filed on Jul. 9, 2025.
(60) Provisional application No. 63/866,929, filed on Aug. 19, 2025.
(60) Provisional application No. 63/895,655, filed on Oct. 8, 2025.

(51) Int. Cl. H04L 27/04; H04L 27/26

(52) U.S. Cl. CPC H04L 27/04; H04L 27/2602

(57) ABSTRACT

This disclosure provides methods, components, devices and systems that relate to a synchronization field design for downlink communication and uplink communication of the PPDU. In some examples, the STA may obtain a PPDU comprising at least a synchronization field and a data field. The synchronization field may include a sequence of on symbols and off symbols, and the sequence may include three consecutive on symbols or three consecutive off symbols. In some examples, the sequence does not include four or more consecutive off symbols or four or more consecutive on symbols. The STA may synchronize parameters based on the synchronization field and decode the data field of the PPDU based on the parameters.

### CROSS REFERENCE

This present Application for Patent claims benefit of U.S. Provisional Patent Application No. 63/781,930 by SHELLHAMMER et al., entitled “AMBIENT POWER SYNCHRONIZATION FIELD,” filed Apr. 1, 2025, U.S. Provisional Patent Application No. 63/822,058 by SHELLHAMMER et al., entitled “AMBIENT POWER SYNCHRONIZATION FIELD,” filed Jun. 11, 2025, U.S. Provisional Patent Application No. 63/837,098 by SHELLHAMMER et al., entitled “AMBIENT POWER SYNCHRONIZATION FIELD,” filed Jul. 1, 2025, U.S. Provisional Patent Application No. 63/841,243 by SHELLHAMMER et al., entitled “AMBIENT POWER SYNCHRONIZATION FIELD,” filed Jul. 9, 2025, U.S. Provisional Patent Application No. 63/866,929 by SHELLHAMMER et al., entitled “AMBIENT POWER SYNCHRONIZATION FIELD,” filed Aug. 19, 2025, and U.S. Provisional Patent Application No. 63/895,655 by SHELLHAMMER et al., entitled “AMBIENT POWER SYNCHRONIZATION FIELD,” filed Oct. 8, 2025, each of which is assigned to the assignee hereof, and each of which is expressly incorporated by reference in its entirety herein.

### AMBIENT POWER SYNCHRONIZATION FIELD

### Technical Field

This disclosure relates generally to wireless communication and, more specifically, to an ambient power synchronization field.

### Description of the Related Technology

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method. The method may include obtaining a physical layer protocol data unit (PPDU) including at least a synchronization field and a data field, the synchronization field including a sequence of on symbols and off symbols, where the sequence includes three consecutive on symbols or three consecutive off symbols, synchronizing one or more parameters based on the synchronization field, and decoding the data field of the PPDU based on the one or more parameters.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to obtain a PPDU including at least a synchronization field and a data field, the synchronization field including a sequence of on symbols and off symbols, where the sequence includes three consecutive on symbols or three consecutive off symbols, synchronize one or more parameters based on the synchronization field, and decode the data field of the PPDU based on the one or more parameters.

Another innovative aspect of the subject matter described in this disclosure can be implemented in an apparatus for wireless communications. The apparatus may include means for obtaining a PPDU including at least a synchronization field and a data field, the synchronization field including a sequence of on symbols and off symbols, where the sequence includes three consecutive on symbols or three consecutive off symbols, means for synchronizing one or more parameters based on the synchronization field, and means for decoding the data field of the PPDU based on the one or more parameters.

Another innovative aspect of the subject matter described in this disclosure can be implemented in a non-transitory computer-readable medium storing code for wireless communications. The code may include instructions executable by one or more processors to obtain a PPDU including at least a synchronization field and a data field, the synchronization field including a sequence of on symbols and off symbols, where the sequence includes three consecutive on symbols or three consecutive off symbols, synchronize one or more parameters based on the synchronization field, and decode the data field of the PPDU based on the one or more parameters.

In some examples of the method, apparatus, and non-transitory computer-readable medium described herein, the sequence does not include four or more consecutive off symbols or four or more consecutive on symbols.

In some examples of the method, apparatus, and non-transitory computer-readable medium described herein, the sequence includes one or more of a base sequence or a logical complement of the base sequence.

In some examples of the method, apparatus, and non-transitory computer-readable medium described herein, at least one of: the sequence includes a pattern of one or more instances of the base sequence and one or more instances of the logical complement of the base sequence, or the pattern indicates a size of the data field.

In some examples of the method, apparatus, and non-transitory computer-readable medium described herein, the base sequence includes an equal quantity of off symbols and on symbols.

In some examples of the method, apparatus, and non-transitory computer-readable medium described herein, a length of the base sequence is an even quantity of symbols.

In some examples of the method, apparatus, and non-transitory computer-readable medium described herein, a first symbol of the sequence is an on symbol.

In some examples of the method, apparatus, and non-transitory computer-readable medium described herein, the sequence may be associated with a first data rate used to communicate the PPDU or a logical complement of the sequence may be associated with a second data rate used to communicate the PPDU.

Some examples of the method, apparatus, and non-transitory computer-readable medium described herein may further include operations, features, means, or instructions for decoding the sequence via a Manchester decoding algorithm after obtaining the sequence.

In some examples of the method, apparatus, and non-transitory computer-readable medium described herein, one or more transceivers may be configured to output the PPDU and the apparatus may be configured as a station.

Another innovative aspect of the subject matter described in this disclosure can be implemented in a method. The method may include generating a PPDU including at least a synchronization field and a data field, where the synchronization field includes a sequence of on symbols and off symbols, where the sequence includes three consecutive on symbols or three consecutive off symbols and outputting the PPDU.

Another innovative aspect of the subject matter described in this disclosure can be implemented in an apparatus. The apparatus may include a processing system that includes processor circuitry and memory circuitry that stores code. The processing system may be configured to cause the apparatus to generate a PPDU including at least a synchronization field and a data field, where the synchronization field includes a sequence of on symbols and off symbols, where the sequence includes three consecutive on symbols or three consecutive off symbols and output the PPDU.

Another innovative aspect of the subject matter described in this disclosure can be implemented in an apparatus. The apparatus may include means for generating a PPDU including at least a synchronization field and a data field, where the synchronization field includes a sequence of on symbols and off symbols, where the sequence includes three consecutive on symbols or three consecutive off symbols and means for outputting the PPDU.

Another innovative aspect of the subject matter described in this disclosure can be implemented in a non-transitory computer-readable medium storing code for wireless communications. The code may include instructions executable by one or more processors to generate a PPDU including at least a synchronization field and a data field, where the synchronization field includes a sequence of on symbols and off symbols, where the sequence includes three consecutive on symbols or three consecutive off symbols and output the PPDU.

In some examples of the method, apparatus, and non-transitory computer-readable medium described herein, the sequence does not include four or more consecutive off symbols or four or more consecutive on symbols.

In some examples of the method, apparatus, and non-transitory computer-readable medium described herein, the sequence includes one or more of a base sequence or a logical complement of the base sequence.

In some examples of the method, apparatus, and non-transitory computer-readable medium described herein, at least one of: the sequence includes a pattern of one or more instances of the base sequence and one or more instances of the logical complement of the base sequence, or the pattern indicates a size of the data field.

In some examples of the method, apparatus, and non-transitory computer-readable medium described herein, the base sequence includes an equal quantity of off symbols and on symbols.

In some examples of the method, apparatus, and non-transitory computer-readable medium described herein, a length of the base sequence is an even quantity of symbols.

In some examples of the method, apparatus, and non-transitory computer-readable medium described herein, a first symbol of the sequence is an on symbol.

In some examples of the method, apparatus, and non-transitory computer-readable medium described herein, the sequence in the synchronization field may be one of a first candidate sequence associated with a first data rate associated with the PPDU, a second candidate sequence associated with a second data rate associated with the PPDU, or a third candidate sequence associated with a third data rate associated with the PPDU.

In some examples of the method, apparatus, and non-transitory computer-readable medium described herein, the first candidate sequence and the second candidate sequence may be the same.

In some examples of the method, apparatus, and non-transitory computer-readable medium described herein, a length of the first candidate sequence, the second candidate sequence, or the third candidate sequence may be scaled based on a symbol duration associated with the synchronization field.

In some examples of the method, apparatus, and non-transitory computer-readable medium described herein, the first candidate sequence, the second candidate sequence, and the third candidate sequence may have a same symbol duration and the first candidate sequence, the second candidate sequence, and the third candidate sequence each may have different lengths.

In some examples of the method, apparatus, and non-transitory computer-readable medium described herein, the first candidate sequence includes at least one of more than one copy of the third candidate sequence, a complement of the third candidate sequence, a reverse ordering of the third candidate sequence, or a bit-wise repetition of the third candidate sequence.

In some examples of the method, apparatus, and non-transitory computer-readable medium described herein, the first candidate sequence and the second candidate sequence include a same pattern of on symbols and off symbols and the third candidate sequence may be shorter in length than the first candidate sequence.

In some examples of the method, apparatus, and non-transitory computer-readable medium described herein, one or more transceivers may be configured to output the PPDU and the apparatus may be configured as a station.

One innovative aspect of the subject matter described in this disclosure can be implemented in a method. The method may include obtaining a trigger frame, generating, based on the trigger frame, a PPDU including at least a synchronization field and a data field, the synchronization field including a sequence of on symbols and off symbols, where the sequence does not include four consecutive off-symbols, and outputting the PPDU.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to obtain a trigger frame, generate, based on the trigger frame, a PPDU including at least a synchronization field and a data field, the synchronization field including a sequence of on symbols and off symbols, where the sequence does not include four consecutive off-symbols, and output the PPDU.

Another innovative aspect of the subject matter described in this disclosure can be implemented in an apparatus for wireless communications. The apparatus may include means for obtaining a trigger frame, means for generating, based on the trigger frame, a PPDU including at least a synchronization field and a data field, the synchronization field including a sequence of on symbols and off symbols, where the sequence does not include four consecutive off-symbols, and means for outputting the PPDU.

Another innovative aspect of the subject matter described in this disclosure can be implemented in a non-transitory computer-readable medium storing code for wireless communications. The code may include instructions executable by one or more processors to obtain a trigger frame, generate, based on the trigger frame, a PPDU including at least a synchronization field and a data field, the synchronization field including a sequence of on symbols and off symbols, where the sequence does not include four consecutive off-symbols, and output the PPDU.

In some examples of the method, apparatus, and non-transitory computer-readable medium described herein, the sequence does not include eight consecutive off symbols.

In some examples of the method, apparatus, and non-transitory computer-readable medium described herein, one or more transceivers may be configured to output the PPDU and the apparatus may be configured as a station.

Another innovative aspect of the subject matter described in this disclosure can be implemented in a method. The method may include outputting a trigger frame, obtaining a PPDU including at least a synchronization field and a data field, where the synchronization field includes a sequence of on symbols and off symbols, where the sequence does not includes four consecutive off symbols and outputting the PPDU, synchronizing one or more parameters based on the synchronization field, and decoding the data field of the PPDU based on the one or more parameters.

Another innovative aspect of the subject matter described in this disclosure can be implemented in an apparatus. The apparatus may include a processing system that includes processor circuitry and memory circuitry that stores code. The processing system may be configured to cause the apparatus to output a trigger frame, obtain a PPDU including at least a synchronization field and a data field, where the synchronization field includes a sequence of on symbols and off symbols, where the sequence does not includes four consecutive off symbols and outputting the PPDU, synchronize one or more parameters based on the synchronization field, and decode the data field of the PPDU based on the one or more parameters.

Another innovative aspect of the subject matter described in this disclosure can be implemented in an apparatus. The apparatus may include means for outputting a trigger frame, means for obtaining a PPDU including at least a synchronization field and a data field, where the synchronization field includes a sequence of on symbols and off symbols, where the sequence does not includes four consecutive off symbols and outputting the PPDU, means for synchronizing one or more parameters based on the synchronization field, and means for decoding the data field of the PPDU based on the one or more parameters.

Another innovative aspect of the subject matter described in this disclosure can be implemented in a non-transitory computer-readable medium storing code for wireless communications. The code may include instructions executable by one or more processors to output a trigger frame, obtain a PPDU including at least a synchronization field and a data field, where the synchronization field includes a sequence of on symbols and off symbols, where the sequence does not includes four consecutive off symbols and outputting the PPDU, synchronize one or more parameters based on the synchronization field, and decode the data field of the PPDU based on the one or more parameters.

In some examples of the method, apparatus, and non-transitory computer-readable medium described herein, the sequence does not include eight consecutive off symbols.

In some examples of the method, apparatus, and non-transitory computer-readable medium described herein, one or more transceivers may be configured to output the PPDU and the apparatus may be configured as an access point.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a frequency diagram depicting an example distributed tone mapping.

FIG. 5 shows a pictorial diagram of another example wireless communication network.

FIG. 6 shows an example of an ambient power PPDU that supports the ambient power synchronization field.

FIG. 7 shows an example of a block diagram of a synchronization field detector that supports the ambient power synchronization field.

FIG. 8 shows an example of a process clow that supports the ambient power synchronization field.

FIG. 9 shows a block diagram of an example wireless communication device that supports the ambient power synchronization field.

FIG. 10 shows a block diagram of an example wireless communication device that supports the ambient power synchronization field.

FIGS. 11 through 16 show flowcharts illustrating example processes performable by or at an AP that supports the ambient power synchronization field.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a receiving wireless device (such as, a station (STA)) may be a low power device. The low power device may be a backscatter device or a non-backscatter device. In some examples, the low power device may be referred to as an ambient power (AMP) device. Some low power devices may support transmission using on-off keying (OOK) waveforms. The AP and the lower power devices may communicate physical layer protocol data units (PPDUs) at one or more data rate (such as, up to 250 kilobit per second (kb/s), up to 1 Megabit per second (Mb/s), or 4 Mb/s). In some implementations, the PPDU may include a synchronization (SYNC) field prior to a data field. The SYNC field may be used for packet detection, timing estimate and correction, identifying the beginning of the data field, and automatic gain control (AGC). The low power devices may detect the SYNC field in downlink communications at different data rates and generate the SYNC field for uplink communications at different data rates. The low power devices may have difficulty detecting the SYNC field at different data rates.

Various aspects relate generally to the ambient power synchronization field. Some aspects more specifically relate to a SYNC field design for downlink communication and uplink communication of the PPDU. In some examples, the STA may obtain a PPDU comprising a SYNC field and a data field. The SYNC field may include a sequence of on symbols and off symbols, and the sequence may include three consecutive on symbols or three consecutive off symbols. In some examples, the sequence does not include four or more consecutive off symbols or four or more consecutive on symbols. In some examples, the sequence may be associated with a first data rate used to communicate the PPDU or a logical complement of the sequence may be associated with a second data rate used to communicate the PPDU. The STA may synchronize parameters based on the SYNC field and decode the data field of the PPDU based on the parameters. In some examples, the STA may generate and output a PPDU including the SYNC field and a data field.

Particular aspects of the subject matter described in this disclosure can be implemented to realize one or more of the following potential advantages. In some examples, by designing the SYNC field to include three consecutive on symbols or three consecutive off symbols, the described techniques can be used by low power devices to detect the SYNC field. In some examples, by designing the SYNC field to not include four consecutive on symbols or four consecutive off symbols, the described techniques can be used by low power devices to detect the SYNC field.

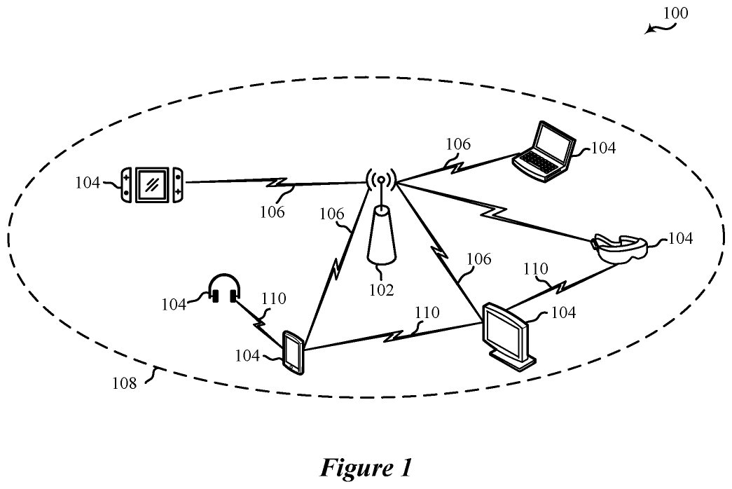

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. A wireless node may refer to a wireless communication device, such as an AP (such as AP 102) or a STA (such as 104) that communicates via the wireless communication network 100. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

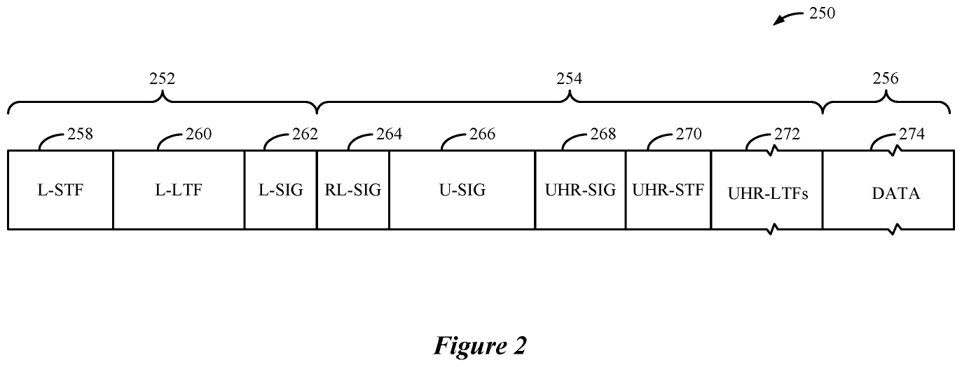

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (such as STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (such as a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (such as a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

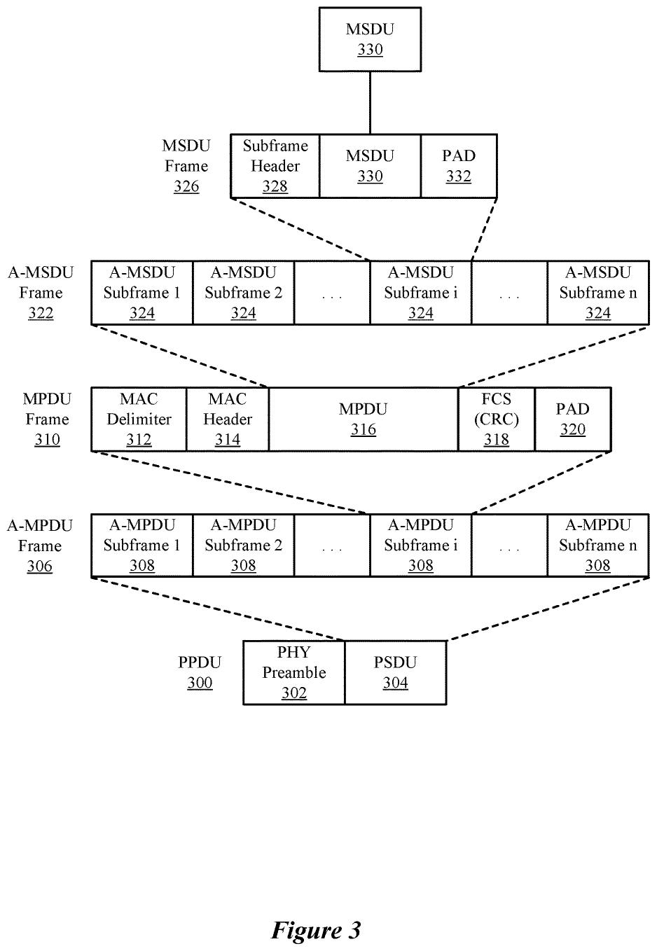

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

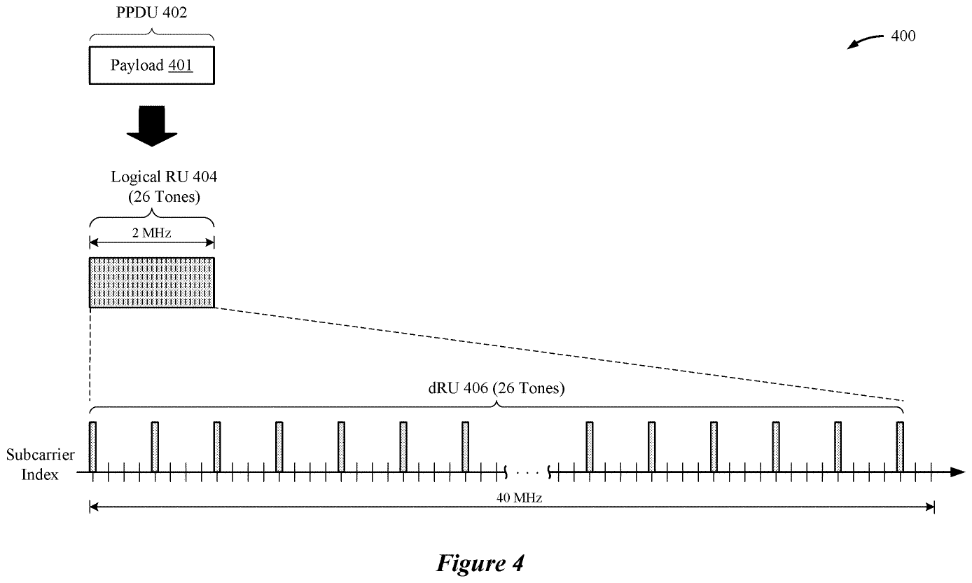

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHz subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

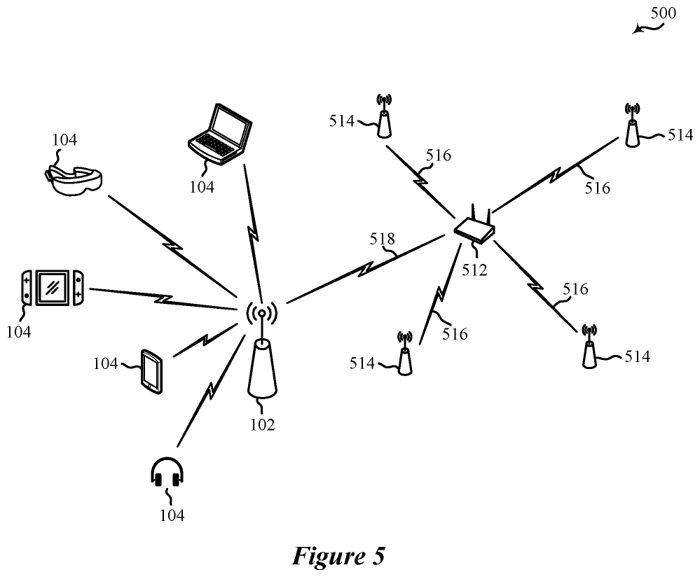

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

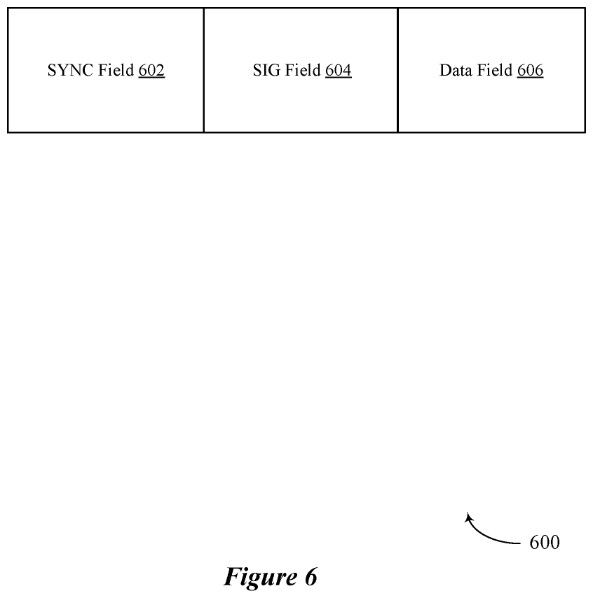

FIG. 6 shows an example of an AMP PPDU 600 that supports the ambient power synchronization field. The AMP PPDU 600 may implement, or be implemented by, aspects of FIGS. 1-5. For example, a device (such as, an AP and a STA), which may be examples of corresponding devices described with reference to FIGS. 1-5, may transmit and receive the AMP PPDU 600. In some examples, the device may be an example of an AP, or a reader device, among other examples. In some examples, the device may be an example of a STA, a low power device, an ultra-low power device, a backscatter device, a non-backscatter device, or a tag.

Some wireless communications systems may support low power or ultra-low power devices, which may be battery-less devices. Low power devices may include non-backscatter devices (such as, a micro-power STA, an active transmission STA, or an AMP assisted STAs, active transmission non-AP AMP STA, AMP enabled non-AP AMP STA, bistatic backscatter non-AP AMP STA) and backscatter devices (such as, a close-range monostatic backscatter device, or a bi-static backscatter device). A backscatter device may refer to a type of communication technology that enables wireless communication by reflecting existing communication signals, rather than generating new ones. Backscatter devices leverage ambient signals to transmit data, which can significantly reduce power consumption compared to non-backscatter communication techniques. The backscatter device may be an example of a passive or semi-passive device, and the backscatter device may communicate with another wireless communication device (such as AP or reader device) via backscatter. For example, the backscatter device may receive a waveform from the AP or reader device, which may activate the backscatter device, and the backscatter device may communicate by modulating a reflection of the received waveform rather than transmitting its own signal. Examples of backscatter devices may include various forms for RFID tags or other tags. The non-backscatter device, active transmission device, or AMP assisted STA may generate its own RF signals to transmit data. The non-backscatter device may have a power source, such as a battery, to generate the RF signals. Another type of non-backscatter device may not have a battery, and the device may harvest energy (such as, RF energy) and may store the harvested energy on a capacitor. The backscatter device may not have a power source, and the backscatter device may derive energy from the incident RF signal. Another type of AMP device may be a non-AP STA referred to as an AMP assisted STA. The active transmission device and the AMP assisted STA may be referred to as non-backscatter devices.

Downlink signaling to the backscatter device or the non-backscatter devices may support one or more data rates. For example, the backscatter device or the non-backscatter devices may support a first downlink data rate (such as, up to 1 Mb/s) or may support a second downlink data rate (such as, up to 250 kb/s). The first downlink data rate or the second downlink data rate may be the data rate used to communicate the AMP PPDU 600.

Some non-backscatter devices and backscatter devices may support receiving and transmitting the AMP PPDU 600. For uplink and downlink communications, the AMP PPDU 600 may include a SYNC field 602 prior to a data field 606. In some examples, the SYNC field 602 may be prior to a possible signaling (SIG) field 604. The SYNC field 602 may be used by the non-backscatter device or the backscatter device to synchronize one or more parameters prior to decoding the data field 606. For example, the SYNC field 602 may be used for packet detection, timing estimate and correction, identifying the beginning of the possible SIG field 604 (if present), identifying the beginning of the data field 606, automatic gain control (AGC), or a combination thereof. Some non-backscatter devices and backscatter devices may support transmissions using an on-off keying (OOK) waveform. For AGC, the SYNC field 602 may be used to derive a power threshold to classify the symbol as a “0” (such as low or OFF) or as a “1” (such as a high or ON) for the OOK signal.

The SYNC field 602 may be designed for downlink communications with low complexity for detection by the non-backscatter devices and the backscatter devices. The SYNC field may include a sequence of ON and OFF symbols that may be detected by the non-backscatter device and the backscatter device. The SYNC field 602 may be used for both uplink transmission of the AMP PPDU 600 by the non-backscatter devices and the backscatter devices and downlink reception of the AMP PPDU 600 by the non-backscatter devices and the backscatter devices. The SYNC field 602 may be designed to simplify the receiver complexity. The downlink communication of the AMP PPDU 600 may be transmitted a data rate of 1 Mb/s or 250 kb/s. The non-backscatter STAs may decode the AMP PPDUs the data rates of 1 Mb/s and 250 kb/s, and the non-backscatter devices may sample at 8 MHz. The non-backscatter STAs may be capable of detecting the SYNC field 602 at both the data rates of 1 Mb/s and 250 kb/s. The SYNC field 602 may include a sequence of on symbols and off symbols, and the symbols (or chips) may have a duration of 2 microseconds (2 μs). The 2 μs symbol duration may support multipath channels.

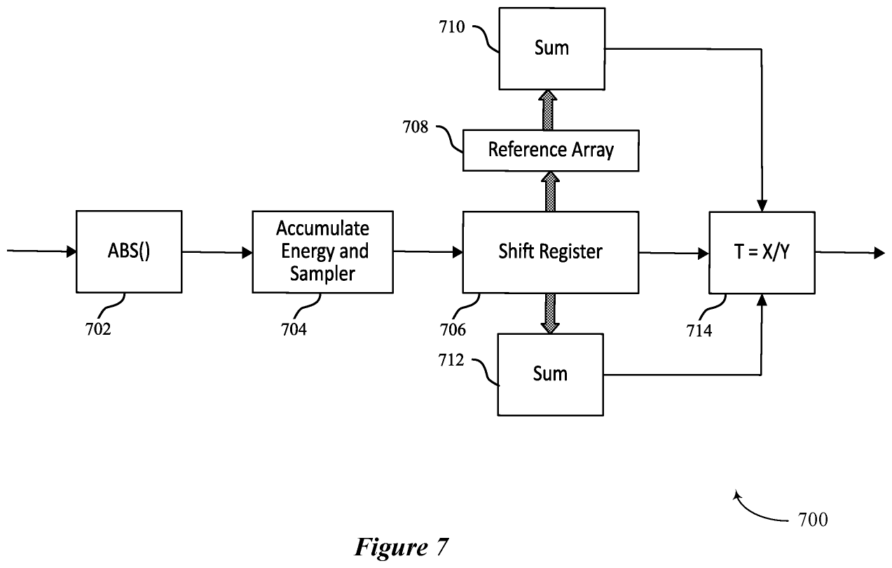

FIG. 7 shows an example of a block diagram 700 that supports the ambient power synchronization field. The block diagram 700 may implement, or be implemented by, aspects of FIGS. 1-6. For example, a receiving device (such as, an AP and a STA), which may be examples of corresponding devices described with reference to FIGS. 1-6, may perform wireless communications in accordance with the block diagram 700. In some examples, the receiving device may be an example of an AP, or a reader device, among other examples. In some examples, the receiving device may be an example of a STA, a backscatter device, a non-backscatter device.

The block diagram 700 shows an example of a SYNC field detector. The SYNC field detector may include an envelope detector (ABS( ) 702) that extracts an outline of a modulated signal. The accumulate energy and sampler 704 may generate samples from the outline of the modulated signals. A shift register 706 may accumulate the samples, and the samples corresponding to the SYNC field may fill the shift register 706. The accumulated samples or the sequence of on symbols or off symbols of the SYNC field may be compared to a reference array 708. The energy of the accumulated samples may be generated at a Sum block 710 and Sum block 712. The value T at block 714 may indicate whether the modulated signal is likely a SYNC field if the value T is high and whether the modulate signal is unlikely the SYNC field if the value Tis low. The SYNC field detector may include complexity of a shift register length and a quantity of additions and subtractions for calculating variables X and Y. The division step of block 716 may not be implemented and may be replaced by a multiplication in an implementation.

To support the SYNC field detector identifying the SYNC field 602, the shift register 706 may have a length sufficient for the SYNC field 602 associated with a data field 606 communicated at the 250 kb/s data rate. The SYNC field 602 may be represented by a sequence of on symbols and off symbols. The SYNC field 602 may be represented by the variable W. Since the shift register 706 supports detection of the bit sequence W, the full shift register may be used for the sequence associated with a data field 606 communicated at the 1 Mb/s data rate or the 1 Mb/s PPDU. The complementary binary sequence of W (W̅) may be used for the sequence of the SYNC field for the 1 Mb/s PPDU, where W̅ is the complementary binary sequence of W, or the logical complement of W, such as W̅=1−W. The complexity may be minimized using W̅ because the sign of X of the SYNC field detector may be changed after calculating X for the sequence W. In some examples, the sequence of on symbols and off symbols associated with the 250 kb/s data rate may be represented by W, and the sequence of on symbols and off symbols associated with the 1 Mb/s data rate may be W̅ or the complementary binary sequence of W. The sequences W and W̅ may reduce the receiver complexity. The length of the SYNC field for the 1 Mb/s PPDU may slightly increase the PPDU duration. A length of a field (including the SYNC field) may refer to a quantity of symbols (e.g., sometimes referred to as chips instead of symbols) in the field. A duration of a field (including the SYNC field) may refer to an amount of time it takes to communicate the field and may be based on the quantity of symbols in the field and duration of each symbol in the field. For example, with a given length-32 sequence (e.g., 32 symbols or chips), the symbol duration may be 2 us, 1 us, 0.5 us, 0.25 us or 0.125 us. In such an example, the duration of the field (e.g., the SYNC field) may be 32*2-64 us, 32*1=32 us, 32*0.5 us=16 us, 32*0.25 us=8 us, or 32*0.125 us=4 us.

To support transmission of the AMP PPDU 600, an AMP AP may transmit the data field 606 of the AMP PPDU 600 at the 250 kb/s data rate or at the 1 Mb/s data rate. For the 250 kb/s PPDU, the data field 606 may have a 2 μs chip duration (such as, symbol duration), and the AMP AP may generate the SYNC field 602 with the 2 μs chip duration and a length N sequence W. For the 1 Mb/s PPDU, the data field 606 may have a 0.5 μs chip duration (such as, symbol duration), and the AMP AP may generate the SYNC field 602 with the 0.5 μs chip duration or the 2 μs chip duration. In some aspects, the AMP AP may generate the SYNC field with the 2 μs chip duration and a length N sequence W̅. The 2 μs chip duration for the SYNC field may provide a unified SYNC field generation for the different data rates of 250 kb/s and 1 Mb/s and may provide more robust timing offset. In some aspects, the AMP AP may generate the SYNC field with the 0.5 μs chip duration and a length N sequence W̅ with bit-wise (such as, chip-wise) 4× repetition, so that one bit in the sequence is mapped to 4 chips (symbol durations) with total duration of 2 μs. The 0.5 μs chip duration for the SYNC field of the 1 Mb/s PPDU may provide a unified SYNC field and data field generation for the 1 Mb/s PPDU and may provide waveform transition between the chips making it less robust to timing offset.

The downlink SYNC field sequence design for W and W̅ may consider one or more properties. If the downlink SYNC field sequence is not based on a Manchester-OOK design, downlink SYNC field sequence design for W may have a property of good autocorrelation. For example, with a same correlator of R=2*W−1, W and W̅ may have uneven correlation performance. W with better correlation performance may be used for 250 kb/s due to a lower operating signal-to-noise ratio (SNR). W̅ with worse correlation performance may be used for 1 Mb/s due to higher operating SNR. The SYNC sequence may be designed to minimize the negative sidelobes in the auto-correlation <W, R> to minimize a false alarm of W̅ detection and to minimize the positive sidelobes in the cross-correlation <W̅, R> to minimize the false alarm of W detection. If the downlink SYNC field sequence is not based on a Manchester-OOK design, downlink SYNC field sequence design for W may have an invalid Manchester pattern, such as at least one sequence of three “Ones” or ON symbols in a row and at least one sequence of three “Zeros” or OFF symbols in a row. For example, the sequence W may include three consecutive on symbols or three consecutive off symbols. In some examples, the sequence may not have more than three consecutive “Ones” (for W̅) or more than three consecutive “Zeros” (for W) as four “Zeros” may be a silence of 8 μs and may result in loss of the channel. For example, the sequence may not include four or more consecutive off symbols or four or more consecutive on symbols. One example for the downlink SYNC field may be a 32-bit W sequence or a 32-bit W sequence.

The downlink SYNC field sequence design for W and W̅ may consider one or more properties. If the downlink SYNC field sequence is based on a Manchester-OOK design, the downlink SYNC field sequence design for W may have a property of good autocorrelation. For example, with a same correlator of R=2*W−1, W and W̅ may have uneven correlation performance. W with better correlation performance may be used for 250 kb/s due to a lower operating signal-to-noise ratio (SNR). W̅ with worse correlation performance may be used for 1 Mb/s due to higher operating SNR. The SYNC sequence may be designed to minimize the negative sidelobes in the auto-correlation <W, R> to minimize the false alarm of W̅ detection and to minimize the positive sidelobes in the cross-correlation <W̅, R> to minimize the false alarm of W detection. If the downlink SYNC sequence is based on a Manchester-OOK design, Manchester encoding may be performed to generate W=Manchester(w) of length-(2N), and the Man-OOK sequence may be changed to include an invalid Manchester pattern, such as three “Ones” or three “Zeros”, but no four or more “Zeros”. The invalid Manchester pattern may be applied by appending a short sequence that includes at least an invalid Manchester pattern, such as three “Ones”, three “Zeros”, 1110, 0001, 01110, 10001, 000111, 111000, at the end of the Manchester-OOK sequence. The invalid Manchester pattern may be applied by finding, in the bit sequence w, a string of three bits where the first and the last bits are the same and for the encoding of middle bit, use either ‘00’ or ‘11’ instead of Manchester encoding. For example, the 3-bit sequence may be ‘1x1’, where x may be 0 or 1, and after Manchester encoding, the first and last bits become ‘01’ and ‘01’ and not performing Manchester encoding for the middle bit ‘x’ but use either ‘00’ (to get ‘010001’ which includes ‘000’) or ‘11’ (to get ‘011101’ which includes ‘111’). For example, the 3-bit sequence may be ‘0x0’, where x may be 0 or 1, and after Manchester encoding, the first and last bits become ‘10’ and ‘10’ and not performing Manchester encoding for the middle bit ‘x’, but use either ‘00’ to get ‘100010’ which includes ‘000’) or ‘11’ (to get ‘101110’ which includes ‘111’).

In some examples, two different types of downlink SYNC fields may be generated for different receiving devices. One type of downlink SYNC field may be generated for downlink transmission to non-backscatter devices, such as active transmitters or AMP assisted STAs, operating at low SNR. For the non-backscatter devices, the downlink SYNC field sequence may include three consecutive on symbols or three consecutive off symbols. In some examples, the sequence may not include four or more consecutive off symbols. For the non-backscatter devices, the sequence design may be based on an assumption that the receiver processing is correlated based.

Another type of downlink SYNC field may be generated for downlink transmission to backscatter devices, operating at high SNR. Some downlink PPDUs may include a SIG field, a data field, and a SYNC field. The SYNC field may come before the SIG field and the data field. The SYNC field may be used for packet detection, timing estimate and correction, identifying the beginning of the possible SIG field (if present) and data field, AGC (deriving a power threshold to classify the symbol as a “0” (such as low or OFF) or as a “1” (such as a high or ON) for the OOK signal).

Backscatter devices (such as AMP backscatter devices) may use a low power receiver to receive downlink signals because one or more circuits of the backscatter devices may be powered by harvested energy. Downlink communications to backscatter devices may have a higher signal-to-noise-ratio. Due to these conditions, a relatively simple receiver with a simple comparator-based receiver to convert received RF signals to binary waveforms. A receiver in a backscatter device may include an envelope detector, an integrator, a comparator, a sampler, and a bit-level correlator. The envelope detector may obtain the RF signal. A first output signal of the envelope detector may go to the comparator and a second output signal may go to the integrator. The comparator may receive the first output signal and the second output signal and compare the received signal to a threshold. The threshold of the comparator may be obtained using the integrator to compute the average power of the signal and classify the RF signal as HIGH or LOW (hence the second output signal). The output of the comparator may be an example of a binary waveform. The sampler receives the binary waveform, samples the waveform, and outputs the samples to the bit-level correlator.

AMP downlink PPDU may include excitation signals prior to the SYNC field so that the backscatter devices (e.g., tags) may harvest energy before SYNC detection (and therefore power the components of the backscatter device). Downlink PPDUs may be communicated using different data rates, which may correspond to different symbol durations. In some cases, an example of the data rate for such downlink signals may be 250 kb/s. If a data rate of 250 kb/s is used, a downlink PPDU may have a 2 microsecond pulse duration for the SYNC field. In such cases, backscatter devices that use a 2 MHz sampling rate may have 4 samples per pulse. In some cases, the maximum OFF period permitted for the downlink signals may be less than 8 microseconds, such as 6 microseconds (e.g., three symbols of zeros if the symbol duration is 2 microseconds). After the OFF period, the downlink signaling may have at least one HIGH to LOW transition to help establish an average level of the signal. An integrator may have a time constant (or a memory) of some quantity of symbols (e.g., chips). In some cases, an integrator may have a memory size of any quantity of symbol durations (e.g., one symbol duration, two symbol durations, three symbol durations, four symbol durations, five symbol durations, six symbol durations, seven symbol durations, eight symbol durations, etc.). From an energy harvesting perspective, the SYNC sequence may need more ON pulses to charge the backscatter device. A Manchester coded sequence or a sequence with equal number of 1s and 0s may be designed to help provide energy to the backscatter device while also creating a distinguishing SYNC pattern.

In some examples, a SYNC sequence structure in downlink for backscatter devices may include two parts: an OFF delimiter and a sequence with equal ones and zeros. In some cases, the SYNC sequence may begin with multiple OFF symbols at the beginning and followed by a sequence with equal number of ON and OFF symbols for threshold estimation. The OFF delimiter may be used to indicate the beginning of the SYNC field (as ON symbols may be communicated before to allow the backscatter device to harvest energy). The sequence with equal ones and zeros may be used to communicate information and to allow the backscatter device to continue to harvest energy. The length of the SYNC sequence may be based on a symbol length of the memory of the integrator. For instance, in situations where an integrator has a memory of two symbol durations, possible examples of SYNC sequences may include 0010 and 00010. In each of these examples, the OFF delimiter is either two OFF symbols (e.g., 0s) or three OFF symbols (e.g., 0s) and the sequence of equal quantity of ones and zeros is two symbols (because the integrator has a memory of two symbols). In other instances, in situations where an integrator has a memory of four symbol durations, possible examples of SYNC sequences may include 001010, 001100, 0001010, 0001100. In each of these examples, the OFF delimiter is either two OFF symbols (e.g., 0s) or three OFF symbols (e.g., 0s). In each of these examples, the OFF delimiter is either two OFF symbols (e.g., 0s) or three OFF symbols (e.g., 0s) and the sequence of equal quantity of ones and zeros is four symbols (because the integrator has a memory of four symbols). While specific examples of lengths of SYNC sequences are shown, other SYNC sequences and other lengths of SYNC sequences are included in the scope using the principles described herein.

In some cases, the SYNC sequence may begin with a single OFF symbol at the beginning and followed by a sequence using Manchester encoded sequences. In such cases, the SYNC sequence may start with a single OFF symbol followed by any number of symbols that results in an even number of symbols (to comply with Manchester encoding). Because the SYNC sequence starts with an OFF symbol, the second symbol is likely to be an ON symbol. The length of the SYNC sequence may be based on a symbol length of the memory of the integrator. For instance, in situations where an integrator has a memory of eight chip durations. A single bit in a Manchester encoding scheme may be considered to include two chips. Said another way, the integrator may have a memory of four symbol durations. In such cases, possible examples of SYNC sequences may include 01010101, 01010110, 01011001, 01011010, 01100101, 01100110, 01101001, and 01101010. While specific examples of lengths of SYNC sequences are shown, other SYNC sequences and other lengths of SYNC sequences are included in the scope using the principles described herein.

For some backscatter devices, the downlink SYNC sequence may include three consecutive on symbols or three consecutive off symbols and a shorter sequence W than the sequence for the non-backscatter devices. The SYNC sequence may be shorter than the downlink transmission to non-backscatters because the backscatter device operate at high SNR. In some examples, the sequence may be generated by assuming the receiving processing is sequence matching based (such as, by directly comparing the scaled received signal power or energy to determine a match to the sequence) and deriving the short SYNC sequence based on some characteristics. For example, the SYNC sequence may be [X W Y] for the 250 kb/s data rate and [X W̅ Y] for the 1 Mb/s data rate. The SYNC sequence may be determined by starting with a known pattern X to indicate the start of the SYNC field, such as, one or more 0's, [0011], followed by W̅ for 250 kb/s and W for 1 Mb/s using the downlink SYNC sequence approach as described above with shorter length, and ending with a short valid Manchester-OOK sequence Y (such as, [01], [10], [0101], [1010]) to indicate the timing for Manchester decoding in data field. The SYNC sequence may not contain a string of four or more zeros in either sequence [X W Y] or [X W̅ Y]. In some examples, the downlink preamble before the SYNC field 602 may be considered as a preceding all 1s sequence.

For rate 1/2 Manchester encoding, if an input bit is 0, the output bit sequence is (such as, “ON OFF” in Manchester-OOK), and if the input bit is 1, the output bit sequence is (such as, “OFF ON” in Manchester-OOK). For decoding the Manchester encoded bit sequence, if an input bit is [10] (such as, “ON OFF” in Manchester-OOK), the output bit is 0, and if the input bit sequence is (such as, “OFF ON” in Manchester-OOK), the output bit is 1.

The uplink SYNC field sequence design may consider one or more properties. The uplink transmissions from the non-backscatter device or the backscatter device may be triggered based transmissions where the data rates and assigned time slots are indicated in a Trigger frame from the AMP AP, where the uplink transmissions are not expected to have collisions with other packets, and the timing of packet arrival may be known even if some clock drift may be present. The receiver (such as the AMP AP) of the uplink transmission from the non-backscatter device or the backscatter device may have a much higher sampling rate and more sophisticated receiver (such as coherent or non-coherent) than the non-backscatter device or the backscatter device. Three data rates may be supported in uplink transmission. The two data rates of 250 kb/s and 1 Mb/s are the same as the downlink data rates, and both the non-backscatter device or the backscatter device may support the 250 kb/s and 1 Mb/s data rates. A third data rate of 4 Mb/s may be supported by the non-backscatter devices (such as, active transmitters, AMP assisted STAs), and the 4 Mb/s data rate may not be supported by the backscatter devices.

The uplink SYNC field sequence design for the backscatter devices may consider one or more properties. Similar to downlink, the chip durations in the data field are 2 μs and 0.5 μs for 250 kb/s and 1 Mb/s, respectively, for the backscatter devices. In general, maintaining the chip duration in the SYNC field as the same as chip duration in the data field may maintain the bandwidth as different chip durations for the SYNC field and the data field may lead to bandwidth change. Maintaining the same chip duration in the SYNC field and the data field may reduce a possible problem of the receiver having an AP receiver filter of 20 MHz and a baseband filter of narrower size to fit the bandwidth of different data rates.

The chip durations in the SYNC field may be the same as the data field, so the chip durations in the SYNC field may be 2 μs and 0.5 μs for 250 kb/s and 1 Mb/s, respectively, for the backscatter devices. In some examples, the sequence for the SYNC field may be designed as one sequence for both the 250 kb/s and 1 Mb/s data rates. In some examples, the sequence for the SYNC field for 250 kb/s data rate may be different from the sequence for the 1 Mb/s data rate where the sequences for the different data rates may have different lengths or may have the same length but a different sequence (such as a different pattern of on symbols and off symbols). The cross-correlation property between the two sequences described for the downlink sequence design may not be considered for uplink because the AMP AP knows the data rate.

Backscattering devices may have clocks that potentially have a clock offset up to 100 k parts per million (ppm) or up to 10%. The chips in the SYNC sequence may have timing drift. For example, every 10 SYNC field chips may have a timing drift by 1 chip, and the timing drift may reduce the correlation value and increase the SYNC detection failure rate. To combat the timing drift, repeated or complementary bit sequences may be used in the uplink SYNC field from the backscatter device. After correlating the SYNC field with a base sequence, repeated peaks may result, and a difference in the timestamps of the repeated peaks may be used to estimate the timing drift. The estimated clock offset information may further help decoding the data field.

Considerations for SYNC field design for uplink active transmission (such as non-backscatter devices) may include a clock error not being a limiting factor in the SYNC field design, since the clock error in an uplink active transmission may be between-1000 ppm and +1000 ppm. A capable receiver may be a sample correlator, and Manchester encoding may not be used for uplink active transmissions. The false alarm rate for the SYNC field detection may be evaluated over a short time period, such as 16 μs (equal to Short Interframe Spacing (SIFS)) for uplink active transmission, which is the time duration an AMP access point (AP) may be waiting to receive an uplink active transmission after it sends out a Trigger frame to one or more non-backscatter devices. In some examples, the time period for false alarm rate evaluation may be tens of microseconds, such as 100 nanoseconds because the AMP AP may be waiting for a long period of time for the uplink triggered based active transmissions. In some examples, multiple SYNC field sequences may be detected if CDMA or FDMA are used for uplink active transmissions.

For uplink active transmissions, the SYNC field design may support reliable detection at a lower signal-to-noise ratio (SNR) than that of the data field. For example, the SYNC field design may support a 1% false alarm rate over a gap period of pure noise input, e.g., additive white Gaussian noise (AWGN) input. The gap period may be 16 μs (equal to SIFS) or tens of microseconds, such as 100 μs. The SYNC field design may support a 1% SYNC field missed detection rate at an SNR that is no larger than the packet error rate (PER) at 10% data packet error rate (PER).

For non-backscatter devices, the chip durations in the SYNC field and data field may be the same to avoid bandwidth change. The data field design for uplink transmission by the non-backscatter device may be similar to the data field design for downlink and uplink transmissions by the backscatter device. In one example, the data field design may use scalable chip duration and bandwidth according to each data rate. For example, the data field design may use the 2 μs, 0.5 μs and 0.125 μs (or 500 kHz 3 dB bandwidth (BW), 2 MHz 3 dB bandwidth, and 8 MHz 3 dB bandwidth, respectively, or 1 MHz null-to-null bandwidth, 4 MHz null-to-null bandwidth, and 16 MHz null-to-null bandwidth, respectively) with Manchester coding for the 250 kb/s, 1 Mb/s and 4 Mb/s data rates, respectively. In some examples, the data field design may use scalable chip duration and bandwidth according to each data rate for the 250 kb/s and 1 Mb/s data rates. For the 250 kb/s data rate, the data field design may use a 1 μs chip duration (e.g., 2 MHz null-to-null BW, or 1 MHz 3 dB BW) with rate 1/2 BCC (e.g., 802.11 rate 1/2 BCC) and Manchester coding. For the 1 Mb/s data rate, the data field design may use a 0.25 μs chip duration (e.g., 8 MHz null-to-null BW, or 4 MHz 3 dB BW) with rate 1/2 BCC (e.g., 802.11 rate 1/2 BCC) and Manchester coding. The SYNC field design for this example of the data field design may use a length-L (e.g., length-16) base sequence S as a building block, and the SYNC field design may derive longer SYNC sequences for different data rates based on the base sequence through repetition. The repetition may include using the base sequence S, a complementary sequence S̅=1−S, or S or S̅ in reverse order (e.g., S(16:−1:1) or S̅(16:−1:1)). For example, a length-16 base sequence S may be used to derive a length-48 sequence, a length-64 sequence, and a length-32 sequence through 3 times, 4 times, and 2 times repetition for the 250 kb/s, 1 Mb/s, and 4 Mb/s data rates and 4 Mbps, respectively.

In some examples for the 4 Mb/s data rate, the data field design may use a 0.125 μs chip duration (e.g., 16 MHz null-to-null BW or 8 MHz 3 dB bandwidth) with Manchester coding. In another example for the 4 Mb/s data rate, the data field design may use 0.0625 μs chip duration (e.g., 32 MHz null-to-null BW, or 16 MHz 3 dB BW) with rate 1/2 BCC (e.g., 802.11 rate 1/2 BCC) and Manchester coding.

In some examples for the 4 Mb/s data rate, the data field design may use 0.25 μs chip duration (e.g., 8 MHz null-to-null BW, or 4 MHz 3 dB BW) without Manchester coding (e.g., with OOK modulation but not Manchester-OOK modulation). In a further example for the 4 Mb/s data rate, the data field design may use 0.25 μs chip duration (e.g., 8 MHz null-to-null BW, or 4 MHz 3 dB BW) with Manchester coding plus polarity. An example of combining polarity (or sign or phase) and Manchester encoding to encode values may include using [−1, 0], [0, 1], [1, 0], [0,−1] (where 0 is an OFF symbol, 1 is an ON symbol, and −1 is a negative ON symbol) to encode four different values, such as 0-3, or combinations of 00, 01, 10, 11. Different values can be mapped to different combinations of Manchester coding plus polarity (or sign or phase). Another example may include values 0, 1, 2, and 3 (e.g., 00, 01, 10, 11, if represented in binary) may be mapped to [1, 0], [0,−1], [−1, 0] and [0, 1]. More specifically, each value of the four values (0-3) could be represented by any combination of two symbols that use Manchester encoding and polarity (as the symbols are −1, 0, and 1). The different combinations of such symbols include: [−1, 0], [0,−1], [0, 1], and [1, 0]. The mapping that assigns a value to one of these combinations such that each value has a unique combination of symbols. While mappings to four values are shown, mappings to any quantity of values may be possible (e.g., 2, 3, 4, 5, 6, 7, 8, etc.). Further, any mapping between symbols and values is possible.

In some examples for the 4 Mb/s data rate, the data field design may use 0.25 μs chip duration (e.g., 8 MHz null-to-null BW, or 4 MHz 3 dB BW) with Manchester coding (e.g., Manchester-OOK modulation) plus binary frequency shift keying (FSK) (BFSK) (e.g., minimum shift keying (MSK)). An ON symbol may be no longer +1 or −1. The ON symbols may be modulated using two different frequencies, e.g. f0 and f1. With MSK, f and f1 may be related through f0=fc−fx and f1=fc+fx, where fc is the center frequency of the transmitted signal, and fx=1/(2*T)=1/(2*0.25 us)=2 MHz, where T=0.25 us is the chip duration. Every pair of info bits may be mapped into a pair of symbols. The first bit in a pair of info bits is a Manchester-OOK bit and determines the location of the ON symbol and OFF symbol. If the first bit in a pair of info bits may be 0, the first symbol is an ON symbol while the second symbol is an OFF symbol; otherwise, the first symbol is an OFF symbol while the second symbol is an ON symbol. The second bit in a pair of info bits is an FSK bit and determines the modulated frequency of the ON symbol. The ON symbol may be modulated using f0 if the second bit in a pair of info bits may be 0, or modulated using f1 if the second bit in a pair of info bits may be 1.

In some examples for the 4 Mb/s data rate, the data field design may use 0.25 μs chip duration (e.g., 8 MHz null-to-null BW, or 4 MHz 3 dB BW) with differential encoding and Manchester coding (e.g., Manchester-OOK modulation) plus binary frequency shift keying (FSK) (BFSK) (e.g., minimum shift keying (MSK)). An ON symbols may be modulated using two different frequencies, e.g. f0 and f1. With MSK, f0 and f1 may be related through f0=fc−fx and f1=fc+fx, where fc is the center frequency of the transmitted signal, and fx=1/(2*T)=1/(2*0.25 us)=2 MHz, where T=0.25 us is the chip duration. The stream of info bits may be firstly encoded into a stream of differential encoded bits. Then, every pair of differential encoded bits may be mapped into a pair of symbols. The first bit in a pair of differential encoded bits is a Manchester-OOK bit and determines the location of the ON symbol and OFF symbol. If the first bit in a pair of differential encoded bits may be 0, the first symbol is an ON symbol while the second symbol is an OFF symbol; otherwise, the first symbol is an OFF symbol while the second symbol is an ON symbol. The second bit in a pair of differential encoded bits is an FSK bit and determines the modulated frequency of the ON symbol. The ON symbol may be modulated using f0 if the second info bit in a pair of differential encoded bits may be 0, or modulated using f1 if the second info bit may be 1.

In some examples, an information bit stream with index starting from 0 (e.g., B₀B₁B₂B₃ . . . ) could be split into two sub-streams, one formed by the even-indexed bits (e.g., B₀B₂ . . . ), and the other formed by the odd-indexed bits (e.g., B₁B₃ . . . ). A first information bit sub-stream may be Manchester encoded, may use non-coherent detection, and may be better protected. The second information bit sub-stream may be carried in the polarity of the ON symbols (i.e., BPSK modulated) conditioned on the Manchester encoding of the first bit sub-stream, may use coherent detection, and may be less protected. The information bit sub-stream that is Manchester encoded and relies on non-coherent detection may be used to carry information with higher priority or importance, and the other information bit sub-stream may be used to carry information with lower priority or importance. For example, if there mapping is between values ‘00’, ‘01’, ‘10’ and ‘11’ (where the second bit is least significant bit and coming from the even-indexed bit sub-stream) and symbols [−1, 0], [0, 1], [1, 0] and [0, −1]. Then, the even-indexed bit sub-stream is Manchester encoded, because ‘00’ and ‘10’ with the even-indexed bit being ‘0’ are mapped to [−1, 0] and [1, 0], respectively, with an OFF symbol being the second symbol (similar to the Manchester encoding which maps ‘0’ to [1, 0] with a first ON symbol and a second OFF symbol). And ‘01’ and ‘11’ with the even-indexed bit being ‘1’ are mapped to [0, 1] and [0, −1], respectively, with an ON symbol with either a (+1) or (−1) multiplier being the second symbol (similar to the Manchester encoding which maps ‘1’ to [0, 1] with a first OFF symbol and a second ON symbol). Non-coherent detection of the ON and OFF symbols (which focuses on the power level but not the sign or phase of the ON symbols) could be used to decode the even-indexed bit sub-stream using Manchester decoding. The odd-indexed bit sub-stream is carried in the polarity of the ON symbols (i.e., BPSK modulated) conditioned on the Manchester encoding of the first bit sub-stream. Bit combinations ‘00’ and ‘10’ are mapped to [−1, 0] and [1, 0], respectively (where the first symbol is an ON symbol and the second symbol is an OFF symbol), where the odd-indexed bits (‘0’ and ‘1’) determine the polarity of the first ON symbol (negative and positive ON symbols, respectively). Conversely, bit combinations ‘01’ and ‘11’ map to [0, 1] and [0, −1], respectively (where the first symbol is an OFF symbol and the second is an ON symbol), where the odd-indexed bits (‘0’ and ‘1’) determine the polarity of the second ON symbol (positive and negative ON symbols) A receiver that performs non-coherent detection and fails to perform coherent detection, may be able to decode the first information bit sub-stream (which is the even-indexed bit sub-stream) that may be Manchester encoded but not the second information bit sub-stream (which is the odd-indexed bit sub-stream) that may be BPSK modulated conditioned on the Manchester encoding of the first bit sub-stream. In such examples, the achievable data rate may become 2 Mb/s instead of 4 Mb/s. A receiver that decodes both information bit sub-streams (i.e., entire information bit stream) may achieve a data rate of 4 Mb/s.

In another example for the 4 Mb/s data rate, the data field design may use 0.25 μs chip duration (e.g., 4 MHz BW) without Manchester coding and with binary phase shift keying (BPSK) modulation using −1 and 1 (e.g., not OOK modulation that uses 0 (OFF symbol) and 1 (ON symbol), but 1 is an ON symbol and −1 is a negative ON symbol).

In another example for the 4 Mb/s data rate, the data field design may use 0.25 μs chip duration (e.g., 4 MHz BW) without Manchester coding and with frequency shift keying (FSK) (e.g., minimum shift keying (MSK)) modulation. The ON symbol may be modulated using a first frequency, f0, and a second frequency, f1. With MSK, f0 and f1 may be related through f0=fc−fx and f1=fc+fx, where fc is the center frequency of the transmitted signal, and fx=1/(2*T)=1/(2*0.25 us)=2 MHz, where T=0.25 us is the chip duration. The ON symbol may have a constant envelope. The MSK modulated signal may have continuous phase.

In some examples for the 4 Mb/s data rate, the data field design may use 0.25 μs chip duration (e.g., 8 MHz null-to-null BW, or 4 MHz 3 dB BW) without Manchester coding but with differential on-off keying (differential-OOK) encoding. In such examples, the differential encoding may use a last chip from the SYNC field or a first chip in the data field having a fixed value or a random value as a reference. The differential encoding may use Bₖ=Bₖ₋₁ to encode a first binary value (e.g., 0) and Bₖ≠Bₖ₋₁ to encode a second binary value (e.g., 1), where Bₖ represents a current chip and Bₖ₋₁ represents a previous chip. The differential-OOK encoding may provide improved performance in non-coherent receiver implementations by reducing sensitivity to phase variations and enabling detection based on symbol transitions rather than absolute symbol values.

In some examples for the 4 Mb/s data rate, the data field design may use 0.25 μs chip duration (e.g., 4 MHz BW) without Manchester coding but with differential FSK (differential-FSK, DFSK) encoding (such as differential-minimum shift keying, DMSK). In such examples, the differential-FSK encoding may use a last chip from the SYNC field if it is an ON chip, a first chip in the data field having a fixed value or a random value as a reference. The ON symbol may be modulated using a first frequency, f0, and a second frequency, f1. With MSK, f0 and f1 may be related through f0=fc−fx and f1=fc+fx, where fc is the center frequency of the transmitted signal, and fx=1/(2*T)=1/(2*0.25 us)=2 MHz, where T=0.25 us is the chip duration. The differential encoding may use the same modulated frequency as the previous chip to encode a first binary value (e.g., 0) and a different modulated frequency from the previous chip to encode a second binary value (e.g., 1), where the modulated frequency of the current chip phase is compared to that of the previous chip phase.

In some examples for the 4 Mb/s data rate, the data field design may use 0.25 μs chip duration (e.g., 4 MHz BW) without Manchester coding but with differential binary phase shift keying (differential-BPSK) encoding. In such examples, the differential-BPSK encoding may use a last chip from the SYNC field if it is an ON chip, a first chip in the data field having a fixed value or a random value as a reference. The differential encoding may use the same phase as the previous chip to encode a first binary value (e.g., 0) and a different phase (e.g., with a 180 degree phase rotation, or a sign flip) from the previous chip to encode a second binary value (e.g., 1), where the current chip phase is compared to the previous chip phase. The differential-BPSK encoding may provide improved performance in coherent receiver implementations by enabling detection based on phase transitions rather than absolute phase values and may offer enhanced noise immunity compared to differential-OOK encoding.

In another example, the data field design may use a same chip duration and bandwidth for each data rate, and the different data rates may have a different quantity of chips. Larger bandwidth for lower data rate(s) may lead to better frequency diversity and performance. For the highest 4 Mb/s data rate with Manchester encoding, the chip duration may be 0.125 μs and the bandwidth may be 8 or 16 MHz, and the data field may use coding (such as, repetition, BCC (binary convolutional code), LDPC code, Manchester encoding, concatenation of different coding like rate 1/2 BCC+2×repetition) or spreading sequence (such as [0 1 0 1] for bit 1 and [1 0 1 0] for bit 0) to derive lower code rates, such as a 4×factor to generate 1 Mb/s, 16×factor to generate 250 kb/s. The data field may use a baseline design for 2 Mb/s with Manchester encoding, and the chip duration may be 0.25 μs and the bandwidth may be 4 or 8 MHz, and the data field may use coding or spreading sequence to derive 250 kb/s (8×factor) and 1 Mb/s (2×factor where 4 Mb/s does not have Manchester coding. In some examples, the data field design may use a time domain repetition of the full payload that may have a memory requirement consideration, and the chip duration may be 0.125 μs and the bandwidth may be 8 or 16 MHz. For the time domain repetition implementation, the payload may be repeated in time domain entirely or block-wise for lower code rates. For example, the 4 Mb/s data rate may include one copy of payload, the 1 Mb/s may include 4 copies of the payload that go sequentially, and the 250 kb/s may include 16 copies of the payload that go sequentially. The time domain repetition may be robust to time-varying interference for lower rates, if some copies are impacted by interference, the data field may still be decoded.

In another example, the data field design may use a same chip duration and bandwidth for the 250 kb/s and 1 Mb/s data rates and use different design for 4 Mb/s data rate. The data field design may use larger bandwidth for the lower code rate(s) to harvest frequency diversity. The 4 Mb/s data rate may use a bandwidth less than or equal to 16 MHz or 16 MHz. With plus or minus 1 kppm, there may be plus or minus 2.4 MHz shifting in frequency, which is greater than 20 MHz width to account for the range for possible frequency shift. In this case, the AP may have a 22 MHz filter that may be used for DSSS. In some examples, the 250 kb/s and 1 Mb/s data rates may use the same chip duration and bandwidth for the data field. The 250 kb/s and 1 Mb/s data rates may use a baseline design for the 1 Mb/s data rate with Manchester coding with a chip duration of 0.5 μs and bandwidth of 2 or 4 MHz and may use coding of a spreading sequence to derive the 250 kb/s (4×factor, such as 4×repetition, or rate 1/2 BCC plus 2×repetition). In some example, the 250 kb/s and 1 Mb/s data rates may use a baseline design for 2 Mb/s data rate with Manchester coding with a chip duration of 0.25 μs and bandwidth of 4 or 8 MHz and may use coding of a spreading sequence to derive the 250 kb/s (8×factor) and 1 Mb/s (2×factor). The 4 Mb/s may use a separate design. For example, the 4 Mb/s data rate may use a chip duration of 0.25 μs and bandwidth of 4 or 8 MHz without Manchester coding or a chip duration of 0.125 μs and bandwidth of 8 or 16 MHz without Manchester coding. The 250 kb/s data rate may use 1 μs chip duration (e.g., 1 MHz 3 dB bandwidth, or 2 MHz null-to-null bandwidth) with 1/2 BCC and Manchester coding. The 1 Mb/s data rate may use 0.5 μs chip duration (e.g., 2 MHz 3 dB bandwidth, or 4 MHz null-to-null bandwidth) with Manchester coding, and the 4 Mb/s data rate may use 0.125 μs chip duration (e.g., 8 MHz 3 dB bandwidth, or 16 MHz null-to-null bandwidth) with Manchester coding. The 250 kb/s and 1 Mb/s data rates may use one of the above chip duration and bandwidth examples for the data field and the 4 Mb/s data rate may use one of the above chip duration and bandwidth examples for the data field.

In some implementations, the uplink active transmission may not be centered at the direct current (DC) in the baseband to avoid a notch filter at DC. All fields, including the Sync field and Data field, in the uplink active transmission may be centered at a baseband carrier frequency (f_{Δ}) away from DC. In other words, the uplink active transmission may be centered at a frequency of (f_{C}+f_{Δ}), where f_{C} may be the original center frequency of the 20 MHz channel. The baseband carrier frequency (f_{Δ}) may be considered a frequency relative to the original center frequency of the 20 MHz channel. In some implementations, there may be one default baseband carrier frequency (f_{Δ}) away from DC. In some implementations, there may be more than one baseband carrier frequencies (f_{Δ}) away from DC to choose from by the AMP AP, to explore frequency diversity and avoid poor performance due to a deep fade at one baseband carrier frequency (f_{Δ}). We call it frequency hopping (e.g., center frequency shift) by switching the baseband carrier frequency (f_{Δ}) from one to another. There may be a 1-bit field to indicate the frequency hopping (e.g., center frequency shift) support capability of one AMP AP or one non-AP AMP devices. Some devices may not support frequency hopping (e.g., center frequency shift) and may indicate ‘disabled’ through this 1-bit field. Some devices may support frequency hopping (e.g., center frequency shift) and may indicate ‘enabled’ through this 1-bit field. The AMP trigger frame to solicit an uplink active transmission may have a field to indicate the frequency hopping (e.g., center frequency shift). For example, if there are two baseband carrier frequencies (f_{Δ}) to choose from, such as one f_{Δ} equals to 5 MHz, and another f_{Δ} equals to −5 MHz, there may be a 1-bit field in the AMP trigger frame to indicate either f_{Δ} value. In some implementations, one of these baseband carrier frequency value, such as f_{Δ} equals to 5 MHz, may be a default baseband carrier frequency value. The devices that don't support frequency hopping (e.g., center frequency shift) and have indicated ‘disabled’ in the capability field, may ignore this 1-bit signaling in the AMP trigger frame and use f_{Δ}=0 or the default baseband carrier frequency f_{Δ} (e.g., 5 MHz). The devices that support frequency hopping (e.g., center frequency shift) and have indicated ‘enabled’ in the capability field may transmit the uplink active transmission using the baseband carrier frequency as indicated in the 1-bit field in the AMP trigger frame.

In another example, if frequency hopping (e.g., center frequency shift) is enabled, there may be two baseband carrier frequencies (f_{Δ}) to choose from (e.g., f_{Δ}=5 MHz, f_{Δ}=−5 MHz), and there may be a 1-bit field in the AMP trigger to indicate whether frequency hopping may be turned on or off and another 1-bit field in the AMP trigger frame to indicate either f_{Δ} value if frequency hopping (e.g., center frequency shift) may be on. If the 1-bit field in the AMP trigger, which may be used to indicate whether frequency hopping (e.g., center frequency shift) may be turned on or off, indicates that frequency hopping is off, devices that support frequency hopping, devices that do not support frequency hopping, or both may transmit the uplink active transmission using the default baseband frequency (e.g., f_{Δ}=0). If the 1-bit field in the AMP trigger indicates that frequency hopping is on, the devices that do not support frequency hopping may ignore the indication and may transmit the uplink active transmission using the default baseband frequency (e.g., f_{Δ}=0). If the 1-bit field in the AMP trigger indicates that frequency hopping is on, the devices that support frequency hopping may transmit the uplink active transmission using the baseband frequency as indicated in the other 1-bit field in the AMP trigger to indicate the baseband frequency (f_{Δ}) (e.g., f_{Δ}=5 MHz or f_{Δ}=−5 MHz).

In another example, if frequency hopping (e.g., center frequency shift) may be enabled, there may be two baseband carrier frequencies (f_{Δ}) to choose from (e.g., f_{Δ}=5 MHz, f_{Δ}=−5 MHz), and there may be a 2-bit field in the AMP trigger to indicate the baseband frequence f_{Δ} e.g., 0, 5 MHz, −5 MHz). The devices that do not support frequency hopping (e.g., center frequency shift) may ignore the indication and may transmit the uplink active transmission using the default baseband frequency (e.g., f_{Δ}=0). The devices that support frequency hopping may transmit the uplink active transmission using the baseband frequency as indicated in the other 1-bit field in the AMP trigger to indicate the baseband frequency (f_{Δ}) (e.g., f_{Δ}=0, f_{Δ}=5 MHz, f_{Δ}=−5 MHz).

In some examples, the data field design may use frequency hopping (e.g., center frequency shift). For example, the AMP AP may indicate frequency hopping (f_{Δ}) in a trigger frame to instruct the AMP device to modulate the signal accordingly, if frequency hopping is enabled. In some examples, the AMP AP may not indicate frequency hopping in a trigger frame, and the AMP device that supports frequency hopping (or center frequency shift) may choose the baseband frequency (f_{Δ}), such as f_{Δ}=0, f_{Δ}=5 MHz or f_{Δ}=−5 MHz. In some examples, the AMP device may directly modulate the baseband signal to a center frequency of (f_{C}+f_{Δ}), where f_{C} may be the original center frequency of the 20 MHz channel without frequency hopping. In another example, the AMP device may perform a frequency modulation (f_{Δ}) in the baseband and then modulate the baseband signal to the center frequency of f_{C}. For a 20 MHz channel, the channel may be divided into upper 10 MHz, with f_{Δ} equal to 5 MHz, and lower 10 MHz, with f_{Δ} equal to −5 MHz) resulting in two choices for f_{Δ} if frequency hopping is enabled. The channel may be divided into an upper 10 MHz, with f_{Δ} equal to 5 MHz, a center 10 MHz, with f_{Δ} equal to 0, and a lower 10 MHz, with f_{Δ} equal to −5 MHz), resulting in three choices for fa if frequency hopping (e.g., center frequency shift) is enabled. Some AMP devices may not have frequency hopping capability, and frequency hopping may be disabled (e.g., f_{Δ} equals a fixed value, e.g., zero, 5 MHz or −5 MHz). Such devices may ignore the frequency hopping indication in the Trigger frame.

The uplink SYNC field sequence design for the non-backscatter devices may consider one of the above chip duration options associated with the data field and the data rates. For example, the uplink SYNC field sequences may use a scalable chip duration and bandwidth according to each data rate. A first candidate sequence corresponding to the 250 kb/s data rate may be the same as a second candidate sequence corresponding to the 1 Mb/s data rate, and a length of the first candidate sequence may be scaled based on a symbol duration associated with the SYNC field. In another example, the SYNC field sequence may have the same chip duration and bandwidth for the different data rates and may have a different quantity of chips for the different data rates. The different data rates may use SYNC sequences of different lengths. For example, a SYNC sequence may be generated by designing one shortest base length-N sequence W for the 4 Mb/s data rate, and the SYNC sequences for lower data rates may be based on the base length-N sequence. The SYNC sequences for lower data rates may use outer sequences with multiple modified copies of the base length-N sequence, and each modified copy may be a repetition of W, a complementary (such as, W̅=1−W), a reverse ordering (such as, W (N:−1:1)), or a bit-wise repetition. In some examples, the different data rates may use different SYNC sequences. The SYNC sequences for the different data rates may use same chip duration for the 250 kb/s and the 1 Mb/s data rates and use different design for the chip duration for the 4 Mb/s data rates. For the 250 kb/s and the 1 Mb/s data rates, one sequence may be designed for both rates. For the 250 kb/s and the 1 Mb/s data rates, a shorter sequence may be designed for the 1 Mb/s data rate and a longer sequence may be designed for the 250 kb/data rate. For example, a base sequence W may be designed for the 1 Mb/s data rate, and the complementary sequence W̅ may be used for 1 Mbps, and the sequence for 250 kbps uses W and/or W̅ as building blocks, with the sequence being [W W], [W W̅], [W̅ W], [W̅ W̅]. In some examples, the sequence for the 250 kb/s and the 1 Mb/s data rates may be different or two separate sequences. In some examples, the sequence for the 4 Mb/s data rate may reuse a sequence for the 250 kb/s or the 1 Mb/s data rates and scale the chip duration for 4 Mb/s or use a different sequence for 4 Mb/s.

The uplink SYNC field sequence design for the non-backscatter devices may use the same chip duration as for the data fields to avoid bandwidth change in receiving processing. The uplink SYNC field sequence design for the non-backscatter devices may consider one of the above chip duration options associated with the data field and the data rates. In some examples, a single uplink SYNC field sequence (e.g., same length L) with scalable chip duration may be used for all data rates. The SYNC field durations may be (2*L) μs, (L/2) μs, and (L/8) μs for 250 kb/s, 1 Mb/s and 4 Mb/s data rates, respectively, if 2 μs, 0.5 μs and 0.125 μs chip durations are used, respectively. For example, a length-28 sequence may be used for a SYNC field duration of 56 μs, 14 us and 3.5 μs for 250 kb/s, 1 Mb/s and 4 Mb/s, respectively; a length-32 sequence may be used for a SYNC field duration of 64 μs, 16 μs and 4 μs for 250 kb/s, 1 Mb/s and 4 Mb/s, respectively; a length-36 sequence may be used for a SYNC field duration of 72 us, 18 μs and 4.5 μs for 250 kb/s, 1 Mb/s and 4 Mb/s, respectively; a length-40 sequence may be used for a SYNC field duration of 80 μs, 18 μs and 5 μs for 250 kb/s, 1 Mb/s and 4 Mb/s, respectively; a length-44 sequence may be used for a SYNC field duration of 88 μs, 22 μs and 5.5 μs for 250 kb/s, 1 Mb/s and 4 Mb/s, respectively; a length-48 sequence may be used for a SYNC field duration of 96 μs, 24 μs and 6 μs for 250 kb/s, 1 Mb/s and 4 Mb/s, respectively; and a length-64 sequence may be used for a SYNC field duration of 128 μs, 32 μs and 8 μs for 250 kb/s, 1 Mb/s and 4 Mb/s data rates, respectively.

In some examples, a single uplink SYNC field sequence with scalable chip duration may be used for all data rates, and the SYNC sequence may be derived from a base sequence S. For example, a length-L base sequence S may be used to derive a length-2L SYNC sequence, as [S S], [S S̅], [S̅ S], [S̅S̅], where the complementary sequence S̅=1−S, and may use S or S in reverse order (such as S(L:−1:1) or S̅(L:−1:1)), as one of the building blocks. The pattern of S and/or S may be used to indicate the length of data field (or packet size) for up to 4 length values. In some examples, a length-L base sequence B may be used to derive a Manchester encoded SYNC sequence W=Manchester(B), where W(1:2:2L−1)=B̅=1−B and W(2:2:2L)=B, or W=Manchester(B̅), where W(1:2:2L−1)=B and W(2:2:2L)=B̅=1−B; the two choices of Manchester(B) and Manchester(B̅) may be used to indicate the length of data field (or packet size) for up to 2 length values. For L=14, 16, 18, 20, 22, 24, 32, 40, 44, 48, 64, and so on, the SYNC field durations may be (4*L) μs, (L) μs, and (L/4) μs for 250 kb/s, 1 Mb/s and 4 Mb/s data rates, respectively, if 2 us, 0.5 us and 0.125 us chip durations are used, respectively. For L=7, 8, 9, 10, 11, 12, 16, and so on, the SYNC field may use a length-L base sequence S to derive a length-4L SYNC sequence, [S S S S], [S S S S̅], [S S S̅ S], [S S̅ S S], [S̅ S S S], and so on; and the SYNC field durations may be (8*L) μs, (2*L) μs, and (L/2) μs for 250 kb/s, 1 Mb/s and 4 Mb/s data rates, respectively, if 2 μs, 0.5 μs and 0.125 μs chip durations are used, respectively. In general, the SYNC field may use a length-L base sequence S to derive a length-KL sync sequence with K copies of S, complementary sequence S̅, or reverse ordered sequence S(L:−1:1). In general, the SYNC field durations may be (2*K*L) μs, (K*L/2) μs, and (K*L/8) μs for 250 kb/s, 1 Mb/s and 4 Mb/s data rates, respectively for K=3, L=10, 12, 14, 16, 18, 20, and 22, if 2 us, 0.5 μs and 0.125 μs chip durations are used, respectively.

The uplink SYNC field sequence design for the non-backscatter devices may use the same chip duration as for the data fields to avoid bandwidth change in receiving processing. The uplink SYNC field sequence design for the non-backscatter devices may use a same scalable chip duration and bandwidth as the data field according to each data rate. The SYNC field may have a length-L base sequence S, such as a length-16 sequence, for the SYNC sequence for 250 kb/s data rate where the SYNC field duration may be (2*L) μs, if 2 μs chip duration is used. The SYNC sequence for 1 Mb/s and 4 Mb/s data rates may use longer SYNC sequences derived from the length-L base sequence. For example, both the SYNC sequence for 1 Mb/s and 4 Mb/s data rate may use a length-2L (such as a length-32 sequence), such as [S S], [S S̅], [S̅ S], [S̅ S̅], where the complementary sequence S̅=1−S, and may use S or S̅ in reverse order, such as S(L:−1:1) or S̅(L:−1:1) where the SYNC field durations for the 1 Mb/s and 4 Mb/s data rates may be (L) μs and (L/4) μs, respectively, if 0.5 μs and 0.125 μs chip durations are used, respectively. In some examples, for the 1 Mb/s data rate, the SYNC sequence may use a length-2L (such as length-32) as shown above, and for the 4 Mb/s data rate, the SYNC sequence may use a length-3L (such as length-48), such as [S S S], [S S S̅], [S S̅ S], [S S̅ S̅], [S̅ S S], [S̅ S S̅], [S̅ S̅ S], [S̅ S̅ S̅] where the SYNC field durations for the 1 Mb/s and 4 Mb/s data rates may be (L) μs and (3*L/8) μs, respectively, if 0.5 μs and 0.125 μs chip durations are used, respectively. For the 250 kb/s data rate, the SYNC sequence S or its complementary sequence S̅=1−S in the SYNC field may be used to indicate the length of data field (or packet size) for up to 2 length values. For the 1 Mb/s and 4 Mb/s data rates, the pattern of S and/or S̅ may be used to indicate the length of data field (or packet size). For example, [S S] may indicate packet size value 1, [S S ] may indicate packet size value 2, [S̅ S] may indicate packet size value 3, and [S̅ S̅] may indicate packet size value 4. In some examples, the SYNC field may have a length-L, such as length-16, base sequence S for both the 250 kb/s and 1 Mb/s data rates, and the SYNC field may have a length-2L, such as length-32, SYNC sequence derived from the base sequence S for the 4 Mb/s data rate where the SYNC field durations may be (2*L) μs, (L/2) μs and (L/4) μs, if 2 μs, 0.5 μs and 0.125 μs chip durations are used, respectively. For example, for L=16, the SYNC field durations may be 32 μs, 8 μs and 4 μs for the 250 kb/s, 1 Mb/s and 4 Mb/s data rates, respectively. In some examples, the 4 Mb/s data rate may use a SYNC sequence such as [S S], [S S̅], [S̅ S], [S̅ S̅] where S̅=1−S.

In some examples, the uplink active transmission may have up to +1000 ppm clock inaccuracy, the frequency may be off up to +2.4 MHz, and the timing drift may be up to +0.1%. The timing drift may be difficult to estimate with the SYNC field at the beginning of UL PPDU. To estimate a timing drift of up to +0.1%, at least two timing estimations based on the SYNC field may be done and they may be at least 1000 samples apart. But this cause the SYNC field to be very long for two higher data rates, 1 Mbps and 4 Mbps, and hence may not be practical due to the large overhead. If the packet length or PPDU length is short (e.g., data payload is not large), the timing drift may not be an issue. If the packet or PPDU is long enough (e.g., data payload is large enough), the timing drift may cause a large performance loss. A timing drift may be estimated and corrected, or re-synchronization may be used. In some examples, a second SYNC field may be included in the PPDU for the timing drift estimate and the re-synchronization. The format of the PPDU may be a first SYNC field, a possible SIG field which may or may not present, a data field, a second SYNC field, and a second data field. The format of the PPDU may also be considered as the data field being split into two portions and there is a second SYNC field before the second portion of the data field. If the packet is very long, there may be multiple SYNC fields with a periodicity. The periodicity could be based on a few octets of data payload size, such as 4 octets, 6 octets, 8 octets, and so on. That means, the data field is split into a few portions or multiple data fields, each with a few octets size, such as 4 octets. Short packets may not include the second SYNC field. Long packets may include one or more second SYNC fields. The second SYNC field may be different from the first SYNC field, which is at the beginning of the PPDU. The second SYNC field may be shorter than the first SYNC field, because the second SYNC field is used for timing estimate and re-synchronization but not for packet detection. In some implementations, the second SYNC field may be a 2-chip sequence of [1 0] or [0 1]. In some implementations, the second SYNC field may be a 3-chip sequence of [1 1 1] or [0 0 0]. In some implementations, the second SYNC field may be a 4-chip sequence with equal numbers of ones and zeros, such as [1 0 1 0], [0 1 0 1], [1 1 0 0], [0 0 1 1], [1 0 0 1] or [0 1 1 0]. The receiving device (e.g., AMP AP) may estimate the timing using the second SYNC field, demodulate and decode the remaining data based on the new timing determined from the second SYNC field. Additionally, the receiving device may compare the new timing with the original timing estimated with the first SYNC field to calculate the timing drift and correct the timing drift, demodulate and decode the remaining data with timing drift correction. In some examples, there is no second SYNC field. The data field is not split into multiple portions or fields in transmission. But in receiver processing, the data field processing is split into multiple portions, and the last few chips in each portion not only carry data but also may be used for timing estimate and re-synchronization. In some implementations, the last two chips of every few octets, such as every 4 octets, are either [1 0] or [0 1] and could be also used for timing estimate. In some examples, there is no second SYNC field, and the receiver uses a short 2-chip correlator (based on the 2-chip sequence of [1 0] or [0 1]) for Manchester decoding plus timing tracking in one step. Timing may be identified by the positive and negative peaks of the correlator output and is updated each time when one bit is decoded from the Manchester decoding. In some examples, if the frequence error and timing drift are from the same error source, such as a clock error, or are correlated, the receiver may estimate the frequency error and use it to derive and correct the timing drift.

For the data field design that uses the fixed chip duration, the SYNC field may use a length-L base sequence S, such as a length-32 sequence, as the SYNC sequence for 1 Mb/s and 4 Mb/s data rates, and the 250 kb/s data rate may use a longer SYNC sequence derived from the base sequence. For example, the 250 kb/s data rate may uses a length-2L (a length-64 sequence), such as [S S], [S S̅], [S̅ S], [S̅ S̅], where S̅=1−S, and may use S or S in reverse order, such as S(L:−1:1) or S̅(L:−1:1). The 1 Mb/s and 4 Mb/s data rates may use either the SYNC sequence S or its complementary sequence S̅=1−S in the SYNC field to indicate the length of data field (or packet size) for up to 2 length values. The 250 kb/s data rate may use the pattern of S and/or S̅ to indicate the length of the data field (or packet size) for up to 2 length values. In some examples, the SYNC field may use a length-L base sequence S, such as a length-16 sequence, and the SYNC sequence of all data rates may be derived from the base sequence. For example, the 1 Mb/s and 4 Mb/s data rate may use a same length-2L, such as a length-32, sequence or two different length-32 sequences, (such as [S S], [S S̅], [S̅ S], [S̅ S̅], where the complementary sequence S̅=1−S, and may use S or S in reverse order, such as S(L:−1:1) or S̅(L:−1:1). The 250 kb/s data rate may use a length-4L, such as length-64 sequence, such as [S S S S], [S S̅ S S̅], and so on, where S̅=1−S, and may use S or S̅ in reverse order, such as S(L:−1:1) or S̅(L:−1:1), or a length-80 sequence, such as [S S S S S], [S S̅ S S̅ S], and so on. The pattern of S and/or S may be used to indicate the length of the data field (or packet size).

In some examples, the data field design may use the scalable chip duration and bandwidth according to each data rate for the 250 kb/s and 1 Mb/s data rates and use a separate design for the 4 Mb/s data rate. The SYNC field design, corresponding to the data field design that uses the scalable chip duration and bandwidth according to each data rate for the 250 kb/s and 1 Mb/s, and a separate design for the 4 Mb/s data rates, may use a length-L, such as length-32, base sequence S for 4 Mb/s and may use a length-2L, such as length-64, sequence derived from the base sequence S, e.g., [S S], [S S̅], [S̅ S], [S̅ S̅], where the complementary sequence S̅=1−S for the 250 kb/s and 1 Mb/s data rates. The SYNC field duration may be are (4*L) μs, (L) μs and (L/8) μs for the 250 kb/s and 1 Mb/s, and 4 Mb/s data rates, respectively (e.g., if L=32, the SYNC field duration may be are 64 μs, 16 μs and 4 μs for the 250 kb/s, 1 Mb/s, and 4 Mb/s data rates, respectively), if 1 μs, 0.25 μs and 0.125 μs chip durations are used, respectively. In some examples, the SYNC field design may use a same length-L sequence, such as length-32 sequence, for the 250 kb/s, 1 Mb/s, and 4 Mb/s data rates. For the length-32 sequence, the SYNC field durations may be 32 μs, 8 μs and 4 μs for the 250 kb/s, 1 Mb/s, and 4 Mb/s data rates, respectively, if 1 μs, 0.25 μs and 0.125 μs chip durations are used, respectively. For the 250 kb/s and 1 Mb/s data rates, the SYNC detection performance may be a bottleneck because the SYNC field detection may be worse than the Data field packet error rate (PER) performance. In some examples, a same base SYNC sequence S and a same SYNC field duration (in the unit of us) may be used for the 250 kb/s, 1 Mb/s, and 4 Mb/s data rates, where the SYNC sequence of each data rate may be derived from the base sequence with repetition, where each copy may be the base sequence S, its complementary sequence S̅=1−S, or the reverse order of S or S̅.

In some examples, the SYNC field may be used to indicate a length of the data field or a packet size of the data field. For a data rate, if the SYNC sequence is a base sequence, S or S, where the complementary sequence S̅=1−S, may indicate two data field length values. For a data rate, if the SYNC sequence is derived from a base sequence S with two copies, the pattern of S and/or S, i.e., [S S], [S S̅], [S̅ S], [S̅ S̅], may indicate up to four data field length values. For a data rate, if the SYNC sequence is derived from a base sequence S with three copies, the pattern of S and/or S̅, i.e., [S S S], [S S S̅], [S S̅ s], [S S̅ S̅], [S̅ S S], [S̅ S S̅], [S̅ S̅ S], [S̅ S̅ S̅], may indicate up to eight data field length values. For a data rate, if the SYNC sequence is derived from a base bit sequence B with Manchester encoding, the two choices Manchester(B) and Manchester(B̅), where B̅=1−B, may indicate the 2 data field length values.

The uplink SYNC field sequence design for W may consider one or more properties. If the uplink SYNC field sequence is not based on a Manchester-OOK design, uplink SYNC field sequence design for W may have a property of good autocorrelation (or good correlation with the reference signal 2*W−1) and may not be concerned with the autocorrelation for W̅ (or good correlation of W̅ with the reference signal 2*W−1). If the uplink SYNC field sequence is not based on a Manchester-OOK design, the sequence may have subsequences to be different from a Manchester-OOK sequence, such as three “Ones” or three “Zeros”, but no string of a lot of consecutive “Zeros” such that the aggregated duration of OFF symbols reaches 8 μs (such as no four or more “Zeros” if the chip duration is 2 μs, no eight or more “Zeros” if the chip duration is 1 us, no sixteen or more “Zeros” if the chip duration is 0.5 μs, no thirty-two or more “Zeros” if the chip duration is 0.25 μs, no sixty-four or more “Zeros” if the chip duration is 0.125 μs). If the uplink SYNC field sequence is based on a Manchester-OOK design, the sequence may be determined similar as the downlink SYNC field sequence to obtain a length-N bit sequence w. The Manchester encoding may be performed to generate W-Manchester(w) of length-(2N) where w is the bit sequence and W is the binary sequence, and the Man-OOK sequence may be changed to include an invalid Manchester pattern, such as three “Ones” or three “Zeros”, but no string of a lot of consecutive “Zeros” such that the aggregated duration of OFF symbols reaches 8 us. In some examples, if the uplink SYNC field sequence is based on a Manchester-OOK design, the sequence may be determined similar as the downlink SYNC field sequence without including the invalid Manchester pattern. The bit sequence w of length-N may be determined to have good autocorrelation as described above for the downlink SYNC sequence design (or good correlation with the reference signal 2*w−1), and Manchester encoding is performed on w to generate W=Manchester(w) of length-(2N). Similarly, a receiver may perform Manchester decoding upon receiving such a signal.

One length-N binary sequence may be identified by a notation of S(N,D) where D is a decimal value of the binary sequence and an integer in the range of [0, 2\hat{ }N−1], such as S(3,0) is [0 0 0] and S(4,8)=[1 0 0 0]. Correlation may be represented as CC=<W, R> (Cross Correlation of W and R), where W is the binary sequence and a reference signal (R) in the correlator. For downlink, R=2*W−1 where R is a sequence with +1 and −1. Auto-correlation may be represented as AC=<W, R >=<W,2*W−1>, (which is essentially a cross correlation between W and the reference signal R) with a positive peak P₁=Max (AC) (a positive value), a second largest positive sidelobe S₁ (second largest value in AC that is usually a non-negative value), and a largest negative sidelobe L1=Min (AC) that is usually a non-positive value. Cross-correlation between the complementary sequence W and the reference signal R may be represented as CC=<W̅, R >=<W̅, 2*W−1 >=<1−W,2*W−1> with a negative peak P₂=Min(CC) that is a negative value, a second largest negative sidelobe S₂ (second smallest value in CC that is usually a non-positive value, and a largest positive sidelobe L₂=Max (CC) that is usually a non-negative value. For uplink, the auto-correlation representation may be the same as shown for downlink, with the reference signal R=2*W−1.

In some examples, a preceding sequence may impact correlation. For uplink, the SYNC field may be the first field in the transmission, so there is no preceding sequence for uplink transmission. However, if the final sequence design is based on a structure of [E W Y], where the subsequence E may be designed based on certain property and the search of W is performed, need to take E into account as a preceding sequence in the auto-correlation of W, so auto-correlation may change to AC=<W, R > to AC=<[E W], R > (which is essentially a cross correlation between [E W] and the reference signal R), where the reference signal R=2*W−1. For downlink, the DL preamble (8 μs L-STF, 8 μs L-LTF, 4 μs L-SIG, 4 μs RL-SIG, and 8 us U-SIG) of total 32 μs, such as 16 chips of 2 μs per chip duration, may be considered as a preceding all 1s before the SYNC sequence and denoted as E. For downlink transmission for backscatter devices, the DL preamble (of total 32 μs as described above) and at least partial excitation field may be considered as a preceding all 1s before the SYNC sequence and denoted as E. The correlation of W and W̅ may take E into account as preceding sequence in correlation, and change auto-correlation to AC=<W, R > to AC=< [E W], R > and change cross-correlation to CC=<W̅, R > to CC=< [E W̅], R >.

In some examples, the uplink SYNC base sequence search procedure for non-backscatter devices may be based on the following criteria. One criterion may be an equal number of ones and zeros in the SYNC base sequence. For a length−L base sequence, the sequence may include L/2 ones and L/2 zeros if L is an even number, and (L+1)/2 ones and (L−1)/2 zeros or (L−1)/2 ones and (L+1)/2 zeros if L is an odd number. Another criterion may be that length L is an even number. A further criterion may be the chip sequence does not contain ‘0000’ (if used for 2 μs chip duration) or ‘00000000’ (if used for 1 μs but not 2 μs chip duration) so as not to have an 8 μs gap (OFF symbols). Another criterion may be the chip sequence does not contain ‘1111’ (if its complementary sequence is used to derive a SYNC sequence for 2 μs chip duration) or ‘11111111’ (if its complementary sequence is used to derive a SYNC sequence for 1 μs but not 2 μs chip duration). A further criterion may be that the SYNC sequence starts with a one (ON symbol) because the SYNC sequence does not include a preamble. Another criterion (e.g., for downlink communications) may be that the SYNC sequence contain one or more invalid Manchester patterns such as ‘111’ or ‘000’ in the chip sequence to differentiate from the Manchester-OOK data field and help with packet detection and timing estimate. A further criterion may be good correlation property. Good correlation may have multiple objectives. A first objective may be to minimize the largest sidelobe(s) before the main peak to minimize the chance that the sidelobes trigger a first timing. Further objectives may be to minimize a largest value before the main peak (|S₁ₐ|), and for a given largest value before the main peak (|S₁ₐ|), minimize the quantity of sidelobes that reach the largest value before the main peak (|S₁ₐ|). Additionally, another objective may be to minimize the width of the main lobe (e.g., to minimize the searching period of time in the method of estimated main peak) and to minimize the last sidelobe before the main peak (such as in the chip level correlation, to reduce or minimize the value of the last correlator output before the main peak). If the SYNC base sequence is used to derive a longer SYNC sequence with repetition, additional objectives for good correlation property may be to minimize the largest sidelobe(s) between adjacent main peaks, to minimize the largest value between adjacent main peaks, and for a given largest value between adjacent main peaks, to minimize the quantity of sidelobes that reach the largest value between adjacent main peak (e.g., the circular correlation property has very low or no sidelobes).

The uplink SYNC base sequence search procedure for non-backscatter devices may be based on good autocorrelation. A cost function may be used to maximize the peak-to-largest-sidelobe ratio

$$( {α}_{1} = \frac{{P}_{1}}{\vert {S}_{1} \vert} )$$

or minimize the largest sidelobe (|S₁|) in AC if its complementary sequence is not used to derive the SYNC sequence(s). The cost function may be used to maximize the ratio between the peak and the largest sidelobe magnitude in

$$AC ( \frac{{P}_{1}}{max ( \vert {S}_{1} \vert , \vert {L}_{1} \vert )} )$$

or minimize the largest sidelobe magnitude (max(|S₁|,|L₁|)), or maximize a cost function of two quantities, where the first quantity is

$${β}_{1} = \frac{{P}_{1}}{max ( \vert {S}_{1} \vert , \vert {L}_{2} \vert )} ,$$

and the second quantity is

$${β}_{2} = \frac{\vert {P}_{2} \vert}{max ( \vert {S}_{2} \vert , \vert {L}_{1} \vert )}$$

or minimize a cost function of two quantities, where the first quantity is max (|S₁|,|L₂|), and the second quantity is max (|S₂|,|L₁|). For the SYNC base sequence search, the search may define a largest sidelobe before peak (|S₁ₐ| (which is the largest value of AC before the peak), a largest sidelobe after peak (|S_{1b}| (which is the largest value of AC after the peak), a largest negative sidelobe before peak (|L₁ₐ| (which is the smallest value of AC before the peak), and a largest negative sidelobe after peak (|L_{1b}| (which is the smallest value of AC after the peak) in AC. The search may define a largest negative sidelobe before negative peak (|S₂ₐ|, (where S₂ₐ is the smallest value before the negative peak), a largest negative sidelobe after negative peak (|S_{2b}| (where S₂) is the smallest value after the negative peak), a largest positive sidelobe before negative peak (|L₂ₐ| (which is the largest value of CC before the peak), and a largest positive sidelobe after negative peak (|L_{2b}| (which is the largest value of CC after the peak) in CC.

In some examples, the SYNC field base sequence search may be based on a property of good correlation. To identify a SYNC field base sequence with good correlation, a cost function is used to maximize the modified peak-to-largest-sidelobe ratio

$$( {α}_{m 1} = \frac{{P}_{1}}{{f}_{1} ( \vert {S}_{1 a} \vert , \vert {S}_{1 b} \vert )} )$$

or minimize the modified largest sidelobe (ƒ₁(|S₁ₐ|,|S_{1b}|)) in AC if its complementary sequence is not used to derive sync sequence(s), where ƒ₁(|S₁ₐ|,|S_{1b}|) is a function designed to put more weight in |S₁ₐ| than |S_{1b}|. For example, ƒ₁(a,b)=a, so that the cost function is to maximize the peak-to-largest-sidelobe ratio before the peak of the main lobe in

$$AC ( {α}_{m 1} = \frac{{P}_{1}}{\vert {S}_{1 a} \vert} ) ,$$

or minimize the largest sidelobe before the peak of the main lobe in AC (|S₁ₐ|). To identify a SYNC field base sequence with good correlation, a cost function is used to maximize the modified ratio between the peak and the largest sidelobe magnitude in

$$AC ( \frac{{P}_{1}}{max ( {f}_{1} ( \vert {S}_{1 a} \vert , \vert {S}_{1 b} \vert ) , {f}_{2} ( \vert {L}_{2 a} \vert , \vert {L}_{2 b} \vert ) )} )$$

or minimize the largest sidelobe magnitude (max(ƒ₁(|S₁ₐ|,|S_{1b}|), ƒ₂(|L₂ₐ|,|L_{2b}|))), where ƒ₂(|L₂ₐ|,|L_{2b}|) is a function designed to put more weight in |L₂ₐ| than |L_{2b}|, or maximize a cost function of two quantities, where the first quantity is

$${β}_{m 1} = \frac{{P}_{1}}{max ( {f}_{1} ( \vert {S}_{1 a} \vert , \vert {S}_{1 b} \vert ) , {f}_{2} ( \vert {L}_{2 a} \vert , \vert {L}_{2 b} \vert ) )} ,$$

and the second quantity is

$${β}_{m 2} = \frac{\vert {P}_{2} \vert}{max ( {f}_{1} ( \vert {S}_{2 a} \vert , \vert {S}_{2 b} \vert ) , {f}_{2} ( \vert {L}_{1 a} \vert , \vert {L}_{1 b} \vert ) )}$$

or minimize a cost function of two quantities where the first quantity is max(ƒ₁(|S₁ₐ|,|S_{1b}|), ƒ₂(|L₂ₐ|,|L_{2b}|)), and the second quantity is max(ƒ₁(|S₂ₐ|,|S_{2b}|), ƒ₂(|L₁ₐ|,|L_{1b}|)). For example, ƒ₁(a,b)=ƒ₂(a,b)=a, so that the cost function is to maximize the modified ratio between the peak and the largest sidelobe magnitude before the peak of the main lobe in

$$AC ( \frac{{P}_{1}}{max ( \vert {S}_{1 a} \vert , \vert {L}_{2 a} \vert )} )$$

or minimize the largest sidelobe magnitude before the peak of the main lobe in AC (max (|S₁ₐ|,|L₂ₐ|)), or maximize a cost function of two quantities, where the first quantity is

$${β}_{m 1} = \frac{{P}_{1}}{max ( \vert {S}_{1 a} \vert , \vert {L}_{2 a} \vert )} ,$$

and the second quantity is

$${β}_{m 2} = \frac{\vert {P}_{2} \vert}{max ( \vert {S}_{2 a} \vert , \vert {L}_{1 a} \vert ) )}$$

or minimize a cost function of two quantities, where the first quantity is max (|S₁ₐ|,|L₂ₐ|), and the second quantity is max (|S₂ₐ|,|L₁ₐ|).

Optimization in uplink SYNC sequence search may include maximizing autocorrelation of W. With Auto-correlation AC=<W,2*W−1> (which is essentially a cross correlation between W and the reference signal R=2*W−1) and three quantities (P₁, S₁ and L₁), different optimizations may use different cost functions. In one example, the linear gap in AC may be maximized, such as A=P₁−S₁. In another example, the gap ratio in AC may be maximized, which equals the linear gap divided by the range of auto-correlation values, and the range is defined as (P₁-L₁+Δ) with a positive margin Δ, and the gap ratio is

$${A}_{ratio} = \frac{A}{( {P}_{1} - {L}_{1} + Δ )} = \frac{( {P}_{1} - {S}_{1} )}{( {P}_{1} - {L}_{1} + Δ )} .$$

In a further example, the ratio between the peak and the 2^{nd} largest sidelobe with the same sign in AC may be maximized, such as the ratio between the positive peak and the second largest positive sidelobe in the auto-correlation,

$${α}_{1} = \frac{{P}_{1}}{\vert {S}_{1} \vert} .$$

In another example, the ratio between the peak and the largest sidelobe magnitude in AC may be maximized, such as,

$$\text{?} = \frac{{P}_{1}}{max ( \vert {S}_{1} \vert , \vert {L}_{1} \vert )} .$$

For the uplink SYNC sequence search procedure, different binary sequences W may be searched to maximize the respective auto-correlation, using one or more optimization criteria as indicated herein, to obtain a set of sequences that optimize the criteria. The different binary sequences W may be narrowed down with additional search criteria. For example, if W is not based on a Manchester-OOK design, find sequences within the set to satisfy the following properties of three consecutive “ones” or three consecutive “zeros” and does not have more than three consecutive “zeros”. If W is based on a Manchester-OOK design, the different binary sequences may not be down selected. The selected sequence within the set of sequences may satisfy the three consecutive “ones” or three consecutive “zeros” and does not have more than three consecutive “zeros” criteria.

For the downlink SYNC sequence search procedure, the autocorrelation of W may be maximized and the associated negative sidelobes may be minimized. With auto-correlation AC=<W,2*W−1> (which is essentially a cross correlation between W and the reference signal R=2*W−1) and the three quantities (P₁, S₁ and L₁), as well as cross-correlation between the complementary sequence W̅ and the reference signal R=2*W−1, such as CC=<W̅,2*W−1> and the three quantities (L₂, S₂ and P₂), different cost function may be used for different optimizations. The above examples associated with maximizing the W sequence detection performance for the uplink sequence search may be used to the downlink sequence search. In a further example, the ratio between the peak of auto-correlation AC=<W,2*W−1> and the maximum between the 2^{nd} largest sidelobe of auto-correlation AC=<W,2*W−1> and the largest positive sidelobe of the cross-correlation CC=<W,2*W−1>, such as,

$${β}_{1} = \frac{{P}_{1}}{max ( \vert {S}_{1} \vert , \vert {L}_{2} \vert )}$$

may be maximized. The following examples also consider balancing between maximizing the W sequence detection performance and maximizing the W̅ sequence detection performance. For example, a cost function of the linear gaps A=P₁−S₁ and B=−P₂+S₂, may be maximized, such as, max ƒ₁(A,B), and one example may be a weight sum, ƒ₁(A,B)=q_{A}×A+q_{B}×B. In another example, a cost function of the gap ratios

$${A}_{ratio} = \frac{( {P}_{1} - {S}_{1} )}{( {P}_{1} - {L}_{1} + Δ )} and {B}_{ratio} = \frac{B}{- {P}_{2} + {L}_{2}} = \frac{- {P}_{2} + {S}_{2}}{- {P}_{2} + {L}_{2}} ,$$

may be maximized, such as max ƒ₂(Aᵣₐₜᵢₒ, Bᵣₐₜᵢₒ), one example may be a weight sum, ƒ₂(Aᵣₐₜᵢₒ, Bᵣₐₜᵢₒ)=q_{A}×Aᵣₐₜᵢₒ+q_{B}×Bᵣₐₜᵢₒ. In a further example, a cost function of the ratio between the peak and the second largest sidelobe with the same sign in AC may be maximized, such

$${α}_{1} = \frac{{P}_{1}}{\vert {S}_{1} \vert}$$

and the ratio between the negative peak and the second largest sidelobe with the same sign in CC, such as

$${α}_{2} = \vert \frac{{P}_{2}}{{S}_{2}} \vert ,$$

such as, max ƒ₃( [symbol] , [symbol] ), one example is a weight sum, ƒ₃( [symbol] , [symbol] )=q₁×α₁+q₂×α₂. In another example, a cost function of the ratio between the peak and the largest sidelobe magnitude in AC may be maximized, such as

$$\text{?} = \frac{{P}_{1}}{max ( \vert {S}_{1} \vert , \vert {L}_{1} \vert )} ,$$

and the ratio between the negative peak magnitude and the largest sidelobe magnitude in CC, such as

$$\text{?} = \frac{{P}_{2}}{max ( \vert {S}_{2} \vert , \vert {L}_{2} \vert )} ,$$

such as, max ƒ₄(α₁,α₂), one example is a weight sum, ƒ₄(α₁,α₂)=q₁× [symbol] +q₂× [symbol] .

For the downlink SYNC sequence search procedure, the autocorrelation of W may be maximized and the associated negative sidelobes may be minimized. For example, a cost function of two quantities may be maximized, where the first quantity is the ratio between the peak of auto-correlation AC=<W,2*W−1> and the maximum between the 2^{nd} largest sidelobe of auto-correlation AC=<W,2*W−1> and the largest positive sidelobe of the cross-correlation CC=<W̅,2*W−1>, such as,

$${β}_{1} = \frac{{P}_{1}}{max ( \vert {S}_{1} \vert , \vert {L}_{2} \vert )} ,$$

and the second quantity is the ratio between the negative peak of cross-correlation CC=<W̅,2*W−1> and the maximum between the second largest negative sidelobe of cross-correlation CC=<W̅,2*W−1> and the largest negative sidelobe of the auto-correlation AC=<W,2*W−1>, such as,

$${β}_{2} = \frac{\vert {P}_{2} \vert}{max ( \vert {S}_{2} \vert , \vert {L}_{1} \vert )} ,$$

as, max ƒ₅(β₁,β₂), one example is a weight sum, ƒ₅(β₁,β₂)=q₁×β₁+q₂×β₂. In another example, the downlink SYNC sequence search procedure may be similar to the uplink SYNC sequence search procedure where the optimization criteria may be replaced by the optimization criteria associated with downlink.

In some examples, for the downlink SYNC sequence search procedure, a receiver processing and timing estimate for the SYNC field may be considered. A first timing may indicate a timing of a first correlator output that exceeds a threshold. The threshold may be determined by a 1% false alarm rate (e.g., noise within a period of time (e.g., 16 μs) has a 1% chance that at least one correlator output exceeds the threshold). A packet may not be detected if a sample is not detected that exceeds the threshold. The first timing may be triggered by large sidelobe(s) before the main peak or somewhere within the main lobe but before the main peak. For example, large sidelobes and a ramp-up in the main lobe may trigger the first timing. The first timing may not be directly used for a timing estimate. In some examples, a practical timing estimate method may estimate a main peak as a timing corresponding to a maximum value within a period of time starting from the first timing. The practical timing estimate method may consider a one chip duration, a two chip duration, a four chip duration, an eight chip duration, and so on, up to the length of sequence as the period of time, in search of the maximum value. The method may buffer the received signal for the period of time. Using the one chip duration as the period of time may perform well for chip durations of 2 us, 1 μs, 0.5 μs, 0.25 μs and 0.125 μs. For the 2 μs chip duration, a longer period of time (e.g., length of sequence) may be used or the criteria may be relaxed. In some examples, three variables may be used in the estimated main peak algorithm: 1) a counter to count the number of samples from the first timing till the end of the period of time, 2) a variable to keep the maximum value within the period of time, and 3) a variable to keep the index of the maximum value within the period of time. In some examples, a special segment may be used for the receiver processing and timing estimate procedure. For example, the estimate process may a use a length-Q special segment (e.g., a length-6 special segment based on the last 6 chips in the sequence, or another 6 chips appended to the end of the sequence) to further reduce false alarm. The estimate process may consider a period of time (e.g., [−6,+6] chips, [−8,+8] chips, and so on) relative to the first timing. The threshold for ON and OFF symbols demodulation may be assumed based on the average power (e.g., moving average with a window duration) until the first timing. The estimate process may use four timing hypotheses with 1/4 chip durations apart starting from the first timing (e.g., + [0, 1/4, 1/2, 3/4] chip durations). Within the period of time, the estimate process may try different timing hypothesis to see if the special segment could be found, and if not, this may be a false alarm.

Table I illustrates candidate SYNC sequences for length N and decimal value D in S(N,D) and the binary sequence. The candidate SYNC sequences shown in Table I have a sequence search criteria of good cross correlation (CC) of W and R (such as, maximize ratio of largest peak of AC to second largest peak of AC, at least one string of three zeros in a row, at least one string of three ones in a row, no strings of four zeros in a row and no strings of four ones in a row. The sequences shown in Table I may be used for uplink communications or downlink communications. In some cases, the sequences shown in Table I may also be used for device-to-device communications or point-to-point communication between various wireless nodes without using an access point.

TABLE I

| Length | Decimal | Binary Sequence W |
|---|---|---|
| 16 | 39239 | 1 0 0 1 1 0 0 1 0 1 0 0 0 1 1 1 |
| 18 | 150981 | 1 0 0 1 0 0 1 1 0 1 1 1 0 0 0 1 0 1 |
| 20 | 576421 | 1 0 0 0 1 1 0 0 1 0 1 1 1 0 1 0 0 1 0 1 |
| 22 | 2339493 | 1 0 0 0 1 1 1 0 1 1 0 0 1 0 1 0 1 0 0 1 0 1 |
| 24 | 10842515 | 1 0 1 0 0 1 0 1 0 1 1 1 0 0 0 1 1 0 0 1 0 0 1 1 |
| 26 | 37169769 | 1 0 0 0 1 1 0 1 1 1 0 0 1 0 1 0 1 0 0 1 1 0 1 0 0 1 |
| 32 | 1903250356 | 0 1 1 1 0 0 0 1 0 1 1 1 0 0 0 1 0 1 0 0 1 0 1 1 1 0 1 1 0 1 0 0 |

Table II illustrates candidate SYNC sequences for length 32. The candidate binary sequences shown in Table I have a sequence search criteria of good cross correlation (CC) of W and R (such as, maximize ratio of largest peak of AC to second largest peak of AC), at least one string of three zeros in a row, at least one string of three ones in a row, no strings of four zeros in a row and no strings of four ones in a row. The sequences shown in Table II may be used for uplink communications or downlink communications. In some cases, the sequences shown in Table II may also be used for device-to-device communications or point-to-point communication between various wireless nodes without using an access point.

TABLE II

| Length | Binary Sequence W |
|---|---|
| 32 | 10100101100110110001010111000110 |
| 32 | 10011100101101001000101101010101 |
| 32 | 10101010110100010010110100111001 |
| 32 | 01110001011100010100101110110100 |
| 32 | 01100011101010001101100110100101 |
| 32 | 00101101110100101000111010001110 |

Table III illustrates candidate SYNC sequences for length N and decimal value D in S(N,D) and the binary sequence. The candidate SYNC sequences shown in Table III have a sequence search criteria of good cross correlation (CC) of W and R (such as, maximize the linear gap A or gap ratio Aᵣₐₜᵢₒ between the largest peak of AC to second largest peak of AC). Some of the sequence with four or more “Ones” may be used as an uplink SYNC sequence, or a downlink SYNC sequence if the SYNC field design is Manchester-OOK based (such as the SYNC sequence needs to go through Manchester encoding). The sequences shown in Table III may be used for uplink communications or downlink communications. In some cases, the sequences shown in Table III may also be used for device-to-device communications or point-to-point communication between various wireless nodes without using an access point.

TABLE III

| Length | Decimal | Binary Sequence W |
|---|---|---|
| 4 | 6 | 0 1 1 0 |
| 4 | 11 | 1 0 1 1 |
| 4 | 13 | 1 1 0 1 |
| 6 | 39 | 1 0 0 1 1 1 |
| 6 | 55 | 1 1 0 1 1 1 |
| 6 | 57 | 1 1 1 0 0 1 |
| 6 | 59 | 1 1 1 0 1 1 |
| 8 | 215 | 1 1 0 1 0 1 1 1 |
| 8 | 235 | 1 1 1 0 1 0 1 1 |
| 10 | 377 | 0 1 0 1 1 1 1 0 0 1 |
| 10 | 461 | 0 1 1 1 0 0 1 1 0 1 |
| 10 | 634 | 1 0 0 1 1 1 1 0 1 0 |
| 10 | 718 | 1 0 1 1 0 0 1 1 1 0 |
| 12 | 2767 | 1 0 1 0 1 1 0 0 1 1 1 1 |
| 12 | 3767 | 1 1 1 0 1 0 1 1 0 1 1 1 |
| 12 | 3799 | 1 1 1 0 1 1 0 1 0 1 1 1 |
| 12 | 3893 | 1 1 1 1 0 0 1 1 0 1 0 1 |
| 14 | 11111 | 1 0 1 0 1 1 0 1 1 0 0 1 1 1 |
| 14 | 13671 | 1 1 0 1 0 1 0 1 1 0 0 1 1 1 |
| 14 | 13727 | 1 1 0 1 0 1 1 0 0 1 1 1 1 1 |
| 14 | 13911 | 1 1 0 1 1 0 0 1 0 1 0 1 1 1 |
| 14 | 14763 | 1 1 1 0 0 1 1 0 1 0 1 0 1 1 |
| 14 | 14773 | 1 1 1 0 0 1 1 0 1 1 0 1 0 1 |
| 14 | 15003 | 1 1 1 0 1 0 1 0 0 1 1 0 1 1 |
| 14 | 15979 | 1 1 1 1 1 0 0 1 1 0 1 0 1 1 |
| 16 | 19937 | 0 1 0 0 1 1 0 1 1 1 1 0 0 0 0 1 |
| 16 | 34738 | 1 0 0 0 0 1 1 1 1 0 1 1 0 0 1 0 |
| 16 | 46877 | 1 0 1 1 0 1 1 1 0 0 0 1 1 1 0 1 |
| 16 | 53998 | 1 1 0 1 0 0 1 0 1 1 1 0 1 1 1 0 |
| 16 | 55511 | 1 1 0 1 1 0 0 0 1 1 0 1 0 1 1 1 |
| 16 | 59095 | 1 1 1 0 0 1 1 0 1 1 0 1 0 1 1 1 |
| 16 | 60263 | 1 1 1 0 1 0 1 1 0 1 1 0 0 1 1 1 |
| 18 | 85232 | 0 1 0 1 0 0 1 1 0 0 1 1 1 1 0 0 0 0 |
| 18 | 222439 | 1 1 0 1 1 0 0 1 0 0 1 1 1 0 0 1 1 1 |
| 18 | 236699 | 1 1 1 0 0 1 1 1 0 0 1 0 0 1 1 0 1 1 |
| 20 | 765243 | 1 0 1 1 1 0 1 0 1 1 0 1 0 0 1 1 1 0 1 1 |
| 20 | 904029 | 1 1 0 1 1 1 0 0 1 0 1 1 0 1 0 1 1 1 0 1 |
| 20 | 945327 | 1 1 1 0 0 1 1 0 1 1 0 0 1 0 1 0 1 1 1 1 |
| 20 | 1004391 | 1 1 1 1 0 1 0 1 0 0 1 1 0 1 1 0 0 1 1 1 |
| 22 | 1794903 | 0 1 1 0 1 1 0 1 1 0 0 0 1 1 0 1 0 1 0 1 1 1 |
| 22 | 3369303 | 1 1 0 0 1 1 0 1 1 0 1 0 0 1 0 1 0 1 0 1 1 1 |
| 22 | 3843507 | 1 1 1 0 1 0 1 0 1 0 0 1 0 1 1 0 1 1 0 0 1 1 |
| 22 | 3846582 | 1 1 1 0 1 0 1 0 1 1 0 0 0 1 1 0 1 1 0 1 1 0 |
| 22 | 3879639 | 1 1 1 0 1 1 0 0 1 1 0 0 1 0 1 1 0 1 0 1 1 1 |
| 22 | 3905119 | 1 1 1 0 1 1 1 0 0 1 0 1 1 0 0 1 0 1 1 1 1 1 |
| 22 | 3984223 | 1 1 1 1 0 0 1 1 0 0 1 0 1 1 0 1 0 1 1 1 1 1 |
| 22 | 4102775 | 1 1 1 1 1 0 1 0 0 1 1 0 1 0 0 1 1 1 0 1 1 1 |
| 22 | 4109519 | 1 1 1 1 1 0 1 0 1 1 0 1 0 0 1 1 0 0 1 1 1 1 |
| 24 | 11963293 | 1 0 1 1 0 1 1 0 1 0 0 0 1 0 1 1 1 0 0 1 1 1 0 1 |
| 24 | 12177773 | 1 0 1 1 1 0 0 1 1 1 0 1 0 0 0 1 0 1 1 0 1 1 0 1 |
| 24 | 15059567 | 1 1 1 0 0 1 0 1 1 1 0 0 1 0 1 0 0 1 1 0 1 1 1 1 |
| 24 | 15393975 | 1 1 1 0 1 0 1 0 1 1 1 0 0 1 0 0 1 0 1 1 0 1 1 1 |
| 24 | 15419191 | 1 1 1 0 1 0 1 1 0 1 0 0 0 1 1 1 0 0 1 1 0 1 1 1 |
| 24 | 15524567 | 1 1 1 0 1 1 0 0 1 1 1 0 0 0 1 0 1 1 0 1 0 1 1 1 |
| 24 | 15542103 | 1 1 1 0 1 1 0 1 0 0 1 0 0 1 1 1 0 1 0 1 0 1 1 1 |
| 24 | 16143271 | 1 1 1 1 0 1 1 0 0 1 0 1 0 0 1 1 1 0 1 0 0 1 1 1 |
| 26 | 47887135 | 1 0 1 1 0 1 1 0 1 0 1 0 1 1 0 0 1 1 0 0 0 1 1 1 1 1 |
| 26 | 57895383 | 1 1 0 1 1 1 0 0 1 1 0 1 1 0 1 0 0 1 1 1 0 1 0 1 1 1 |
| 26 | 60599455 | 1 1 1 0 0 1 1 1 0 0 1 0 1 0 1 1 0 0 1 0 0 1 1 1 1 1 |
| 26 | 61695567 | 1 1 1 0 1 0 1 1 0 1 0 1 1 0 0 1 1 0 0 1 0 0 1 1 1 1 |
| 26 | 61758267 | 1 1 1 0 1 0 1 1 1 0 0 1 0 1 1 0 1 1 0 0 1 1 1 0 1 1 |
| 26 | 63544023 | 1 1 1 1 0 0 1 0 0 1 1 0 0 1 1 0 1 0 1 1 0 1 0 1 1 1 |
| 26 | 65221997 | 1 1 1 1 1 0 0 0 1 1 0 0 1 1 0 1 0 1 0 1 1 0 1 1 0 1 |
| 26 | 65328359 | 1 1 1 1 1 0 0 1 0 0 1 1 0 1 0 1 0 0 1 1 1 0 0 1 1 1 |

Table IV illustrates candidate SYNC sequences for length 16 for a Manchester-OOK based design. The candidate binary sequences shown in Table IV have a sequence search criteria of good cross correlation (CC) of W and R (such as, maximize ratio of largest peak of AC to second largest peak of AC). The SYNC sequence needs to go through Manchester encoding to obtain a 32-bit sequence for the SYNC field. The sequences shown in Table IV may be used for uplink communications or downlink communications. In some cases, the sequences shown in Table IV may also be used for device-to-device communications or point-to-point communication between various wireless nodes without using an access point.

TABLE IV

| Length | Decimal | Binary Sequence W |
|---|---|---|
| 16 | 15509 | 0 0 1 1 1 1 0 0 1 0 0 1 0 1 0 1 |
| 16 | 22211 | 0 1 0 1 0 1 1 0 1 1 0 0 0 0 1 1 |
| 16 | 43324 | 1 0 1 0 1 0 0 1 0 0 1 1 1 1 0 0 |
| 16 | 50026 | 1 1 0 0 0 0 1 1 0 1 1 0 1 0 1 0 |

Table V illustrates candidate SYNC base sequences. The candidate SYNC base sequences shown in Table V meet the criteria for the uplink SYNC base sequence search procedure for non-backscatter devices as described above. The sequences shown in Table V may be used for uplink communications or downlink communications. In some cases, the sequences shown in Table V may also be used for device-to-device communications or point-to-point communication between various wireless nodes without using an access point.

TABLE V

| Length | Decimal | Binary Sequence W |
|---|---|---|
| 16 | 39239 | 1001100101000111 |
| 20 | 675512 | 10100100111010111000 |
| 24 | 9129704 | 100010110100111011101000 |
| 28 | 80146759 | 0100110001101111000101000111 |
| 32 | 1903250356 | 01110001011100010100101110110100 |

Table VI illustrates candidate SYNC base sequences for length 28 (single sided). The candidate binary sequences S shown in Table VI are good SYNC base sequences if S is used (but its complementary sequence S̅=1−S is not used). The three examples in Table VI that end with ‘111000’ may help with SYNC field detection, timing estimate and minimizing false alarm from Manchester-OOK signals. The sequences shown in Table VI may be used for uplink communications or downlink communications. In some cases, the sequences shown in Table VI may also be used for device-to-device communications or point-to-point communication between various wireless nodes without using an access point.

TABLE VI

| Length | Decimal | Binary Base Sequence S |
|---|---|---|
| 28 | 144963881 | 1000101000111111100100101001 |
| 28 | 145693496 | 1000101011110001101100111000 |
| 28 | 148497080 | 1000110110011110001010111000 |
| 28 | 150051180 | 1000111100011001100101101100 |
| 28 | 155579956 | 1001010001011111011000110100 |
| 28 | 155692582 | 1001010001111010111000100110 |
| 28 | 155841868 | 1001010010011111010101001100 |
| 28 | 155843665 | 1001010010011111110001010001 |
| 28 | 160618154 | 1001100100101101011010101010 |
| 28 | 171776466 | 1010001111010001100111010010 |
| 28 | 172457048 | 1010010001110111110001011000 |
| 28 | 176935820 | 1010100010111101001110001100 |
| 28 | 178867046 | 1010101010010100101101100110 |
| 28 | 185953592 | 1011000101010110110100111000 |
| 28 | 206032530 | 1100010001111100111010010010 |
| 28 | 237565490 | 1110001010001111011000110010 |

Table VII illustrates candidate SYNC base sequences for length 28 (double sided). The candidate binary sequences S shown in Table VII are good SYNC base sequences if both S and its complementary sequence S̅=1−S are used. The sequences in Table VII that include a segment ‘000111’ or ‘111000’ at the end or near the end of the sequence may help with SYNC field detection, timing estimate and minimizing false alarm from Manchester-OOK signals. The sequences shown in Table VII may be used for uplink communications or downlink communications. In some cases, the sequences shown in Table VII may also be used for device-to-device communications or point-to-point communication between various wireless nodes without using an access point.

TABLE VII

| Length | Decimal | Binary Base Sequence S |
|---|---|---|
| 28 | 154483015 | 1001001101010011100101000111 |
| 28 | 157634119 | 1001011001010100111001000111 |
| 28 | 162617671 | 1001101100010101100101000111 |
| 28 | 186967367 | 1011001001001110010101000111 |
| 28 | 186988871 | 1011001001010011100101000111 |
| 28 | 210478478 | 1100100010111010010110001110 |
| 28 | 152794396 | 1001000110110111010100011100 |
| 28 | 158092984 | 1001011011000100111010111000 |

Table VIII illustrates candidate SYNC base sequences for length 16. The candidate binary sequences S shown in Table VIII are good SYNC base sequences if S is used and S̅ is not used. The sequences in Table VIII are good SYNC base sequences for both S and S̅ for the 1 μs chip duration but not the 2 μs chip duration. The S base sequences in Table VIII that do not include ‘1111’ (marked with 16*) are good SYNC base sequences for both S and S̅ for the 2 μs chip duration. The examples in Table VIII that include ‘111’ and/or ‘000’ may help with SYNC field detection, timing estimate and minimizing false alarm from Manchester-OOK signals. The sequences shown in Table VIII may be used for uplink communications or downlink communications. In some cases, the sequences shown in Table VIII may also be used for device-to-device communications or point-to-point communication between various wireless nodes without using an access point.

TABLE VIII

| Length | Decimal | Binary Base Sequence S |
|---|---|---|
| 16 | 35704 | 1100110001011010 |
| 16* | 35749 | 1000101110100101 |
| 16* | 35764 | 1000101110110100 |
| 16 | 35782 | 1000101111000110 |
| 16 | 35794 | 1000101111010010 |
| 16 | 35800 | 1000101111011000 |
| 16 | 35812 | 1000101111100100 |
| 16* | 36212 | 1000110101110100 |
| 16* | 36280 | 1000110110111000 |
| 16* | 36306 | 1000110111010010 |
| 16* | 36568 | 1000111011011000 |
| 16 | 36645 | 1000111100100101 |
| 16 | 36681 | 1000111101001001 |
| 16 | 36708 | 1000111101100100 |
| 16 | 36772 | 1000111110100100 |
| 16 | 37617 | 1001001011110001 |
| 16 | 37844 | 1001001111010100 |
| 16 | 37858 | 1001001111100010 |
| 16 | 38012 | 1001010001111100 |
| 16 | 38136 | 1001010011111000 |
| 16* | 38516 | 1001011001110100 |
| 16 | 38852 | 1001011111000100 |
| 16 | 39156 | 1001100011110100 |
| 16* | 39239 | 1001100101000111 |
| 16 | 41938 | 1010001111010010 |
| 16 | 41944 | 1010001111011000 |
| 16 | 41956 | 1010001111100100 |
| 16 | 42225 | 1010010011110001 |
| 16* | 42449 | 1010010111010001 |
| 16 | 42616 | 1010011001111000 |
| 16 | 43250 | 1010100011110010 |
| 16 | 43324 | 1010100100111100 |
| 16* | 43414 | 1010100110010110 |
| 16 | 43492 | 1010100111100100 |
| 16* | 45724 | 1011001010011100 |
| 16* | 45852 | 1011001100011100 |
| 16* | 46222 | 1011010010001110 |
| 16* | 46364 | 1011010100011100 |
| 16* | 50642 | 1100010111010010 |
| 16* | 52314 | 1100110001011010 |
| 16* | 58009 | 1110001010011001 |
| 16 | 35786 | 1000101111001010 |
| 16 | 37241 | 1001000101111001 |
| 16 | 37564 | 1001001010111100 |
| 16 | 37834 | 1001001111001010 |
| 16 | 38204 | 1001010100111100 |
| 16 | 40532 | 1001111001010100 |
| 16 | 40585 | 1001111010001001 |
| 16* | 50459 | 1100010100011011 |
| 16* | 50540 | 1100010101101100 |
| 16* | 50604 | 1100010110101100 |
| 16* | 50827 | 1100011010001011 |
| 16* | 51548 | 1100100101011100 |
| 16* | 51751 | 1100101000100111 |
| 16* | 51783 | 1100101001000111 |
| 16* | 51804 | 1100101001011100 |
| 16* | 51828 | 1100101001110100 |
| 16* | 52648 | 1100110110101000 |
| 16* | 53603 | 1101000101100011 |
| 16* | 53676 | 1101000110101100 |
| 16* | 54488 | 1101010011011000 |
| 16* | 55459 | 1101100010100011 |
| 16* | 57939 | 1110001001010011 |
| 16* | 58451 | 1110010001010011 |
| 16* | 58580 | 1110010011010100 |
| 16* | 59980 | 1110101001001100 |

Table IX illustrates candidate SYNC base sequences for length 32. The first three candidate binary sequences S shown in Table IX are good SYNC base sequences if S is used and S̅ is not used. The candidate binary sequences S after the third entry of Table IX are good SYNC base sequences for both S and S̅ for the 1 μs chip duration but not the 2 μs chip duration. The candidate binary sequences S after the third entry of Table IX marked as 32*are good SYNC base sequences for both S and S̅ for the 2 μs chip duration. The examples in Table IX that include ‘111’ and/or ‘000’ may help with SYNC field detection, timing estimate and minimizing false alarm from Manchester-OOK signals. The sequences shown in Table IX may be used for uplink communications or downlink communications. In some cases, the sequences shown in Table IX may also be used for device-to-device communications or point-to-point communication between various wireless nodes without using an access point.

TABLE IX

| Length | Decimal | Binary Base Sequence S |
|---|---|---|
| 32 | 2629077845 | 10011100101101001000101101010101 |
| 32 | 2778404294 | 10100101100110110001010111000110 |
| 32 | 2865835321 | 10101010110100010010110100111001 |
| 32 | 3398682812 | 11001010100100111100100010111100 |
| 32* | 2973391175 | 10110001001110100101100101000111 |
| 32* | 3007994951 | 10110011010010100101110001000111 |
| 32* | 3158992325 | 10111100010010100110010111000101 |
| 32* | 3795473101 | 11100010001110100101001011001101 |
| 32* | 3801767053 | 11100010100110100101110010001101 |
| 32* | 3902435753 | 11101000100110100111000110101001 |
| 32 | 3903933388 | 11101000101100010100101111001100 |
| 32* | 2509134103 | 10010101100011100101100100010111 |
| 32 | 2745586237 | 10100011101001100101001000111101 |
| 32* | 3410421902 | 11001011010001101110100010001110 |
| 32* | 3795465818 | 11100010001110100011011001011010 |
| 32* | 3809944282 | 11100011000101110010001011011010 |
| 32* | 2397609260 | 10001110111010001001110100101100 |
| 32 | 2563498708 | 10011000110010111110001011010100 |
| 32* | 2763724600 | 10100100101110110001011100111000 |
| 32* | 2777916344 | 10100101100100111010001110111000 |

Table X illustrates repetition based, SYNC base sequences S for length 16. The repetition structure may be using more than one copies of S, such as [S S] for two times repetition, [S S S] for three times repetition, [S S S S] for four times repetition, and so on. In some examples, the candidate SYNC base sequences may be based on the SYNC base sequence search criteria of: 1) equal numbers of 1s and 0s, 2) the length L is an even number, 3) the chip sequence does not contain ‘0000’ (if used for 2 μs chip duration) or ‘00000000’ (if used for 1 μs but not 2 μs chip duration) so as not to have an 8 μs gap (OFF symbols), 4) starts with ‘1’ (ON symbol), because there is no prior preamble, 5) good correlation property (e.g., multiple objectives of 1) minimize the largest sidelobe(s) before the main peak (to minimize the change that sidelobes triggers first timing), 2) minimize the largest value before the main peak (i.e., min |S₁ₐ|), 3) for a given largest value before the main peak (i.e., |S₁ₐ|), minimize the number of sidelobes that reach the largest value before the main peak (|S₁ₐ|), 4) minimize the width of the main lobe (to minimize the searching period of time in the method of estimated main peak), and 5) minimize the last negative sidelobe before the main peak (such as in the chip level correlation, to minimize the value of the last correlator output before the main peak), and 6) good correlation property with repetition criteria (e.g., multiple objectives of: 1) minimize the largest sidelobe(s) between adjacent main peaks, 2) minimize the largest value between adjacent main peaks, 3) for a given largest value between adjacent main peaks, minimize the number of sidelobes that reach the largest value between adjacent main peak). All 54 sequences listed in Table X satisfy the criteria of: 1) all sidelobes before the first main peak are <=0, and 2) all sidelobes between adjacent main peaks are <=0. The candidate sequences marked as 16*satisfy the criteria of 1) all sidelobes before the first main peak are <=0, 2) all sidelobes between adjacent main peaks are <=0, and 3) the last sidelobe before the first main peak is −2, so that the width of the main lobe is minimized under 1) and 2). The candidate sequences marked as 16& satisfy the criteria of 1) all sidelobes before the first main peak are <=0, 2) up to 2 sidelobes before the main peak reach a value of 0, and 3) the last sidelobe before the first main peak is −2, so that the width of the main lobe is minimized under 1) and 2). The candidate sequences marked as 16~ satisfy may be used for a first symbol duration (e.g., 1 microsecond) but may not be suitable for a second symbol duration (e.g., 2 microsecond), whereas other sequences could be used for the second chip duration (e.g., 2 microsecond). The sequences shown in Table X may be used for uplink communications or downlink communications. In some cases, the sequences shown in Table X may also be used for device-to-device communications or point-to-point communication between various wireless nodes without using an access point.

TABLE X

| Length | Decimal Value | Binary Sequence |
|---|---|---|
| 16 | 38768 | 1 0 0 1 0 1 1 1 0 1 1 1 0 0 0 0 |
| 16 | 39664 | 1 0 0 1 1 0 1 0 1 1 1 1 0 0 0 0 |
| 16 | 40744 | 1 0 0 1 1 1 1 1 0 0 1 0 1 0 0 0 |
| 16 | 42736 | 1 0 1 0 0 1 1 0 1 1 1 1 0 0 0 0 |
| 16 | 42948 | 1 0 1 0 0 1 1 1 1 1 0 0 0 1 0 0 |
| 16 | 42952 | 1 0 1 0 0 1 1 1 1 1 0 0 1 0 0 0 |
| 16 | 44272 | 1 0 1 0 1 1 0 0 1 1 1 1 0 0 0 0 |
| 16 | 44812 | 1 0 1 0 1 1 1 1 0 0 0 0 1 1 0 0 |
| 16 | 46032 | 1 0 1 1 0 0 1 1 1 1 0 1 0 0 0 0 |
| 16 | 46704 | 1 0 1 1 0 1 1 0 0 1 1 1 0 0 0 0 |
| 16~ | 46860 | 1 0 1 1 0 1 1 1 0 0 0 0 1 1 0 0 |
| 16 | 47332 | 1 0 1 1 1 0 0 0 1 1 1 0 0 1 0 0 |
| 16~ | 47568 | 1 0 1 1 1 0 0 1 1 1 0 1 0 0 0 0 |
| 16~ | 47884 | 1 0 1 1 1 0 1 1 0 0 0 0 1 1 0 0 |
| 16 | 48228 | 1 0 1 1 1 1 0 0 0 1 1 0 0 1 0 0 |
| 16 | 48336 | 1 0 1 1 1 1 0 0 1 1 0 1 0 0 0 0 |
| 16 | 48396 | 1 0 1 1 1 1 0 1 0 0 0 0 1 1 0 0 |
| 16 | 48408 | 1 0 1 1 1 1 0 1 0 0 0 1 1 0 0 0 |
| 16 | 48432 | 1 0 1 1 1 1 0 1 0 0 1 1 0 0 0 0 |
| 16 | 51106 | 1 1 0 0 0 1 1 1 1 0 1 0 0 0 1 0 |
| 16 | 52164 | 1 1 0 0 1 0 1 1 1 1 0 0 0 1 0 0 |
| 16 | 52176 | 1 1 0 0 1 0 1 1 1 1 0 1 0 0 0 0 |
| 16~ | 52592 | 1 1 0 0 1 1 0 1 0 1 1 1 0 0 0 0 |
| 16 | 53002 | 1 1 0 0 1 1 1 1 0 0 0 0 1 0 1 0 |
| 16 | 53010 | 1 1 0 0 1 1 1 1 0 0 0 1 0 0 1 0 |
| 16& | 54184 | 1 1 0 1 0 0 1 1 1 0 1 0 1 0 0 0 |
| 16* | 54704 | 1 1 0 1 0 1 0 1 1 0 1 1 0 0 0 0 |
| 16 | 55008 | 1 1 0 1 0 1 1 0 1 1 1 0 0 0 0 0 |
| 16 | 55136 | 1 1 0 1 0 1 1 1 0 1 1 0 0 0 0 0 |
| 16 | 55522 | 1 1 0 1 1 0 0 0 1 1 1 0 0 0 1 0 |
| 16 | 55746 | 1 1 0 1 1 0 0 1 1 1 0 0 0 0 1 0 |
| 16~ | 55920 | 1 1 0 1 1 0 1 0 0 1 1 1 0 0 0 0 |
| 16* | 55984 | 1 1 0 1 1 0 1 0 1 0 1 1 0 0 0 0 |
| 16 | 56032 | 1 1 0 1 1 0 1 0 1 1 1 0 0 0 0 0 |
| 16 | 56088 | 1 1 0 1 1 0 1 1 0 0 0 1 1 0 0 0 |
| 16& | 56402 | 1 1 0 1 1 1 0 0 0 1 0 1 0 0 1 0 |
| 16 | 56496 | 1 1 0 1 1 1 0 0 1 0 1 1 0 0 0 0 |
| 16& | 56616 | 1 1 0 1 1 1 0 1 0 0 1 0 1 0 0 0 |
| 16~ | 56624 | 1 1 0 1 1 1 0 1 0 0 1 1 0 0 0 0 |
| 16 | 56672 | 1 1 0 1 1 1 0 1 0 1 1 0 0 0 0 0 |
| 16 | 56852 | 1 1 0 1 1 1 1 0 0 0 0 1 0 1 0 0 |
| 16 | 56872 | 1 1 0 1 1 1 1 0 0 0 1 0 1 0 0 0 |
| 16& | 58786 | 1 1 1 0 0 1 0 1 1 0 1 0 0 0 1 0 |
| 16~ | 58800 | 1 1 1 0 0 1 0 1 1 0 1 1 0 0 0 0 |
| 16~ | 58832 | 1 1 1 0 0 1 0 1 1 1 0 1 0 0 0 0 |
| 16 | 59088 | 1 1 1 0 0 1 1 0 1 1 0 1 0 0 0 0 |
| 16& | 59796 | 1 1 1 0 1 0 0 1 1 0 0 1 0 1 0 0 |
| 16~ | 59824 | 1 1 1 0 1 0 0 1 1 0 1 1 0 0 0 0 |
| 16 | 59844 | 1 1 1 0 1 0 0 1 1 1 0 0 0 1 0 0 |
| 16& | 59992 | 1 1 1 0 1 0 1 0 0 1 0 1 1 0 0 0 |
| 16* | 60178 | 1 1 1 0 1 0 1 1 0 0 0 1 0 0 1 0 |
| 16& | 60180 | 1 1 1 0 1 0 1 1 0 0 0 1 0 1 0 0 |
| 16~ | 60208 | 1 1 1 0 1 0 1 1 0 0 1 1 0 0 0 0 |
| 16&~ | 60228 | 1 1 1 0 1 0 1 1 0 1 0 0 0 1 0 0 |
| 16 | 60256 | 1 1 1 0 1 0 1 1 0 1 1 0 0 0 0 0 |
| 16 | 60304 | 1 1 1 0 1 0 1 1 1 0 0 1 0 0 0 0 |
| 16~ | 60592 | 1 1 1 0 1 1 0 0 1 0 1 1 0 0 0 0 |
| 16~ | 60624 | 1 1 1 0 1 1 0 0 1 1 0 1 0 0 0 0 |
| 16* | 60692 | 1 1 1 0 1 1 0 1 0 0 0 1 0 1 0 0 |
| 16 | 60696 | 1 1 1 0 1 1 0 1 0 0 0 1 1 0 0 0 |
| 16~ | 60720 | 1 1 1 0 1 1 0 1 0 0 1 1 0 0 0 0 |
| 16 | 60768 | 1 1 1 0 1 1 0 1 0 1 1 0 0 0 0 0 |
| 16 | 60946 | 1 1 1 0 1 1 1 0 0 0 0 1 0 0 1 0 |
| 16~ | 60948 | 1 1 1 0 1 1 1 0 0 0 0 1 0 1 0 0 |
| 16 | 61072 | 1 1 1 0 1 1 1 0 1 0 0 1 0 0 0 0 |
| 16 | 61642 | 1 1 1 1 0 0 0 0 1 1 0 0 1 0 1 0 |
| 16 | 61772 | 1 1 1 1 0 0 0 1 0 1 0 0 1 1 0 0 |
| 16 | 61834 | 1 1 1 1 0 0 0 1 1 0 0 0 1 0 1 0 |
| 16 | 61842 | 1 1 1 1 0 0 0 1 1 0 0 1 0 0 1 0 |
| 16 | 61844 | 1 1 1 1 0 0 0 1 1 0 0 1 0 1 0 0 |
| 16 | 61860 | 1 1 1 1 0 0 0 1 1 0 1 0 0 1 0 0 |
| 16 | 61864 | 1 1 1 1 0 0 0 1 1 0 1 0 1 0 0 0 |
| 16* | 62036 | 1 1 1 1 0 0 1 0 0 1 0 1 0 1 0 0 |
| 16 | 62092 | 1 1 1 1 0 0 1 0 1 0 0 0 1 1 0 0 |
| 16 | 62104 | 1 1 1 1 0 0 1 0 1 0 0 1 1 0 0 0 |
| 16* | 62116 | 1 1 1 1 0 0 1 0 1 0 1 0 0 1 0 0 |
| 16 | 62148 | 1 1 1 1 0 0 1 0 1 1 0 0 0 1 0 0 |
| 16~ | 62218 | 1 1 1 1 0 0 1 1 0 0 0 0 1 0 1 0 |
| 16 | 62226 | 1 1 1 1 0 0 1 1 0 0 0 1 0 0 1 0 |
| 16 | 62228 | 1 1 1 1 0 0 1 1 0 0 0 1 0 1 0 0 |
| 16 | 62248 | 1 1 1 1 0 0 1 1 0 0 1 0 1 0 0 0 |
| 16 | 62274 | 1 1 1 1 0 0 1 1 0 1 0 0 0 0 1 0 |
| 16 | 62288 | 1 1 1 1 0 0 1 1 0 1 0 1 0 0 0 0 |
| 16 | 62540 | 1 1 1 1 0 1 0 0 0 1 0 0 1 1 0 0 |
| 16 | 62604 | 1 1 1 1 0 1 0 0 1 0 0 0 1 1 0 0 |
| 16 | 62616 | 1 1 1 1 0 1 0 0 1 0 0 1 1 0 0 0 |
| 16 | 62658 | 1 1 1 1 0 1 0 0 1 1 0 0 0 0 1 0 |
| 16 | 62664 | 1 1 1 1 0 1 0 0 1 1 0 0 1 0 0 0 |
| 16~ | 62732 | 1 1 1 1 0 1 0 1 0 0 0 0 1 1 0 0 |
| 16 | 62744 | 1 1 1 1 0 1 0 1 0 0 0 1 1 0 0 0 |
| 16 | 62768 | 1 1 1 1 0 1 0 1 0 0 1 1 0 0 0 0 |
| 16 | 62864 | 1 1 1 1 0 1 0 1 1 0 0 1 0 0 0 0 |
| 16~ | 62996 | 1 1 1 1 0 1 1 0 0 0 0 1 0 1 0 0 |
| 16 | 63016 | 1 1 1 1 0 1 1 0 0 0 1 0 1 0 0 0 |
| 16 | 63056 | 1 1 1 1 0 1 1 0 0 1 0 1 0 0 0 0 |
| 16 | 63112 | 1 1 1 1 0 1 1 0 1 0 0 0 1 0 0 0 |
| 16 | 63636 | 1 1 1 1 1 0 0 0 1 0 0 1 0 1 0 0 |
| 16 | 63652 | 1 1 1 1 1 0 0 0 1 0 1 0 0 1 0 0 |
| 16 | 63764 | 1 1 1 1 1 0 0 1 0 0 0 1 0 1 0 0 |
| 16 | 63784 | 1 1 1 1 1 0 0 1 0 0 1 0 1 0 0 0 |
| 16 | 63812 | 1 1 1 1 1 0 0 1 0 1 0 0 0 1 0 0 |
| 16 | 63816 | 1 1 1 1 1 0 0 1 0 1 0 0 1 0 0 0 |

Table XI illustrates a non-repetition based, SYNC base sequences for length 32. In some examples, the candidate SYNC base sequences may be based on the SYNC base sequence search criteria of: 1) equal numbers of 1s and 0s, 2) the length L is an even number, 3) the chip sequence does not contain ‘0000’ (if used for 2 μs chip duration) or ‘00000000’ (if used for 1 us but not 2 μs chip duration) so as not to have an 8 μs gap (OFF symbols), 4) starts with ‘1’ (ON symbol), because there is no prior preamble, 5) good correlation property (e.g., multiple objectives of 1) minimize the largest sidelobe(s) before the main peak (to minimize the change that sidelobes triggers 1^{st} timing), 2) minimize the largest value before the main peak (i.e., min |S₁ₐ|), 3) for a given largest value before the main peak (i.e., |S₁ₐ|), minimize the number of sidelobes that reach the largest value before the main peak (|S₁ₐ|), 4) minimize the width of the main lobe (to minimize the searching period of time in the method of estimated main peak), and 5) maximize the magnitude of the last negative sidelobe before the main peak (such as in the chip level correlation, to reduce or minimize the value of the last correlator output before the main peak)). The candidate sequence marked as 32*satisfy the criteria of: 1) all sidelobes before the main peak are <=−1, 2), all sidelobes after the main peak are <=3, and 3) the last sidelobe before the main peak is −2. The two candidate sequences marked as 32 #satisfy the criteria of: 1) all sidelobes before the first main peak are <=0, 2) all sidelobes after the main peak are <=2, and 3) the last sidelobe before the first main peak is −6, so that the width of the main lobe is minimized. The remaining candidate sequences satisfy the criteria of: 1) all sidelobes before the first main peak are <=0, and 2) all sidelobes after the main peak are <=2. The sequences shown in Table XI may be used for uplink communications or downlink communications. In some cases, the sequences shown in Table XI may also be used for device-to-device communications or point-to-point communication between various wireless nodes without using an access point.

TABLE XI

| Length | Decimal Value | Binary Sequence |
|---|---|---|
| 32* | 4205992132 | 1 1 1 1 1 0 1 0 1 0 1 1 0 0 1 0 0 1 0 1 1 0 0 0 1 1 0 0 0 1 0 0 |
| 32# | 4079330644 | 1 1 1 1 0 0 1 1 0 0 1 0 0 1 0 1 1 0 1 0 0 1 0 1 0 1 0 1 0 1 0 0 |
| 32# | 4080309418 | 1 1 1 1 0 0 1 1 0 0 1 1 0 1 0 0 1 0 0 1 0 1 0 0 1 0 1 0 1 0 1 0 |
| 32 | 4053378218 | 1 1 1 1 0 0 0 1 1 0 0 1 1 0 0 1 1 0 1 0 0 1 0 0 1 0 1 0 1 0 1 0 |
| 32 | 3102365384 | 1 0 1 1 1 0 0 0 1 1 1 0 1 0 1 0 0 1 0 1 0 1 1 0 1 1 0 0 1 0 0 0 |
| 32 | 4048991384 | 1 1 1 1 0 0 0 1 0 1 0 1 0 1 1 0 1 0 1 1 0 1 0 0 1 0 0 1 1 0 0 0 |
| 32 | 4197225868 | 1 1 1 1 1 0 1 0 0 0 1 0 1 1 0 0 1 0 0 1 0 1 0 1 1 0 0 0 1 1 0 0 |
| 32 | 3099113288 | 1 0 1 1 1 0 0 0 1 0 1 1 1 0 0 0 1 0 1 1 0 1 1 1 0 1 0 0 1 0 0 0 |
| 32 | 3944011992 | 1 1 1 0 1 0 1 1 0 0 0 1 0 1 0 0 1 1 0 1 1 0 0 0 1 1 0 1 1 0 0 0 |
| 32 | 3071863016 | 1 0 1 1 0 1 1 1 0 0 0 1 1 0 0 0 1 1 1 0 1 0 0 0 1 1 1 0 1 0 0 0 |
| 32 | 3813405764 | 1 1 1 0 0 0 1 1 0 1 0 0 1 0 1 1 1 1 1 1 0 1 0 0 0 1 0 0 0 1 0 0 |
| 32 | 4074048716 | 1 1 1 1 0 0 1 0 1 1 0 1 0 1 0 1 0 0 0 0 1 1 0 0 1 1 0 0 1 1 0 0 |
| 32 | 3581038468 | 1 1 0 1 0 1 0 1 0 1 1 1 0 0 1 0 0 1 0 0 1 1 1 1 1 0 0 0 0 1 0 0 |
| 32 | 3538997060 | 1 1 0 1 0 0 1 0 1 1 1 1 0 0 0 0 1 1 0 0 1 1 1 1 0 1 0 0 0 1 0 0 |
| 32 | 3652488816 | 1 1 0 1 1 0 0 1 1 0 1 1 0 1 0 0 1 0 0 0 1 1 1 0 0 1 1 1 0 0 0 0 |
| 32 | 3902700112 | 1 1 1 0 1 0 0 0 1 0 0 1 1 1 1 0 0 1 1 1 1 0 1 0 0 1 0 1 0 0 0 0 |
| 32 | 3915150176 | 1 1 1 0 1 0 0 1 0 1 0 1 1 1 0 0 0 1 1 1 0 0 1 1 0 1 1 0 0 0 0 0 |
| 32 | 2892887064 | 1 0 1 0 1 1 0 0 0 1 1 0 1 1 0 1 1 1 1 1 0 1 0 0 0 0 0 1 1 0 0 0 |
| 32 | 3674712968 | 1 1 0 1 1 0 1 1 0 0 0 0 0 1 1 1 1 0 1 0 1 0 1 1 1 0 0 0 1 0 0 0 |
| 32 | 4040088224 | 1 1 1 1 0 0 0 0 1 1 0 0 1 1 1 0 1 1 0 1 1 0 1 0 1 0 1 0 0 0 0 0 |
| 32 | 2900989888 | 1 0 1 0 1 1 0 0 1 1 1 0 1 0 0 1 1 0 0 1 0 1 1 1 1 1 0 0 0 0 0 0 |
| 32 | 3638195648 | 1 1 0 1 1 0 0 0 1 1 0 1 1 0 1 0 0 1 1 1 0 1 0 1 1 1 0 0 0 0 0 0 |
| 32 | 3645336512 | 1 1 0 1 1 0 0 1 0 1 0 0 0 1 1 1 0 1 1 0 1 0 1 1 1 1 0 0 0 0 0 0 |

Table XII illustrates a repetition based SYNC base sequences for variable lengths (including length 8). In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XII may show examples of the base sequence. In some examples, the candidate SYNC base sequences may be based on the SYNC base sequence search criteria of: 1) equal numbers of 1s and 0s, 2) the length L is an even number, 3) the chip sequence does not contain ‘0000’ (if used for 2 μs chip duration) or ‘00000000’ (if used for 1 us but not 2 μs chip duration) so as not to have—an 8 μs gap (OFF symbols), 4) starts with ‘1’ (ON symbol), because there is no prior preamble, and 5) good correlation property (e.g., multiple objectives of 1) minimize the largest sidelobe(s) before the main peak (to minimize the change that sidelobes triggers 1^{st} timing), 2) minimize the largest value before the main peak (i.e., min |S₁ₐ|), 3) for a given largest value before the main peak (i.e., |S₁ₐ|), minimize the number of sidelobes that reach the largest value before the main peak (|S₁ₐ|), 4) minimize the width of the main lobe (to minimize the searching period of time in the method of estimated main peak), and 5) maximize the magnitude of the last negative sidelobe before the main peak (such as in the chip level correlation, to reduce or minimize the value of the last correlator output before the main peak)). All of the candidate sequences satisfy the criteria of: 1) all sidelobes before the first main peak are <=0, and 2) all sidelobes between adjacent main peaks are <=0. The candidate sequence marked as 8*satisfy the criteria of: 1) all sidelobes before the first main peak are <=0, 2) all sidelobes between adjacent main peaks are <=0, and 3) the last sidelobe before the first main peak is −2, so that the width of the main lobe is minimized. The candidate sequence marked as 8& satisfy the criteria of: 1) all sidelobes before the first main peak are <=0, 2) all sidelobes between adjacent main peaks are <=0, and 3) up to 1 sidelobe before the main peak (which is at the beginning of the main lobe) reaches a value of 0 and all sidelobes before that are <=−1. The sequences shown in Table XII may be used for uplink communications or downlink communications. In some cases, the sequences shown in Table XII may also be used for device-to-device communications or point-to-point communication between various wireless nodes without using an access point.

TABLE XII

| Length | Decimal Value | Binary Sequence |
|---|---|---|
| 8* | 172 | 1 0 1 0 1 1 0 0 |
| 8 | 184 | 1 0 1 1 1 0 0 0 |
| 8* | 202 | 1 1 0 0 1 0 1 0 |
| 8* | 212 | 1 1 0 1 0 1 0 0 |
| 8 | 216 | 1 1 0 1 1 0 0 0 |
| 8 | 226 | 1 1 1 0 0 0 1 0 |
| 8& | 228 | 1 1 1 0 0 1 0 0 |
| 8 | 232 | 1 1 1 0 1 0 0 0 |

Table XIII illustrates non-repetition based, SYNC base sequences for length 24. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XIII may show examples of the base sequence. In some examples, the candidate SYNC base sequences in Table XIII satisfy the criteria of: 1) all sidelobes before the first main peak are <=0. The candidate sequence marked as 24*satisfy the criteria of: 1) all sidelobes before the first main peak are <−0 and 2) up to 1 sidelobes before the main peak reach a value of 0. The candidate sequence marked as 24~ satisfy the criteria of: 1) all sidelobes before the first main peak are <=0, 2) up to 1 sidelobes before the main peak reach a value of 0, and 3) all sidelobes between adjacent main peaks are <=0. The candidate sequence marked as 24& satisfy the criteria of: 1) all sidelobes before the first main peak are <=0, 2) up to 1 sidelobes before the main peak reach a value of 0, 3) The sidelobes after the main peak are <=2, and 4) Up to 3 sidelobe before the main peak reaching value of 0. The sequences shown in Table XIII may be used for uplink communications or downlink communications. In some cases, the sequences shown in Table XIII may also be used for device-to-device communications or point-to-point communication between various wireless nodes without using an access point.

TABLE XIII

| Length | Decimal Value | Binary Sequence |
|---|---|---|
| 24~ | 16081700 | 1 1 1 1 0 1 0 1 0 1 1 0 0 0 1 1 0 0 1 0 0 1 0 0 |
| 24* | 16094408 | 1 1 1 1 0 1 0 1 1 0 0 1 0 1 0 0 1 1 0 0 1 0 0 0 |
| 24~ | 16410132 | 1 1 1 1 1 0 1 0 0 1 1 0 0 1 1 0 0 0 0 1 0 1 0 0 |
| 24& | 15962792 | 1 1 1 1 0 0 1 1 1 0 0 1 0 0 1 0 1 0 1 0 1 0 0 0 |

Table XIV illustrates repetition based, SYNC base sequences for length 28. In some examples, the candidate SYNC base sequences in Table XIV satisfy the criteria of: 1) all sidelobes before the first main peak are <−0 and 2) up to 1 sidelobes before the main peak reaches a value of 0. The candidate sequence marked as 28*satisfy the criteria of: 1) all sidelobes before the first main peak are <=0, 2) up to 1 sidelobes before the main peak reaches a value of 0, and 3) the last sidelobe before the first main peak has value of 0 and it essentially becomes part of the main lobe. The sequences shown in Table XIV may be used for uplink communications or downlink communications. In some cases, the sequences shown in Table XIV may also be used for device-to-device communications or point-to-point communication between various wireless nodes without using an access point.

TABLE XIV

| Length | Decimal Value | Binary Sequence |
|---|---|---|
| 28 | 248705348 | 1 1 1 0 1 1 0 1 0 0 1 0 1 1 1 1 0 0 0 1 0 1 0 0 0 1 0 0 |
| 28 | 256727428 | 1 1 1 1 0 1 0 0 1 1 0 1 0 1 0 1 1 0 0 1 1 0 0 0 0 1 0 0 |
| 28 | 257320324 | 1 1 1 1 0 1 0 1 0 1 1 0 0 1 1 0 0 1 0 1 1 0 0 0 0 1 0 0 |
| 28* | 261837188 | 1 1 1 1 1 0 0 1 1 0 1 1 0 1 0 1 0 0 0 1 1 0 0 0 0 1 0 0 |
| 28* | 262779076 | 1 1 1 1 1 0 1 0 1 0 0 1 1 0 1 1 0 0 0 0 1 1 0 0 0 1 0 0 |
| 28 | 263002436 | 1 1 1 1 1 0 1 0 1 1 0 1 0 0 0 1 1 0 0 1 0 1 0 0 0 1 0 0 |
| 28 | 263301284 | 1 1 1 1 1 0 1 1 0 0 0 1 1 0 1 0 1 0 0 0 1 0 1 0 0 1 0 0 |
| 28* | 263368900 | 1 1 1 1 1 0 1 1 0 0 1 0 1 0 1 1 0 0 0 0 1 1 0 0 0 1 0 0 |
| 28* | 264968516 | 1 1 1 1 1 1 0 0 1 0 1 1 0 0 0 1 1 0 0 1 0 1 0 0 0 1 0 0 |
| 28* | 264971028 | 1 1 1 1 1 1 0 0 1 0 1 1 0 0 1 0 0 0 1 1 0 0 0 1 0 1 0 0 |

Table XV illustrates repetition based, SYNC base sequences for length 28. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XV may show examples of the base sequence. In some examples, the candidate SYNC base sequences in Table XV satisfy the criteria of: 1) all sidelobes before the first main peak are <=0 and 2) all sidelobes between adjacent main peaks are <−0. The candidate sequence marked as 28*satisfy the criteria of: 1) all sidelobes before the first main peak are <=0, 2) all sidelobes between adjacent main peaks are <=0, and 3) the last sidelobe before the first main peak is −2, so that the width of the main lobe is minimized. The candidate sequence marked as 28~ satisfy the criteria of: all sidelobes before the first main peak are <=0, 2) all sidelobes between adjacent main peaks are <=0, and 3) up to 2 sidelobes before the main peak reach the value of 0. The candidate sequence marked as 28& satisfy the criteria of: 1) all sidelobes before the first main peak are <=0, 2) all sidelobes between adjacent main peaks are <−0, 3) the last sidelobe before the first main peak is −2, so that the width of the main lobe is minimized, and 4) up to 2 sidelobes before the main peak reach the value of 0. The sequences shown in Table XV may be used for uplink communications or downlink communications. In some cases, the sequences shown in Table XV may also be used for device-to-device communications or point-to-point communication between various wireless nodes without using an access point.

TABLE XV

| Length | Decimal Value | Binary Sequence |
|---|---|---|
| 28 | 159272488 | 1 0 0 1 0 1 1 1 1 1 1 0 0 1 0 0 1 1 1 0 0 0 1 0 1 0 0 0 |
| 28 | 192476228 | 1 0 1 1 0 1 1 1 1 0 0 0 1 1 1 1 0 1 0 0 0 1 0 0 0 1 0 0 |
| 28 | 192698508 | 1 0 1 1 0 1 1 1 1 1 0 0 0 1 0 1 1 0 0 0 1 0 0 0 1 1 0 0 |
| 28 | 199550220 | 1 0 1 1 1 1 1 0 0 1 0 0 1 1 1 0 0 1 0 1 0 0 0 0 1 1 0 0 |
| 28 | 213798480 | 1 1 0 0 1 0 1 1 1 1 1 0 0 1 0 0 1 1 1 0 0 1 0 1 0 0 0 0 |
| 28 | 233034002 | 1 1 0 1 1 1 1 0 0 0 1 1 1 1 0 1 0 0 0 1 0 0 0 1 0 0 1 0 |
| 28 | 234400048 | 1 1 0 1 1 1 1 1 1 0 0 0 1 0 1 0 1 0 0 1 0 0 1 1 0 0 0 0 |
| 28 | 241950994 | 1 1 1 0 0 1 1 0 1 0 1 1 1 1 1 0 0 0 0 1 0 0 0 1 0 0 1 0 |
| 28 | 244282500 | 1 1 1 0 1 0 0 0 1 1 1 1 0 1 1 1 0 1 0 0 1 0 0 0 0 1 0 0 |
| 28 | 246911280 | 1 1 1 0 1 0 1 1 0 1 1 1 1 0 0 1 0 0 0 1 0 0 1 1 0 0 0 0 |
| 28& | 247142032 | 1 1 1 0 1 0 1 1 1 0 1 1 0 0 0 1 0 1 1 0 1 0 0 1 0 0 0 0 |
| 28 | 247350928 | 1 1 1 0 1 0 1 1 1 1 1 0 0 1 0 0 0 1 1 0 1 0 0 1 0 0 0 0 |
| 28 | 250704402 | 1 1 1 0 1 1 1 1 0 0 0 1 0 1 1 1 0 0 1 0 0 0 0 1 0 0 1 0 |
| 28 | 250770472 | 1 1 1 0 1 1 1 1 0 0 1 0 0 1 1 1 0 1 0 0 0 0 1 0 1 0 0 0 |
| 28* | 250782928 | 1 1 1 0 1 1 1 1 0 0 1 0 1 0 1 0 0 1 0 0 1 1 0 1 0 0 0 0 |
| 28 | 250792144 | 1 1 1 0 1 1 1 1 0 0 1 0 1 1 0 0 1 0 0 0 1 1 0 1 0 0 0 0 |
| 28 | 251156756 | 1 1 1 0 1 1 1 1 1 0 0 0 0 1 0 1 1 0 0 1 0 0 0 1 0 1 0 0 |
| 28 | 251216584 | 1 1 1 0 1 1 1 1 1 0 0 1 0 1 0 0 0 0 1 0 1 1 0 0 1 0 0 0 |
| 28 | 253610130 | 1 1 1 1 0 0 0 1 1 1 0 1 1 1 0 0 1 0 0 0 1 0 0 1 0 0 1 0 |
| 28 | 253612196 | 1 1 1 1 0 0 0 1 1 1 0 1 1 1 0 1 0 0 0 0 1 0 1 0 0 1 0 0 |
| 28 | 253678114 | 1 1 1 1 0 0 0 1 1 1 1 0 1 1 0 1 0 0 1 0 0 0 1 0 0 0 1 0 |
| 28 | 255189282 | 1 1 1 1 0 0 1 1 0 1 0 1 1 1 1 0 0 0 0 1 0 0 1 0 0 0 1 0 |
| 28 | 255287592 | 1 1 1 1 0 0 1 1 0 1 1 1 0 1 1 0 0 0 0 1 0 0 1 0 1 0 0 0 |
| 28* | 256748296 | 1 1 1 1 0 1 0 0 1 1 0 1 1 0 1 0 1 0 1 1 0 0 0 0 1 0 0 0 |
| 28 | 257550480 | 1 1 1 1 0 1 0 1 1 0 0 1 1 1 1 0 1 0 0 0 1 0 0 1 0 0 0 0 |
| 28* | 258568744 | 1 1 1 1 0 1 1 0 1 0 0 1 0 1 1 1 0 0 1 0 0 0 1 0 1 0 0 0 |
| 28~ | 258704964 | 1 1 1 1 0 1 1 0 1 0 1 1 1 0 0 0 0 1 1 0 0 1 0 0 0 1 0 0 |
| 28 | 261822786 | 1 1 1 1 1 0 0 1 1 0 1 1 0 0 0 1 1 0 0 1 0 1 0 0 0 0 1 0 |
| 28 | 262990096 | 1 1 1 1 1 0 1 0 1 1 0 0 1 1 1 0 1 0 0 1 0 0 0 1 0 0 0 0 |
| 28~ | 263066308 | 1 1 1 1 1 0 1 0 1 1 1 0 0 0 0 1 0 0 1 0 1 1 0 0 0 1 0 0 |
| 28~ | 263394480 | 1 1 1 1 1 0 1 1 0 0 1 1 0 0 0 1 0 1 0 0 1 0 1 1 0 0 0 0 |
| 28 | 263505000 | 1 1 1 1 1 0 1 1 0 1 0 0 1 1 0 0 0 1 0 0 0 1 1 0 1 0 0 0 |
| 28~ | 263756308 | 1 1 1 1 1 0 1 1 1 0 0 0 1 0 0 1 1 0 1 0 0 0 0 1 0 1 0 0 |
| 28 | 263800016 | 1 1 1 1 1 0 1 1 1 0 0 1 0 1 0 0 0 1 0 0 1 1 0 1 0 0 0 0 |
| 28 | 264607818 | 1 1 1 1 1 1 0 0 0 1 0 1 1 0 0 1 1 0 0 0 0 1 0 0 1 0 1 0 |
| 28~ | 264710434 | 1 1 1 1 1 1 0 0 0 1 1 1 0 0 1 0 1 0 0 1 0 0 1 0 0 0 1 0 |
| 28 | 264881426 | 1 1 1 1 1 1 0 0 1 0 0 1 1 1 0 0 0 1 0 1 0 0 0 1 0 0 1 0 |
| 28 | 264980002 | 1 1 1 1 1 1 0 0 1 0 1 1 0 1 0 0 0 1 1 0 0 0 1 0 0 0 1 0 |
| 28 | 265839784 | 1 1 1 1 1 1 0 1 1 0 0 0 0 1 1 0 0 1 0 0 1 0 1 0 1 0 0 0 |
| 28~ | 266507364 | 1 1 1 1 1 1 1 0 0 0 1 0 1 0 0 1 0 1 0 0 0 1 1 0 0 1 0 0 |
| 28 | 266650920 | 1 1 1 1 1 1 1 0 0 1 0 0 1 1 0 0 0 1 0 1 0 0 1 0 1 0 0 0 |
| 28 | 149732704 | 1 0 0 0 1 1 1 0 1 1 0 0 1 0 1 1 1 1 0 1 0 1 1 0 0 0 0 0 |
| 28 | 182347200 | 1 0 1 0 1 1 0 1 1 1 1 0 0 1 1 0 0 1 0 1 1 1 0 0 0 0 0 0 |
| 28 | 190300556 | 1 0 1 1 0 1 0 1 0 1 1 1 1 1 0 0 0 0 0 1 1 0 0 0 1 1 0 0 |
| 28 | 191808624 | 1 0 1 1 0 1 1 0 1 1 1 0 1 1 0 0 0 1 0 0 0 1 1 1 0 0 0 0 |
| 28 | 192267968 | 1 0 1 1 0 1 1 1 0 1 0 1 1 1 0 0 0 1 1 0 1 1 0 0 0 0 0 0 |
| 28 | 196522432 | 1 0 1 1 1 0 1 1 0 1 1 0 1 0 1 1 0 0 0 1 1 1 0 0 0 0 0 0 |
| 28 | 196576560 | 1 0 1 1 1 0 1 1 0 1 1 1 1 0 0 0 0 1 0 1 0 0 1 1 0 0 0 0 |
| 28 | 196727488 | 1 0 1 1 1 0 1 1 1 0 0 1 1 1 0 1 0 0 1 0 1 1 0 0 0 0 0 0 |
| 28 | 196823152 | 1 0 1 1 1 0 1 1 1 0 1 1 0 1 0 0 1 0 0 0 0 1 1 1 0 0 0 0 |
| 28 | 198603360 | 1 0 1 1 1 1 0 1 0 1 1 0 0 1 1 1 0 0 1 0 0 1 1 0 0 0 0 0 |
| 28 | 198990348 | 1 0 1 1 1 1 0 1 1 1 0 0 0 1 0 1 1 0 1 0 0 0 0 0 1 1 0 0 |
| 28 | 199673424 | 1 0 1 1 1 1 1 0 0 1 1 0 1 1 0 0 0 1 1 0 0 1 0 1 0 0 0 0 |
| 28 | 215944488 | 1 1 0 0 1 1 0 1 1 1 1 1 0 0 0 0 1 1 0 1 0 0 1 0 1 0 0 0 |
| 28 | 216514898 | 1 1 0 0 1 1 1 0 0 1 1 1 1 1 0 0 0 0 0 1 0 1 0 1 0 0 1 0 |
| 28 | 221148992 | 1 1 0 1 0 0 1 0 1 1 1 0 0 1 1 1 0 1 1 1 0 1 0 0 0 0 0 0 |
| 28 | 226127392 | 1 1 0 1 0 1 1 1 1 0 1 0 0 1 1 0 1 1 1 0 0 0 1 0 0 0 0 0 |
| 28 | 227457856 | 1 1 0 1 1 0 0 0 1 1 1 0 1 0 1 1 1 0 1 1 0 1 0 0 0 0 0 0 |
| 28 | 228420480 | 1 1 0 1 1 0 0 1 1 1 0 1 0 1 1 0 1 0 1 1 1 0 0 0 0 0 0 0 |
| 28 | 229590128 | 1 1 0 1 1 0 1 0 1 1 1 1 0 1 0 0 0 1 0 0 0 1 1 1 0 0 0 0 |
| 28 | 231438496 | 1 1 0 1 1 1 0 0 1 0 1 1 0 1 1 1 1 0 0 0 1 0 1 0 0 0 0 0 |
| 28 | 232473480 | 1 1 0 1 1 1 0 1 1 0 1 1 0 1 0 0 0 0 1 1 1 0 0 0 1 0 0 0 |
| 28 | 232590866 | 1 1 0 1 1 1 0 1 1 1 0 1 0 0 0 0 1 1 1 0 0 0 0 1 0 0 1 0 |
| 28 | 233200650 | 1 1 0 1 1 1 1 0 0 1 1 0 0 1 0 1 1 1 0 0 0 0 0 0 1 0 1 0 |
| 28 | 233640168 | 1 1 0 1 1 1 1 0 1 1 0 1 0 0 0 1 0 0 0 0 1 1 1 0 1 0 0 0 |
| 28 | 238401344 | 1 1 1 0 0 0 1 1 0 1 0 1 1 0 1 1 0 1 1 1 0 1 0 0 0 0 0 0 |
| 28 | 244182288 | 1 1 1 0 1 0 0 0 1 1 0 1 1 1 1 0 1 1 0 1 0 0 0 1 0 0 0 0 |
| 28 | 244968768 | 1 1 1 0 1 0 0 1 1 0 0 1 1 1 1 0 1 1 0 1 0 1 0 0 0 0 0 0 |
| 28 | 245222688 | 1 1 1 0 1 0 0 1 1 1 0 1 1 1 0 0 1 1 0 1 0 0 1 0 0 0 0 0 |
| 28 | 246259264 | 1 1 1 0 1 0 1 0 1 1 0 1 1 0 0 1 1 1 1 0 0 1 0 0 0 0 0 0 |
| 28 | 246795648 | 1 1 1 0 1 0 1 1 0 1 0 1 1 1 0 0 1 1 0 1 1 0 0 0 0 0 0 0 |
| 28 | 247152856 | 1 1 1 0 1 0 1 1 1 0 1 1 0 1 0 0 0 0 0 0 1 1 0 1 1 0 0 0 |
| 28 | 250921320 | 1 1 1 0 1 1 1 1 0 1 0 0 1 1 0 0 0 0 0 1 0 1 1 0 1 0 0 0 |
| 28 | 254636832 | 1 1 1 1 0 0 1 0 1 1 0 1 0 1 1 1 0 0 1 1 0 0 1 0 0 0 0 0 |
| 28 | 256759328 | 1 1 1 1 0 1 0 0 1 1 0 1 1 1 0 1 0 1 1 0 0 0 1 0 0 0 0 0 |
| 28 | 257542530 | 1 1 1 1 0 1 0 1 1 0 0 1 1 1 0 0 1 0 0 1 1 0 0 0 0 0 1 0 |
| 28 | 257821076 | 1 1 1 1 0 1 0 1 1 1 1 0 0 0 0 0 1 0 0 1 1 0 0 1 0 1 0 0 |
| 28 | 257839904 | 1 1 1 1 0 1 0 1 1 1 1 0 0 1 0 1 0 0 1 1 0 0 1 0 0 0 0 0 |
| 28 | 258594856 | 1 1 1 1 0 1 1 0 1 0 0 1 1 1 0 1 1 0 0 0 0 0 1 0 1 0 0 0 |
| 28 | 258901584 | 1 1 1 1 0 1 1 0 1 1 1 0 1 0 0 0 0 1 1 0 0 1 0 1 0 0 0 0 |
| 28 | 259090482 | 1 1 1 1 0 1 1 1 0 0 0 1 0 1 1 0 1 0 0 0 0 0 1 1 0 0 1 0 |
| 28 | 259427488 | 1 1 1 1 0 1 1 1 0 1 1 0 1 0 0 0 1 1 0 0 1 0 1 0 0 0 0 0 |
| 28 | 259533388 | 1 1 1 1 0 1 1 1 1 0 0 0 0 0 1 0 1 0 1 0 0 1 0 0 1 1 0 0 |
| 28 | 259625632 | 1 1 1 1 0 1 1 1 1 0 0 1 1 0 0 1 0 0 1 0 1 0 1 0 0 0 0 0 |
| 28 | 261935776 | 1 1 1 1 1 0 0 1 1 1 0 0 1 1 0 1 0 0 1 0 1 0 1 0 0 0 0 0 |
| 28 | 262884448 | 1 1 1 1 1 0 1 0 1 0 1 1 0 1 0 0 1 1 0 0 0 1 1 0 0 0 0 0 |
| 28 | 262891024 | 1 1 1 1 1 0 1 0 1 0 1 1 0 1 1 0 0 1 1 0 0 0 0 1 0 0 0 0 |
| 28 | 263411792 | 1 1 1 1 1 0 1 1 0 0 1 1 0 1 0 1 1 0 0 0 0 1 0 1 0 0 0 0 |
| 28 | 263427360 | 1 1 1 1 1 0 1 1 0 0 1 1 1 0 0 1 0 1 0 1 0 0 1 0 0 0 0 0 |
| 28 | 263545632 | 1 1 1 1 1 0 1 1 0 1 0 1 0 1 1 0 0 0 1 1 0 0 1 0 0 0 0 0 |

Table XVI illustrates repetition based, SYNC base sequences for length 32. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XVI may show examples of the base sequence. In some examples, the candidate SYNC base sequences in Table XVI satisfy the criteria of: 1) all sidelobes before the first main peak are <=0 and 2) all sidelobes between adjacent main peaks are <=0. The candidate sequence marked as 32*satisfy the criteria of: 1) all sidelobes before the first main peak are <=0, 2) all sidelobes between adjacent main peaks are <=0, and 3) the last sidelobe before the first main peak is −2, so that the width of the main lobe is minimized. The candidate sequence marked as 32~ satisfy the criteria of: 1) all sidelobes before the first main peak are <=0, 2) all sidelobes between adjacent main peaks are <=0, and 3) up to 2 sidelobes before the main peak reach the value of 0. The sequences shown in Table XVI may be used for uplink communications or downlink communications. In some cases, the sequences shown in Table XVI may also be used for device-to-device communications or point-to-point communication between various wireless nodes without using an access point.

TABLE XVI

| Length | Decimal Value | Binary Sequence |
|---|---|---|
| 32* | 2949270808 | 1 0 1 0 1 1 1 1 1 1 0 0 1 0 1 0 0 1 0 0 1 1 0 1 0 0 0 1 1 0 0 0 |
| 32* | 4208169284 | 1 1 1 1 1 0 1 0 1 1 0 1 0 0 1 1 1 0 0 1 0 0 0 1 0 1 0 0 0 1 0 0 |
| 32* | 4238659978 | 1 1 1 1 1 1 0 0 1 0 1 0 0 1 0 0 1 1 0 1 0 0 0 1 1 0 0 0 1 0 1 0 |
| 32 | 3822881188 | 1 1 1 0 0 0 1 1 1 1 0 1 1 1 0 0 1 0 0 0 1 0 0 1 1 0 1 0 0 1 0 0 |
| 32 | 4109577284 | 1 1 1 1 0 1 0 0 1 1 1 1 0 0 1 1 0 0 1 0 1 1 0 0 0 1 0 0 0 1 0 0 |
| 32~ | 4187788840 | 1 1 1 1 1 0 0 1 1 0 0 1 1 1 0 0 1 0 0 1 0 1 1 0 0 0 1 0 1 0 0 0 |
| 32 | 4199663204 | 1 1 1 1 1 0 1 0 0 1 0 1 0 0 0 1 1 1 0 0 0 1 1 0 0 1 1 0 0 1 0 0 |
| 32 | 4180629640 | 1 1 1 1 1 0 0 1 0 0 1 0 1 1 1 1 0 1 0 1 1 0 0 0 1 0 0 0 1 0 0 0 |
| 32 | 4271518024 | 1 1 1 1 1 1 1 0 1 0 0 1 1 0 1 0 0 0 1 1 0 0 0 1 0 1 0 0 1 0 0 0 |
| 32 | 3617912968 | 1 1 0 1 0 1 1 1 1 0 1 0 0 1 0 0 1 1 1 1 1 0 0 0 1 0 0 0 1 0 0 0 |
| 32* | 4015396424 | 1 1 1 0 1 1 1 1 0 1 0 1 0 1 1 0 0 0 0 1 0 1 1 0 0 1 0 0 1 0 0 0 |
| 32 | 3952592968 | 1 1 1 0 1 0 1 1 1 0 0 1 0 1 1 1 1 1 0 0 1 0 0 0 0 1 0 0 1 0 0 0 |
| 32 | 3999212584 | 1 1 1 0 1 1 1 0 0 1 0 1 1 1 1 1 0 0 1 0 0 1 0 0 0 0 1 0 1 0 0 0 |
| 32 | 4149463184 | 1 1 1 1 0 1 1 1 0 1 0 1 0 0 1 1 1 1 0 0 1 0 0 0 1 0 0 1 0 0 0 0 |
| 32 | 4202022020 | 1 1 1 1 1 0 1 0 0 1 1 1 0 1 0 1 1 1 0 0 0 1 0 0 1 0 0 0 0 1 0 0 |
| 32 | 4202107940 | 1 1 1 1 1 0 1 0 0 1 1 1 0 1 1 1 0 0 0 1 0 1 0 0 0 0 1 0 0 1 0 0 |
| 32 | 2615272744 | 1 0 0 1 1 0 1 1 1 1 1 0 0 0 0 1 1 1 1 0 0 1 0 1 0 0 1 0 1 0 0 0 |
| 32 | 2949804232 | 1 0 1 0 1 1 1 1 1 1 0 1 0 0 1 0 0 1 1 1 0 0 0 0 1 1 0 0 1 0 0 0 |
| 32 | 3664692280 | 1 1 0 1 1 0 1 0 0 1 1 0 1 1 1 0 1 1 0 0 0 1 0 0 0 0 1 1 1 0 0 0 |
| 32 | 3750073442 | 1 1 0 1 1 1 1 1 1 0 0 0 0 1 0 1 1 0 0 1 0 1 0 0 0 1 1 0 0 0 1 0 |
| 32 | 3815357200 | 1 1 1 0 0 0 1 1 0 1 1 0 1 0 0 1 1 0 1 1 1 0 1 1 0 0 0 1 0 0 0 0 |
| 32 | 3967639826 | 1 1 1 0 1 1 0 0 0 1 1 1 1 1 0 1 0 1 1 0 0 0 0 1 0 0 0 1 0 0 1 0 |
| 32 | 4016640368 | 1 1 1 0 1 1 1 1 0 1 1 0 1 0 0 1 0 0 0 1 0 0 0 1 0 1 1 1 0 0 0 0 |
| 32 | 4241894434 | 1 1 1 1 1 1 0 0 1 1 0 1 0 1 1 0 0 0 1 0 1 1 0 0 0 0 1 0 0 0 1 0 |
| 32 | 4249276568 | 1 1 1 1 1 1 0 1 0 1 0 0 0 1 1 0 1 1 0 1 0 0 0 0 1 0 0 1 1 0 0 0 |
| 32 | 4255323344 | 1 1 1 1 1 1 0 1 1 0 1 0 0 0 1 1 0 0 0 1 0 1 0 0 1 1 0 1 0 0 0 0 |
| 32 | 3721081040 | 1 1 0 1 1 1 0 1 1 1 0 0 1 0 1 1 0 0 1 1 0 0 0 0 1 1 0 1 0 0 0 0 |
| 32 | 4216537988 | 1 1 1 1 1 0 1 1 0 1 0 1 0 0 1 1 0 1 0 0 0 0 1 1 1 0 0 0 0 1 0 0 |
| 32 | 4239090052 | 1 1 1 1 1 1 0 0 1 0 1 0 1 0 1 1 0 1 1 0 0 0 0 1 1 0 0 0 0 1 0 0 |
| 32 | 2677369904 | 1 0 0 1 1 1 1 1 1 0 0 1 0 1 0 1 0 1 1 0 1 1 0 0 0 0 1 1 0 0 0 0 |
| 32 | 3083457584 | 1 0 1 1 0 1 1 1 1 1 0 0 1 0 0 1 1 1 0 1 0 1 0 0 0 0 1 1 0 0 0 0 |
| 32 | 3720094384 | 1 1 0 1 1 1 0 1 1 0 1 1 1 1 0 0 0 0 1 0 0 0 1 0 1 0 1 1 0 0 0 0 |
| 32 | 4142675216 | 1 1 1 1 0 1 1 0 1 1 1 0 1 1 0 0 0 0 1 1 0 1 0 1 0 0 0 1 0 0 0 0 |
| 32* | 3470081042 | 1 1 0 0 1 1 1 0 1 1 0 1 0 1 0 1 0 0 1 1 1 1 0 0 0 0 0 1 0 0 1 0 |
| 32 | 3616262752 | 1 1 0 1 0 1 1 1 1 0 0 0 1 0 1 1 1 1 0 0 1 0 1 0 0 1 1 0 0 0 0 0 |
| 32 | 3650909600 | 1 1 0 1 1 0 0 1 1 0 0 1 1 1 0 0 0 1 1 1 0 1 0 1 1 0 1 0 0 0 0 0 |
| 32* | 3715500632 | 1 1 0 1 1 1 0 1 0 1 1 1 0 1 1 0 0 0 0 0 1 0 1 0 0 1 0 1 1 0 0 0 |
| 32* | 3715511456 | 1 1 0 1 1 1 0 1 0 1 1 1 0 1 1 0 0 0 1 1 0 1 0 0 1 0 1 0 0 0 0 0 |
| 32 | 3747668564 | 1 1 0 1 1 1 1 1 0 1 1 0 0 0 0 0 1 1 1 0 0 0 1 0 0 1 0 1 0 1 0 0 |
| 32 | 3747956960 | 1 1 0 1 1 1 1 1 0 1 1 0 0 1 0 1 0 1 0 0 1 0 0 0 1 1 1 0 0 0 0 0 |
| 32 | 3952526944 | 1 1 1 0 1 0 1 1 1 0 0 1 0 1 1 0 1 1 0 0 0 1 1 0 0 1 1 0 0 0 0 0 |
| 32 | 4019850568 | 1 1 1 0 1 1 1 1 1 0 0 1 1 0 1 0 0 0 0 0 1 1 0 1 0 1 0 0 1 0 0 0 |
| 32 | 4090784786 | 1 1 1 1 0 0 1 1 1 1 0 1 0 1 0 0 0 1 1 0 1 1 0 0 0 0 0 1 0 0 1 0 |
| 32 | 4150828052 | 1 1 1 1 0 1 1 1 0 1 1 0 1 0 0 0 1 0 0 1 1 1 0 0 0 0 0 1 0 1 0 0 |
| 32 | 4176304388 | 1 1 1 1 1 0 0 0 1 1 1 0 1 1 0 1 0 1 0 1 1 0 0 1 0 0 0 0 0 1 0 0 |
| 32 | 4217115848 | 1 1 1 1 1 0 1 1 0 1 0 1 1 1 0 0 0 0 0 1 0 1 0 0 1 1 0 0 1 0 0 0 |
| 32 | 4253864608 | 1 1 1 1 1 1 0 1 1 0 0 0 1 1 0 0 1 1 0 1 0 0 1 0 1 0 1 0 0 0 0 0 |
| 32 | 4255467104 | 1 1 1 1 1 1 0 1 1 0 1 0 0 1 0 1 0 1 0 0 0 1 1 0 0 1 1 0 0 0 0 0 |
| 32 | 2940018904 | 1 0 1 0 1 1 1 1 0 0 1 1 1 1 0 1 0 0 1 0 0 0 0 0 1 1 0 1 1 0 0 0 |
| 32 | 3018728800 | 1 0 1 1 0 0 1 1 1 1 1 0 1 1 1 0 0 0 1 0 0 1 0 1 0 1 1 0 0 0 0 0 |
| 32 | 3049730912 | 1 0 1 1 0 1 0 1 1 1 0 0 0 1 1 1 0 0 1 1 0 0 1 1 0 1 1 0 0 0 0 0 |
| 32 | 3150607384 | 1 0 1 1 1 0 1 1 1 1 0 0 1 0 1 0 0 1 1 1 0 1 0 0 0 0 0 1 1 0 0 0 |
| 32 | 3197971552 | 1 0 1 1 1 1 1 0 1 0 0 1 1 1 0 1 0 0 1 0 1 1 0 0 0 1 1 0 0 0 0 0 |
| 32 | 3688305056 | 1 1 0 1 1 0 1 1 1 1 0 1 0 1 1 1 0 0 0 1 0 0 0 1 1 0 1 0 0 0 0 0 |
| 32 | 3722668072 | 1 1 0 1 1 1 0 1 1 1 1 0 0 0 1 1 0 1 1 0 1 0 0 0 0 0 1 0 1 0 0 0 |
| 32 | 3738980768 | 1 1 0 1 1 1 1 0 1 1 0 1 1 1 0 0 0 1 0 1 0 0 0 1 1 0 1 0 0 0 0 0 |
| 32 | 3991672360 | 1 1 1 0 1 1 0 1 1 1 1 0 1 1 0 0 0 0 0 1 0 1 1 0 0 0 1 0 1 0 0 0 |
| 32 | 3714780932 | 1 1 0 1 1 1 0 1 0 1 1 0 1 0 1 1 0 0 0 0 1 1 1 1 0 0 0 0 0 1 0 0 |
| 32 | 4007713300 | 1 1 1 0 1 1 1 0 1 1 1 0 0 0 0 0 1 1 0 1 1 0 1 0 0 0 0 1 0 1 0 0 |
| 32 | 4007988064 | 1 1 1 0 1 1 1 0 1 1 1 0 0 1 0 1 0 0 0 0 1 0 1 1 0 1 1 0 0 0 0 0 |
| 32 | 4040604448 | 1 1 1 1 0 0 0 0 1 1 0 1 0 1 1 0 1 0 1 1 1 0 1 1 0 0 1 0 0 0 0 0 |
| 32 | 3117833732 | 1 0 1 1 1 0 0 1 1 1 0 1 0 1 1 0 0 1 0 1 1 1 1 0 0 0 0 0 0 1 0 0 |
| 32 | 3732482752 | 1 1 0 1 1 1 1 0 0 1 1 1 1 0 0 1 0 0 1 0 1 0 1 0 1 1 0 0 0 0 0 0 |
| 32 | 3874790720 | 1 1 1 0 0 1 1 0 1 1 1 1 0 1 0 0 1 0 0 1 1 1 0 1 0 1 0 0 0 0 0 0 |
| 32 | 3924722068 | 1 1 1 0 1 0 0 1 1 1 1 0 1 1 1 0 1 0 0 0 0 0 0 1 1 0 0 1 0 1 0 0 |
| 32 | 4091026084 | 1 1 1 1 0 0 1 1 1 1 0 1 1 0 0 0 0 0 0 1 1 0 1 0 1 0 1 0 0 1 0 0 |
| 32 | 4107745856 | 1 1 1 1 0 1 0 0 1 1 0 1 0 1 1 1 0 0 1 1 1 0 1 0 0 1 0 0 0 0 0 0 |
| 32 | 4187839040 | 1 1 1 1 1 0 0 1 1 0 0 1 1 1 0 1 0 1 0 1 1 0 1 0 0 1 0 0 0 0 0 0 |
| 32 | 4206153280 | 1 1 1 1 1 0 1 0 1 0 1 1 0 1 0 0 1 1 0 0 1 1 1 0 0 1 0 0 0 0 0 0 |
| 32 | 3057442112 | 1 0 1 1 0 1 1 0 0 0 1 1 1 1 0 0 1 1 0 1 1 1 0 1 0 1 0 0 0 0 0 0 |
| 32 | 3983779456 | 1 1 1 0 1 1 0 1 0 1 1 1 0 0 1 1 1 0 1 0 0 1 1 0 1 0 0 0 0 0 0 0 |

Table XVII illustrates repetition based, SYNC base sequences for length 6. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XVII may show examples of the base sequence. In some examples, the candidate SYNC base sequences in Table XVII satisfy the criteria of: 1) all sidelobes before the first main peak are <=0, 2) all sidelobes adjacent main peaks are <=1, and 3) the last sidelobe before the first main peak is −1, so that the width of the main lobe is minimized. The sequences shown in Table XVII may be used for uplink communications or downlink communications. In some cases, the sequences shown in Table XVII may also be used for device-to-device communications or point-to-point communication between various wireless nodes without using an access point.

TABLE XVII

| Length | Decimal Value | Binary Sequence |
|---|---|---|
| 6 | 44 | 1 0 1 1 0 0 |
| 6 | 50 | 1 1 0 0 1 0 |
| 6 | 52 | 1 1 0 1 0 0 |

Table XVIII illustrates repetition based, SYNC base sequences for length 10. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XVIII may show examples of the base sequence. In some examples, the candidate SYNC base sequences in Table XVIII satisfy the criteria of: 1) all sidelobes before the first main peak are <=0, 2) all sidelobes adjacent main peaks are <=1, and 3) the last sidelobe before the first main peak is −1, so that the width of the main lobe is minimized. The candidate sequence marked as 10*satisfy the criteria of: 1) all sidelobes before the first main peak are <=0, 2) all sidelobes adjacent main peaks are <=1, 3) the last sidelobe before the first main peak is −1, so that the width of the main lobe is minimized, and 4) up to 1 sidelobe before the main peak reaches a value of 0. All sidelobes before that are <=−1. The sequences shown in Table XVIII may be used for uplink communications or downlink communications. In some cases, the sequences shown in Table XVIII may also be used for device-to-device communications or point-to-point communication between various wireless nodes without using an access point.

TABLE XVIII

| Length | Decimal Value | Binary Sequence |
|---|---|---|
| 10 | 740 | 1 0 1 1 1 0 0 1 0 0 |
| 10 | 820 | 1 1 0 0 1 1 0 1 0 0 |
| 10 | 866 | 1 1 0 1 1 0 0 0 1 0 |
| 10 | 914 | 1 1 1 0 0 1 0 0 1 0 |
| 10 | 930 | 1 1 1 0 1 0 0 0 1 0 |
| 10* | 932 | 1 1 1 0 1 0 0 1 0 0 |

Table XIX illustrates repetition based, SYNC base sequences for length 12. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XIX may show examples of the base sequence. In some examples, the candidate SYNC base sequences in Table XIX satisfy the criteria of: 1) all sidelobes before the first main peak are <=0 and 2) all sidelobes between adjacent main peaks are <=0. The candidate sequence marked as 12*satisfy the criteria of: 1) all sidelobes before the first main peak are <=0 and 2) all sidelobes between adjacent main peaks are <=0, and 3) the last sidelobe before the first main peak is −2, so that the width of the main lobe is minimized. The candidate sequence marked as 12~ satisfy the criteria of: 1) all sidelobes before the first main peak are <=0 and 2) all sidelobes between adjacent main peaks are <=0, 3) the last sidelobe before the first main peak is −2, so that the width of the main lobe is minimized, and 4) up to 1 sidelobe before the main peak reaches a value of 0. All sidelobes before that are <=−1. The sequences shown in Table XIX may be used for uplink communications or downlink communications. In some cases, the sequences shown in Table XIX may also be used for device-to-device communications or point-to-point communication between various wireless nodes without using an access point.

TABLE XIX

| Length | Decimal Value | Binary Sequence |
|---|---|---|
| 12 | 2424 | 1 0 0 1 0 1 1 1 1 0 0 0 |
| 12 | 2536 | 1 0 0 1 1 1 1 0 1 0 0 0 |
| 12* | 2776 | 1 0 1 0 1 1 0 1 1 0 0 0 |
| 12 | 2928 | 1 0 1 1 0 1 1 1 0 0 0 0 |
| 12 | 2992 | 1 0 1 1 1 0 1 1 0 0 0 0 |
| 12 | 3012 | 1 0 1 1 1 1 0 0 0 1 0 0 |
| 12 | 3016 | 1 0 1 1 1 1 0 0 1 0 0 0 |
| 12* | 3466 | 1 1 0 1 1 0 0 0 1 0 1 0 |
| 12* | 3496 | 1 1 0 1 1 0 1 0 1 0 0 0 |
| 12 | 3522 | 1 1 0 1 1 1 0 0 0 0 1 0 |
| 12 | 3536 | 1 1 0 1 1 1 0 1 0 0 0 0 |
| 12~ | 3748 | 1 1 1 0 1 0 1 0 0 1 0 0 |
| 12 | 3778 | 1 1 1 0 1 1 0 0 0 0 1 0 |
| 12 | 3792 | 1 1 1 0 1 1 0 1 0 0 0 0 |
| 12 | 3858 | 1 1 1 1 0 0 0 1 0 0 1 0 |
| 12 | 3874 | 1 1 1 1 0 0 1 0 0 0 1 0 |
| 12 | 3908 | 1 1 1 1 0 1 0 0 0 1 0 0 |
| 12 | 3912 | 1 1 1 1 0 1 0 0 1 0 0 0 |

Table XX illustrates a non-repetition based, SYNC base sequences for length 24. In some examples, the candidate SYNC base sequences may be based on the SYNC base sequence search criteria of: 1) equal numbers of 1s and 0s, 2) the length L is an even number, 3) the chip sequence does not contain ‘0000’ (if used for 2 μs chip duration) or ‘00000000’ (if used for 1 us but not 2 μs chip duration) so as not to have—an 8 μs gap (OFF symbols), 4) starts with ‘1’ (ON symbol), because there is no prior preamble, 5) good correlation property (e.g., multiple objectives of 1) minimize the largest sidelobe(s) before the main peak (to minimize the change that sidelobes triggers 1^{st} timing), 2) minimize the largest value before the main peak (i.e., min |S₁ₐ|), 3) for a given largest value before the main peak (i.e., |S₁ₐ|), minimize the number of sidelobes that reach the largest value before the main peak (|S₁ₐ|), 4) minimize the width of the main lobe (to minimize the searching period of time in the method of estimated main peak), and 5) maximize the magnitude of the last negative sidelobe before the main peak (such as in the chip level correlation, to reduce or minimize the value of the last correlator output before the main peak)). All candidate sequences shown in Table XX satisfy the criteria of: 1) all sidelobes before the main peak are <=0, and 2) more than 1 sidelobe before the main peak reaches a value of 0. The sequences shown in Table XX may be used for uplink communications or downlink communications. In some cases, the sequences shown in Table XX may also be used for device-to-device communications or point-to-point communication between various wireless nodes without using an access point. In some cases, the sequences shown in Table XX may be used for uplink active transmission or for uplink backscattering transmission.

TABLE XX

| Length | Decimal Value | Binary Sequence |
|---|---|---|
| 24 | 9918680 | 1 0 0 1 0 1 1 1 0 1 0 1 1 0 0 0 1 1 0 1 1 0 0 0 |
| 24 | 10427080 | 1 0 0 1 1 1 1 1 0 0 0 1 1 0 1 0 1 1 0 0 1 0 0 0 |
| 24 | 10983856 | 1 0 1 0 0 1 1 1 1 0 0 1 1 0 0 1 1 0 1 1 0 0 0 0 |
| 24 | 10996108 | 1 0 1 0 0 1 1 1 1 1 0 0 1 0 0 1 1 0 0 0 1 1 0 0 |
| 24 | 11304336 | 1 0 1 0 1 1 0 0 0 1 1 1 1 1 0 1 1 0 0 1 0 0 0 0 |
| 24 | 11304520 | 1 0 1 0 1 1 0 0 0 1 1 1 1 1 1 0 0 1 0 0 1 0 0 0 |
| 24 | 11377120 | 1 0 1 0 1 1 0 1 1 0 0 1 1 0 0 1 1 1 1 0 0 0 0 0 |
| 24 | 11382904 | 1 0 1 0 1 1 0 1 1 0 1 1 0 0 0 0 0 1 1 1 1 0 0 0 |
| 24 | 11479148 | 1 0 1 0 1 1 1 1 0 0 1 0 1 0 0 0 0 1 1 0 1 1 0 0 |
| 24 | 11481304 | 1 0 1 0 1 1 1 1 0 0 1 1 0 0 0 0 1 1 0 1 1 0 0 0 |
| 24 | 11713840 | 1 0 1 1 0 0 1 0 1 0 1 1 1 1 0 1 0 0 1 1 0 0 0 0 |
| 24 | 11853080 | 1 0 1 1 0 1 0 0 1 1 0 1 1 1 0 1 0 0 0 1 1 0 0 0 |
| 24 | 12090184 | 1 0 1 1 1 0 0 0 0 1 1 1 1 0 1 1 0 1 0 0 1 0 0 0 |
| 24 | 12243172 | 1 0 1 1 1 0 1 0 1 1 0 1 0 0 0 0 1 1 1 0 0 1 0 0 |
| 24 | 12261736 | 1 0 1 1 1 0 1 1 0 0 0 1 1 0 0 1 0 1 1 0 1 0 0 0 |
| 24 | 12835978 | 1 1 0 0 0 0 1 1 1 1 0 1 1 1 0 0 1 0 0 0 1 0 1 0 |
| 24 | 13171536 | 1 1 0 0 1 0 0 0 1 1 1 1 1 0 1 1 0 1 0 1 0 0 0 0 |
| 24 | 13205032 | 1 1 0 0 1 0 0 1 0 1 1 1 1 1 1 0 0 0 1 0 1 0 0 0 |
| 24 | 13417168 | 1 1 0 0 1 1 0 0 1 0 1 1 1 0 1 0 1 1 0 1 0 0 0 0 |
| 24 | 13477232 | 1 1 0 0 1 1 0 1 1 0 1 0 0 1 0 1 0 1 1 1 0 0 0 0 |
| 24 | 13794856 | 1 1 0 1 0 0 1 0 0 1 1 1 1 1 1 0 0 0 1 0 1 0 0 0 |
| 24 | 13925960 | 1 1 0 1 0 1 0 0 0 1 1 1 1 1 1 0 0 1 0 0 1 0 0 0 |
| 24 | 13997000 | 1 1 0 1 0 1 0 1 1 0 0 1 0 0 1 1 1 1 0 0 1 0 0 0 |
| 24 | 14187204 | 1 1 0 1 1 0 0 0 0 1 1 1 1 0 1 0 1 1 0 0 0 1 0 0 |
| 24 | 14244576 | 1 1 0 1 1 0 0 1 0 1 0 1 1 0 1 0 1 1 1 0 0 0 0 0 |
| 24 | 14245424 | 1 1 0 1 1 0 0 1 0 1 0 1 1 1 1 0 0 0 1 1 0 0 0 0 |
| 24 | 14363416 | 1 1 0 1 1 0 1 1 0 0 1 0 1 0 1 1 0 0 0 1 1 0 0 0 |
| 24 | 14364856 | 1 1 0 1 1 0 1 1 0 0 1 1 0 0 0 0 1 0 1 1 1 0 0 0 |
| 24 | 14373048 | 1 1 0 1 1 0 1 1 0 1 0 1 0 0 0 0 1 0 1 1 1 0 0 0 |
| 24 | 14490788 | 1 1 0 1 1 1 0 1 0 0 0 1 1 1 0 0 1 0 1 0 0 1 0 0 |
| 24 | 14777122 | 1 1 1 0 0 0 0 1 0 1 1 1 1 0 1 1 0 0 1 0 0 0 1 0 |
| 24 | 14802248 | 1 1 1 0 0 0 0 1 1 1 0 1 1 1 0 1 0 1 0 0 1 0 0 0 |
| 24 | 14806306 | 1 1 1 0 0 0 0 1 1 1 1 0 1 1 0 1 0 0 1 0 0 0 1 0 |
| 24 | 14900002 | 1 1 1 0 0 0 1 1 0 1 0 1 1 0 1 1 0 0 1 0 0 0 1 0 |
| 24 | 15148496 | 1 1 1 0 0 1 1 1 0 0 1 0 0 1 0 1 1 1 0 1 0 0 0 0 |
| 24 | 15261264 | 1 1 1 0 1 0 0 0 1 1 0 1 1 1 1 0 0 1 0 1 0 0 0 0 |
| 24 | 15781034 | 1 1 1 1 0 0 0 0 1 1 0 0 1 1 0 0 1 0 1 0 1 0 1 0 |
| 24 | 15833508 | 1 1 1 1 0 0 0 1 1 0 0 1 1 0 0 1 1 0 1 0 0 1 0 0 |
| 24 | 15833674 | 1 1 1 1 0 0 0 1 1 0 0 1 1 0 1 0 0 1 0 0 1 0 1 0 |
| 24 | 15833764 | 1 1 1 1 0 0 0 1 1 0 0 1 1 0 1 0 1 0 1 0 0 1 0 0 |
| 24 | 15837896 | 1 1 1 1 0 0 0 1 1 0 1 0 1 0 1 0 1 1 0 0 1 0 0 0 |
| 24 | 15897932 | 1 1 1 1 0 0 1 0 1 0 0 1 0 1 0 1 0 1 0 0 1 1 0 0 |
| 24 | 15903116 | 1 1 1 1 0 0 1 0 1 0 1 0 1 0 0 1 1 0 0 0 1 1 0 0 |
| 24 | 15905548 | 1 1 1 1 0 0 1 0 1 0 1 1 0 0 1 1 0 0 0 0 1 1 0 0 |
| 24 | 15928532 | 1 1 1 1 0 0 1 1 0 0 0 0 1 1 0 0 1 1 0 1 0 1 0 0 |
| 24 | 15931690 | 1 1 1 1 0 0 1 1 0 0 0 1 1 0 0 1 0 0 1 0 1 0 1 0 |
| 24 | 15932042 | 1 1 1 1 0 0 1 1 0 0 0 1 1 0 1 0 1 0 0 0 1 0 1 0 |
| 24 | 15935912 | 1 1 1 1 0 0 1 1 0 0 1 0 1 0 0 1 1 0 1 0 1 0 0 0 |
| 24 | 15950122 | 1 1 1 1 0 0 1 1 0 1 1 0 0 0 0 1 0 0 1 0 1 0 1 0 |
| 24 | 15950164 | 1 1 1 1 0 0 1 1 0 1 1 0 0 0 0 1 0 1 0 1 0 1 0 0 |
| 24 | 15962792 | 1 1 1 1 0 0 1 1 1 0 0 1 0 0 1 0 1 0 1 0 1 0 0 0 |
| 24 | 16030090 | 1 1 1 1 0 1 0 0 1 0 0 1 1 0 0 1 1 0 0 0 1 0 1 0 |
| 24 | 16030092 | 1 1 1 1 0 1 0 0 1 0 0 1 1 0 0 1 1 0 0 0 1 1 0 0 |
| 24 | 16063640 | 1 1 1 1 0 1 0 1 0 0 0 1 1 1 0 0 1 0 0 1 1 0 0 0 |
| 24 | 16069010 | 1 1 1 1 0 1 0 1 0 0 1 1 0 0 0 1 1 0 0 1 0 0 1 0 |
| 24 | 16075148 | 1 1 1 1 0 1 0 1 0 1 0 0 1 0 0 1 1 0 0 0 1 1 0 0 |
| 24 | 16097484 | 1 1 1 1 0 1 0 1 1 0 1 0 0 0 0 0 1 1 0 0 1 1 0 0 |
| 24 | 16131722 | 1 1 1 1 0 1 1 0 0 0 1 0 0 1 1 0 1 0 0 0 1 0 1 0 |
| 24 | 16292170 | 1 1 1 1 1 0 0 0 1 0 0 1 1 0 0 1 0 1 0 0 1 0 1 0 |
| 24 | 16329356 | 1 1 1 1 1 0 0 1 0 0 1 0 1 0 1 0 1 0 0 0 1 1 0 0 |
| 24 | 16331146 | 1 1 1 1 1 0 0 1 0 0 1 1 0 0 0 1 1 0 0 0 1 0 1 0 |
| 24 | 16331156 | 1 1 1 1 1 0 0 1 0 0 1 1 0 0 0 1 1 0 0 1 0 1 0 0 |
| 24 | 16393612 | 1 1 1 1 1 0 1 0 0 0 1 0 0 1 0 1 1 0 0 0 1 1 0 0 |
| 24 | 16395032 | 1 1 1 1 1 0 1 0 0 0 1 0 1 0 1 1 0 0 0 1 1 0 0 0 |
| 24 | 16540810 | 1 1 1 1 1 1 0 0 0 1 1 0 0 1 0 0 1 0 0 0 1 0 1 0 |

Table XXI illustrates a repetition based SYNC base sequences for length 24. In some cases, a structure of [S S] for a SYNC sequence is used, where S represents the base sequence and [S S] represents the structure for the resulting SYNC sequence. Since a SYNC sequence having more than two times repetition, such as [S S S] that has three times repetition, has periodicity, its correlation output also has periodicity. Therefore, the base sequence found in the search using the [S S] structure could also be used for SYNC sequences with more than two times repetition, such as [S S S] with three times repetition, [S S S S] with four times repetition, and so on. Table XXI may show examples of the base sequence. In some examples, the candidate SYNC base sequences may be based on the SYNC base sequence search criteria of: 1) equal numbers of 1s and 0s, 2) the length L is an even number, 3) the chip sequence does not contain ‘0000’ (if used for 2 μs chip duration) or ‘00000000’ (if used for 1 us but not 2 us chip duration) so as not to have an 8 μs gap (OFF symbols), 4) starts with ‘1’ (ON symbol), because there is no prior preamble, 5) good correlation property (e.g., multiple objectives of 1) minimize the largest sidelobe(s) before the main peak (to minimize the change that sidelobes triggers 1^{st} timing), 2) minimize the largest value before the main peak (i.e., min |S₁ₐ|), 3) for a given largest value before the main peak (i.e., |S₁ₐ|), minimize the number of sidelobes that reach the largest value before the main peak (|S₁ₐ|), 4) minimize the width of the main lobe (to minimize the searching period of time in the method of estimated main peak), and 5) maximize the magnitude of the last negative sidelobe before the main peak (such as in the chip level correlation, to reduce or minimize the value of the last correlator output before the main peak)), and 6) minimize the largest sidelobe(s) between adjacent main peaks with objects that 1) minimize the largest value between adjacent main peaks and 2) minimize the number of sidelobes that reach the largest value between adjacent main peak (e.g., the circular correlation property has very low or no sidelobes). All of the candidate sequences satisfy the criteria of: 1) all sidelobes before the first main peak are <=0, and 2) all sidelobes between adjacent main peaks are <=0. The sequences shown in Table XXI may be used for uplink communications or downlink communications. In some cases, the sequences shown in Table XXI may also be used for device-to-device communications or point-to-point communication between various wireless nodes without using an access point. In some cases, the sequences shown in Table XXI may be used for uplink active transmission or for uplink backscattering transmission.

TABLE XXI

| Length | Decimal Value | Binary Sequence |
|---|---|---|
| 24 | 10216272 | 1 0 0 1 1 0 1 1 1 1 1 0 0 0 1 1 0 1 0 1 0 0 0 0 |
| 24 | 10414168 | 1 0 0 1 1 1 1 0 1 1 1 0 1 0 0 0 0 1 0 1 1 0 0 0 |
| 24 | 10414288 | 1 0 0 1 1 1 1 0 1 1 1 0 1 0 0 0 1 1 0 1 0 0 0 0 |
| 24 | 10433840 | 1 0 0 1 1 1 1 1 0 0 1 1 0 1 0 1 0 0 1 1 0 0 0 0 |
| 24 | 10439320 | 1 0 0 1 1 1 1 1 0 1 0 0 1 0 1 0 1 0 0 1 1 0 0 0 |
| 24 | 11134816 | 1 0 1 0 1 0 0 1 1 1 1 0 0 1 1 1 0 1 1 0 0 0 0 0 |
| 24 | 11303776 | 1 0 1 0 1 1 0 0 0 1 1 1 1 0 1 1 0 1 1 0 0 0 0 0 |
| 24 | 11304336 | 1 0 1 0 1 1 0 0 0 1 1 1 1 1 0 1 1 0 0 1 0 0 0 0 |
| 24 | 11335180 | 1 0 1 0 1 1 0 0 1 1 1 1 0 1 1 0 0 0 0 0 1 1 0 0 |
| 24 | 11399472 | 1 0 1 0 1 1 0 1 1 1 1 1 0 0 0 1 0 0 1 1 0 0 0 0 |
| 24 | 11494240 | 1 0 1 0 1 1 1 1 0 1 1 0 0 0 1 1 0 1 1 0 0 0 0 0 |
| 24 | 11506576 | 1 0 1 0 1 1 1 1 1 0 0 1 0 0 1 1 1 0 0 1 0 0 0 0 |
| 24 | 11630480 | 1 0 1 1 0 0 0 1 0 1 1 1 0 1 1 1 1 0 0 1 0 0 0 0 |
| 24 | 11777472 | 1 0 1 1 0 0 1 1 1 0 1 1 0 1 0 1 1 1 0 0 0 0 0 0 |
| 24 | 11914688 | 1 0 1 1 0 1 0 1 1 1 0 0 1 1 0 1 1 1 0 0 0 0 0 0 |
| 24 | 11916080 | 1 0 1 1 0 1 0 1 1 1 0 1 0 0 1 1 0 0 1 1 0 0 0 0 |
| 24 | 11918348 | 1 0 1 1 0 1 0 1 1 1 0 1 1 1 0 0 0 0 0 0 1 1 0 0 |
| 24 | 11955760 | 1 0 1 1 0 1 1 0 0 1 1 0 1 1 1 0 0 0 1 1 0 0 0 0 |
| 24 | 12027716 | 1 0 1 1 0 1 1 1 1 0 0 0 0 1 1 1 0 1 0 0 0 1 0 0 |
| 24 | 12090184 | 1 0 1 1 1 0 0 0 0 1 1 1 1 0 1 1 0 1 0 0 1 0 0 0 |
| 24 | 12179136 | 1 0 1 1 1 0 0 1 1 1 0 1 0 1 1 0 1 1 0 0 0 0 0 0 |
| 24 | 12269920 | 1 0 1 1 1 0 1 1 0 0 1 1 1 0 0 1 0 1 1 0 0 0 0 0 |
| 24 | 12305584 | 1 0 1 1 1 0 1 1 1 1 0 0 0 1 0 0 1 0 1 1 0 0 0 0 |
| 24 | 12306640 | 1 0 1 1 1 0 1 1 1 1 0 0 1 0 0 0 1 1 0 1 0 0 0 0 |
| 24 | 12368656 | 1 0 1 1 1 1 0 0 1 0 1 1 1 0 1 1 0 0 0 1 0 0 0 0 |
| 24 | 12400400 | 1 0 1 1 1 1 0 1 0 0 1 1 0 1 1 1 0 0 0 1 0 0 0 0 |
| 24 | 12423736 | 1 0 1 1 1 1 0 1 1 0 0 1 0 0 1 0 0 0 1 1 1 0 0 0 |
| 24 | 12436688 | 1 0 1 1 1 1 0 1 1 1 0 0 0 1 0 0 1 1 0 1 0 0 0 0 |
| 24 | 12437680 | 1 0 1 1 1 1 0 1 1 1 0 0 1 0 0 0 1 0 1 1 0 0 0 0 |
| 24 | 12472524 | 1 0 1 1 1 1 1 0 0 1 0 1 0 0 0 0 1 1 0 0 1 1 0 0 |
| 24 | 12474568 | 1 0 1 1 1 1 1 0 0 1 0 1 1 0 0 0 1 1 0 0 1 0 0 0 |
| 24 | 12522636 | 1 0 1 1 1 1 1 1 0 0 0 1 0 1 0 0 1 0 0 0 1 1 0 0 |
| 24 | 12526872 | 1 0 1 1 1 1 1 1 0 0 1 0 0 1 0 1 0 0 0 1 1 0 0 0 |
| 24 | 13097226 | 1 1 0 0 0 1 1 1 1 1 0 1 1 0 0 1 0 0 0 0 1 0 1 0 |
| 24 | 13171536 | 1 1 0 0 1 0 0 0 1 1 1 1 1 0 1 1 0 1 0 1 0 0 0 0 |
| 24 | 13327808 | 1 1 0 0 1 0 1 1 0 1 0 1 1 1 0 1 1 1 0 0 0 0 0 0 |
| 24 | 13417168 | 1 1 0 0 1 1 0 0 1 0 1 1 1 0 1 0 1 1 0 1 0 0 0 0 |
| 24 | 13418064 | 1 1 0 0 1 1 0 0 1 0 1 1 1 1 1 0 0 1 0 1 0 0 0 0 |
| 24 | 13458368 | 1 1 0 0 1 1 0 1 0 1 0 1 1 0 1 1 1 1 0 0 0 0 0 0 |
| 24 | 13458962 | 1 1 0 0 1 1 0 1 0 1 0 1 1 1 1 0 0 0 0 1 0 0 1 0 |
| 24 | 13588160 | 1 1 0 0 1 1 1 1 0 1 0 1 0 1 1 0 1 1 0 0 0 0 0 0 |
| 24 | 13604240 | 1 1 0 0 1 1 1 1 1 0 0 1 0 1 0 1 1 0 0 1 0 0 0 0 |
| 24 | 13615700 | 1 1 0 0 1 1 1 1 1 1 0 0 0 0 1 0 0 1 0 1 0 1 0 0 |
| 24 | 13617488 | 1 1 0 0 1 1 1 1 1 1 0 0 1 0 0 1 0 1 0 1 0 0 0 0 |
| 24 | 13794856 | 1 1 0 1 0 0 1 0 0 1 1 1 1 1 1 0 0 0 1 0 1 0 0 0 |
| 24 | 13823584 | 1 1 0 1 0 0 1 0 1 1 1 0 1 1 1 0 0 1 1 0 0 0 0 0 |
| 24 | 13867936 | 1 1 0 1 0 0 1 1 1 0 0 1 1 0 1 1 1 0 1 0 0 0 0 0 |
| 24 | 13875904 | 1 1 0 1 0 0 1 1 1 0 1 1 1 0 1 0 1 1 0 0 0 0 0 0 |
| 24 | 13925960 | 1 1 0 1 0 1 0 0 0 1 1 1 1 1 1 0 0 1 0 0 1 0 0 0 |
| 24 | 13950560 | 1 1 0 1 0 1 0 0 1 1 0 1 1 1 1 0 0 1 1 0 0 0 0 0 |
| 24 | 13999040 | 1 1 0 1 0 1 0 1 1 0 0 1 1 0 1 1 1 1 0 0 0 0 0 0 |
| 24 | 14021168 | 1 1 0 1 0 1 0 1 1 1 1 1 0 0 1 0 0 0 1 1 0 0 0 0 |
| 24 | 14119616 | 1 1 0 1 0 1 1 1 0 1 1 1 0 0 1 0 1 1 0 0 0 0 0 0 |
| 24 | 14129568 | 1 1 0 1 0 1 1 1 1 0 0 1 1 0 0 1 1 0 1 0 0 0 0 0 |
| 24 | 14212648 | 1 1 0 1 1 0 0 0 1 1 0 1 1 1 1 0 0 0 1 0 1 0 0 0 |
| 24 | 14212768 | 1 1 0 1 1 0 0 0 1 1 0 1 1 1 1 0 1 0 1 0 0 0 0 0 |
| 24 | 14281768 | 1 1 0 1 1 0 0 1 1 1 1 0 1 1 0 0 0 0 1 0 1 0 0 0 |
| 24 | 14282890 | 1 1 0 1 1 0 0 1 1 1 1 1 0 0 0 0 1 0 0 0 1 0 1 0 |
| 24 | 14310952 | 1 1 0 1 1 0 1 0 0 1 0 1 1 1 1 0 0 0 1 0 1 0 0 0 |
| 24 | 14316992 | 1 1 0 1 1 0 1 0 0 1 1 1 0 1 0 1 1 1 0 0 0 0 0 0 |
| 24 | 14334400 | 1 1 0 1 1 0 1 0 1 0 1 1 1 0 0 1 1 1 0 0 0 0 0 0 |
| 24 | 14335168 | 1 1 0 1 1 0 1 0 1 0 1 1 1 1 0 0 1 1 0 0 0 0 0 0 |
| 24 | 14346048 | 1 1 0 1 1 0 1 0 1 1 1 0 0 1 1 1 0 1 0 0 0 0 0 0 |
| 24 | 14347288 | 1 1 0 1 1 0 1 0 1 1 1 0 1 1 0 0 0 0 0 1 1 0 0 0 |
| 24 | 14367056 | 1 1 0 1 1 0 1 1 0 0 1 1 1 0 0 1 0 1 0 1 0 0 0 0 |
| 24 | 14390720 | 1 1 0 1 1 0 1 1 1 0 0 1 0 1 0 1 1 1 0 0 0 0 0 0 |
| 24 | 14402224 | 1 1 0 1 1 0 1 1 1 1 0 0 0 0 1 0 1 0 1 1 0 0 0 0 |
| 24 | 14403232 | 1 1 0 1 1 0 1 1 1 1 0 0 0 1 1 0 1 0 1 0 0 0 0 0 |
| 24 | 14472608 | 1 1 0 1 1 1 0 0 1 1 0 1 0 1 0 1 1 0 1 0 0 0 0 0 |
| 24 | 14480032 | 1 1 0 1 1 1 0 0 1 1 1 1 0 0 1 0 1 0 1 0 0 0 0 0 |
| 24 | 14491154 | 1 1 0 1 1 1 0 1 0 0 0 1 1 1 1 0 0 0 0 1 0 0 1 0 |
| 24 | 14499080 | 1 1 0 1 1 1 0 1 0 0 1 1 1 1 0 1 0 0 0 0 1 0 0 0 |
| 24 | 14508488 | 1 1 0 1 1 1 0 1 0 1 1 0 0 0 0 1 1 1 0 0 1 0 0 0 |
| 24 | 14511200 | 1 1 0 1 1 1 0 1 0 1 1 0 1 1 0 0 0 1 1 0 0 0 0 0 |
| 24 | 14533448 | 1 1 0 1 1 1 0 1 1 1 0 0 0 0 1 1 0 1 0 0 1 0 0 0 |
| 24 | 14556434 | 1 1 0 1 1 1 1 0 0 0 0 1 1 1 0 1 0 0 0 1 0 0 1 0 |
| 24 | 14575824 | 1 1 0 1 1 1 1 0 0 1 1 0 1 0 0 0 1 1 0 1 0 0 0 0 |
| 24 | 14576224 | 1 1 0 1 1 1 1 0 0 1 1 0 1 0 1 0 0 1 1 0 0 0 0 0 |
| 24 | 14576720 | 1 1 0 1 1 1 1 0 0 1 1 0 1 1 0 0 0 1 0 1 0 0 0 0 |
| 24 | 14619402 | 1 1 0 1 1 1 1 1 0 0 0 1 0 0 1 1 0 0 0 0 1 0 1 0 |
| 24 | 14620968 | 1 1 0 1 1 1 1 1 0 0 0 1 1 0 0 1 0 0 1 0 1 0 0 0 |
| 24 | 14806306 | 1 1 1 0 0 0 0 1 1 1 1 0 1 1 0 1 0 0 1 0 0 0 1 0 |
| 24 | 14874184 | 1 1 1 0 0 0 1 0 1 1 1 1 0 1 1 0 0 1 0 0 1 0 0 0 |
| 24 | 15003280 | 1 1 1 0 0 1 0 0 1 1 1 0 1 1 1 0 1 0 0 1 0 0 0 0 |
| 24 | 15006340 | 1 1 1 0 0 1 0 0 1 1 1 1 1 0 1 0 1 0 0 0 0 1 0 0 |
| 24 | 15039264 | 1 1 1 0 0 1 0 1 0 1 1 1 1 0 1 1 0 0 1 0 0 0 0 0 |
| 24 | 15039560 | 1 1 1 0 0 1 0 1 0 1 1 1 1 1 0 0 0 1 0 0 1 0 0 0 |
| 24 | 15039632 | 1 1 1 0 0 1 0 1 0 1 1 1 1 1 0 0 1 0 0 1 0 0 0 0 |
| 24 | 15117760 | 1 1 1 0 0 1 1 0 1 0 1 0 1 1 0 1 1 1 0 0 0 0 0 0 |
| 24 | 15161024 | 1 1 1 0 0 1 1 1 0 1 0 1 0 1 1 0 1 1 0 0 0 0 0 0 |
| 24 | 15181000 | 1 1 1 0 0 1 1 1 1 0 1 0 0 1 0 0 1 1 0 0 1 0 0 0 |
| 24 | 15190180 | 1 1 1 0 0 1 1 1 1 1 0 0 1 0 0 0 1 0 1 0 0 1 0 0 |
| 24 | 15301700 | 1 1 1 0 1 0 0 1 0 1 1 1 1 1 0 0 0 1 0 0 0 1 0 0 |
| 24 | 15318088 | 1 1 1 0 1 0 0 1 1 0 1 1 1 1 0 0 0 1 0 0 1 0 0 0 |
| 24 | 15365824 | 1 1 1 0 1 0 1 0 0 1 1 1 0 1 1 0 1 1 0 0 0 0 0 0 |
| 24 | 15427360 | 1 1 1 0 1 0 1 1 0 1 1 0 0 1 1 1 0 0 1 0 0 0 0 0 |
| 24 | 15430464 | 1 1 1 0 1 0 1 1 0 1 1 1 0 0 1 1 0 1 0 0 0 0 0 0 |
| 24 | 15438544 | 1 1 1 0 1 0 1 1 1 0 0 1 0 0 1 0 1 1 0 1 0 0 0 0 |
| 24 | 15438736 | 1 1 1 0 1 0 1 1 1 0 0 1 0 0 1 1 1 0 0 1 0 0 0 0 |
| 24 | 15439552 | 1 1 1 0 1 0 1 1 1 0 0 1 0 1 1 0 1 1 0 0 0 0 0 0 |
| 24 | 15514888 | 1 1 1 0 1 1 0 0 1 0 1 1 1 1 0 1 0 0 0 0 1 0 0 0 |
| 24 | 15521440 | 1 1 1 0 1 1 0 0 1 1 0 1 0 1 1 0 1 0 1 0 0 0 0 0 |
| 24 | 15522328 | 1 1 1 0 1 1 0 0 1 1 0 1 1 0 1 0 0 0 0 1 1 0 0 0 |
| 24 | 15525250 | 1 1 1 0 1 1 0 0 1 1 1 0 0 1 0 1 1 0 0 0 0 0 1 0 |
| 24 | 15526720 | 1 1 1 0 1 1 0 0 1 1 1 0 1 0 1 1 0 1 0 0 0 0 0 0 |
| 24 | 15529248 | 1 1 1 0 1 1 0 0 1 1 1 1 0 1 0 1 0 0 1 0 0 0 0 0 |
| 24 | 15547412 | 1 1 1 0 1 1 0 1 0 0 1 1 1 1 0 0 0 0 0 1 0 1 0 0 |
| 24 | 15547460 | 1 1 1 0 1 1 0 1 0 0 1 1 1 1 0 0 0 1 0 0 0 1 0 0 |
| 24 | 15547464 | 1 1 1 0 1 1 0 1 0 0 1 1 1 1 0 0 0 1 0 0 1 0 0 0 |
| 24 | 15547664 | 1 1 1 0 1 1 0 1 0 0 1 1 1 1 0 1 0 0 0 1 0 0 0 0 |
| 24 | 15555008 | 1 1 1 0 1 1 0 1 0 1 0 1 1 0 0 1 1 1 0 0 0 0 0 0 |
| 24 | 15558464 | 1 1 1 0 1 1 0 1 0 1 1 0 0 1 1 1 0 1 0 0 0 0 0 0 |
| 24 | 15581800 | 1 1 1 0 1 1 0 1 1 1 0 0 0 0 1 0 0 1 1 0 1 0 0 0 |
| 24 | 15582024 | 1 1 1 0 1 1 0 1 1 1 0 0 0 0 1 1 0 1 0 0 1 0 0 0 |
| 24 | 15582384 | 1 1 1 0 1 1 0 1 1 1 0 0 0 1 0 0 1 0 1 1 0 0 0 0 |
| 24 | 15582608 | 1 1 1 0 1 1 0 1 1 1 0 0 0 1 0 1 1 0 0 1 0 0 0 0 |
| 24 | 15582880 | 1 1 1 0 1 1 0 1 1 1 0 0 0 1 1 0 1 0 1 0 0 0 0 0 |
| 24 | 15622354 | 1 1 1 0 1 1 1 0 0 1 1 0 0 0 0 0 1 1 0 1 0 0 1 0 |
| 24 | 15642676 | 1 1 1 0 1 1 1 0 1 0 1 1 0 0 0 0 0 0 1 1 0 1 0 0 |
| 24 | 15643840 | 1 1 1 0 1 1 1 0 1 0 1 1 0 1 0 0 1 1 0 0 0 0 0 0 |
| 24 | 15647920 | 1 1 1 0 1 1 1 0 1 1 0 0 0 1 0 0 1 0 1 1 0 0 0 0 |
| 24 | 15648160 | 1 1 1 0 1 1 1 0 1 1 0 0 0 1 0 1 1 0 1 0 0 0 0 0 |
| 24 | 15680200 | 1 1 1 0 1 1 1 1 0 1 0 0 0 0 1 0 1 1 0 0 1 0 0 0 |
| 24 | 15680324 | 1 1 1 0 1 1 1 1 0 1 0 0 0 0 1 1 0 1 0 0 0 1 0 0 |
| 24 | 15824528 | 1 1 1 1 0 0 0 1 0 1 1 1 0 1 1 0 1 0 0 1 0 0 0 0 |
| 24 | 15916066 | 1 1 1 1 0 0 1 0 1 1 0 1 1 1 0 0 0 0 1 0 0 0 1 0 |
| 24 | 15916168 | 1 1 1 1 0 0 1 0 1 1 0 1 1 1 0 0 1 0 0 0 1 0 0 0 |
| 24 | 15916192 | 1 1 1 1 0 0 1 0 1 1 0 1 1 1 0 0 1 0 1 0 0 0 0 0 |
| 24 | 15920194 | 1 1 1 1 0 0 1 0 1 1 1 0 1 1 0 0 0 1 0 0 0 0 1 0 |
| 24 | 15938642 | 1 1 1 1 0 0 1 1 0 0 1 1 0 1 0 0 0 1 0 1 0 0 1 0 |
| 24 | 15953994 | 1 1 1 1 0 0 1 1 0 1 1 1 0 0 0 0 0 1 0 0 1 0 1 0 |
| 24 | 15960466 | 1 1 1 1 0 0 1 1 1 0 0 0 1 0 0 1 1 0 0 1 0 0 1 0 |
| 24 | 15970388 | 1 1 1 1 0 0 1 1 1 0 1 1 0 0 0 0 0 1 0 1 0 1 0 0 |
| 24 | 16047170 | 1 1 1 1 0 1 0 0 1 1 0 1 1 1 0 0 0 1 0 0 0 0 1 0 |
| 24 | 16051234 | 1 1 1 1 0 1 0 0 1 1 1 0 1 1 0 0 0 0 1 0 0 0 1 0 |
| 24 | 16071824 | 1 1 1 1 0 1 0 1 0 0 1 1 1 1 0 0 1 0 0 1 0 0 0 0 |
| 24 | 16081700 | 1 1 1 1 0 1 0 1 0 1 1 0 0 0 1 1 0 0 1 0 0 1 0 0 |
| 24 | 16082576 | 1 1 1 1 0 1 0 1 0 1 1 0 0 1 1 0 1 0 0 1 0 0 0 0 |
| 24 | 16083980 | 1 1 1 1 0 1 0 1 0 1 1 0 1 1 0 0 0 0 0 0 1 1 0 0 |
| 24 | 16135690 | 1 1 1 1 0 1 1 0 0 0 1 1 0 1 1 0 0 0 0 0 1 0 1 0 |
| 24 | 16135720 | 1 1 1 1 0 1 1 0 0 0 1 1 0 1 1 0 0 0 1 0 1 0 0 0 |
| 24 | 16143884 | 1 1 1 1 0 1 1 0 0 1 0 1 0 1 1 0 0 0 0 0 1 1 0 0 |
| 24 | 16149184 | 1 1 1 1 0 1 1 0 0 1 1 0 1 0 1 0 1 1 0 0 0 0 0 0 |
| 24 | 16159088 | 1 1 1 1 0 1 1 0 1 0 0 1 0 0 0 1 0 1 1 1 0 0 0 0 |
| 24 | 16161104 | 1 1 1 1 0 1 1 0 1 0 0 1 1 0 0 1 0 1 0 1 0 0 0 0 |
| 24 | 16166080 | 1 1 1 1 0 1 1 0 1 0 1 0 1 1 0 0 1 1 0 0 0 0 0 0 |
| 24 | 16171352 | 1 1 1 1 0 1 1 0 1 1 0 0 0 0 0 1 0 1 0 1 1 0 0 0 |
| 24 | 16171856 | 1 1 1 1 0 1 1 0 1 1 0 0 0 0 1 1 0 1 0 1 0 0 0 0 |
| 24 | 16192322 | 1 1 1 1 0 1 1 1 0 0 0 1 0 0 1 1 0 1 0 0 0 0 1 0 |
| 24 | 16196290 | 1 1 1 1 0 1 1 1 0 0 1 0 0 0 1 0 1 1 0 0 0 0 1 0 |
| 24 | 16204484 | 1 1 1 1 0 1 1 1 0 1 0 0 0 0 1 0 1 1 0 0 0 1 0 0 |
| 24 | 16204616 | 1 1 1 1 0 1 1 1 0 1 0 0 0 0 1 1 0 1 0 0 1 0 0 0 |
| 24 | 16208480 | 1 1 1 1 0 1 1 1 0 1 0 1 0 0 1 0 0 1 1 0 0 0 0 0 |
| 24 | 16292170 | 1 1 1 1 1 0 0 0 1 0 0 1 1 0 0 1 0 1 0 0 1 0 1 0 |
| 24 | 16343842 | 1 1 1 1 1 0 0 1 0 1 1 0 0 0 1 1 0 0 1 0 0 0 1 0 |
| 24 | 16361860 | 1 1 1 1 1 0 0 1 1 0 1 0 1 0 0 1 1 0 0 0 0 1 0 0 |
| 24 | 16364816 | 1 1 1 1 1 0 0 1 1 0 1 1 0 1 0 1 0 0 0 1 0 0 0 0 |
| 24 | 16369988 | 1 1 1 1 1 0 0 1 1 1 0 0 1 0 0 1 0 1 0 0 0 1 0 0 |
| 24 | 16405700 | 1 1 1 1 1 0 1 0 0 1 0 1 0 1 0 0 1 1 0 0 0 1 0 0 |
| 24 | 16407688 | 1 1 1 1 1 0 1 0 0 1 0 1 1 1 0 0 1 0 0 0 1 0 0 0 |
| 24 | 16410132 | 1 1 1 1 1 0 1 0 0 1 1 0 0 1 1 0 0 0 0 1 0 1 0 0 |
| 24 | 16422088 | 1 1 1 1 1 0 1 0 1 0 0 1 0 1 0 0 1 1 0 0 1 0 0 0 |
| 24 | 16423972 | 1 1 1 1 1 0 1 0 1 0 0 1 1 1 0 0 0 0 1 0 0 1 0 0 |
| 24 | 16424008 | 1 1 1 1 1 0 1 0 1 0 0 1 1 1 0 0 0 1 0 0 1 0 0 0 |
| 24 | 16429252 | 1 1 1 1 1 0 1 0 1 0 1 1 0 0 0 0 1 1 0 0 0 1 0 0 |
| 24 | 16434352 | 1 1 1 1 1 0 1 0 1 1 0 0 0 1 0 0 1 0 1 1 0 0 0 0 |
| 24 | 16455976 | 1 1 1 1 1 0 1 1 0 0 0 1 1 0 0 1 0 0 1 0 1 0 0 0 |
| 24 | 16458072 | 1 1 1 1 1 0 1 1 0 0 1 0 0 0 0 1 0 1 0 1 1 0 0 0 |
| 24 | 16470216 | 1 1 1 1 1 0 1 1 0 1 0 1 0 0 0 0 1 1 0 0 1 0 0 0 |
| 24 | 16524620 | 1 1 1 1 1 1 0 0 0 0 1 0 0 1 0 1 0 1 0 0 1 1 0 0 |
| 24 | 16524884 | 1 1 1 1 1 1 0 0 0 0 1 0 0 1 1 0 0 1 0 1 0 1 0 0 |
| 24 | 16532780 | 1 1 1 1 1 1 0 0 0 1 0 0 0 1 0 1 0 0 1 0 1 1 0 0 |
| 24 | 16534168 | 1 1 1 1 1 1 0 0 0 1 0 0 1 0 1 0 1 0 0 1 1 0 0 0 |
| 24 | 16534610 | 1 1 1 1 1 1 0 0 0 1 0 0 1 1 0 0 0 1 0 1 0 0 1 0 |
| 24 | 16535972 | 1 1 1 1 1 1 0 0 0 1 0 1 0 0 0 1 1 0 1 0 0 1 0 0 |
| 24 | 16536114 | 1 1 1 1 1 1 0 0 0 1 0 1 0 0 1 0 0 0 1 1 0 0 1 0 |
| 24 | 16537124 | 1 1 1 1 1 1 0 0 0 1 0 1 0 1 1 0 0 0 1 0 0 1 0 0 |
| 24 | 16540324 | 1 1 1 1 1 1 0 0 0 1 1 0 0 0 1 0 1 0 1 0 0 1 0 0 |
| 24 | 16541000 | 1 1 1 1 1 1 0 0 0 1 1 0 0 1 0 1 0 1 0 0 1 0 0 0 |
| 24 | 16553058 | 1 1 1 1 1 1 0 0 1 0 0 1 0 1 0 0 0 1 1 0 0 0 1 0 |
| 24 | 16553228 | 1 1 1 1 1 1 0 0 1 0 0 1 0 1 0 1 0 0 0 0 1 1 0 0 |
| 24 | 16553240 | 1 1 1 1 1 1 0 0 1 0 0 1 0 1 0 1 0 0 0 1 1 0 0 0 |
| 24 | 16553512 | 1 1 1 1 1 1 0 0 1 0 0 1 0 1 1 0 0 0 1 0 1 0 0 0 |
| 24 | 16556596 | 1 1 1 1 1 1 0 0 1 0 1 0 0 0 1 0 0 0 1 1 0 1 0 0 |
| 24 | 16558480 | 1 1 1 1 1 1 0 0 1 0 1 0 1 0 0 1 1 0 0 1 0 0 0 0 |
| 24 | 16560404 | 1 1 1 1 1 1 0 0 1 0 1 1 0 0 0 1 0 0 0 1 0 1 0 0 |
| 24 | 16564900 | 1 1 1 1 1 1 0 0 1 1 0 0 0 0 1 0 1 0 1 0 0 1 0 0 |
| 24 | 16566928 | 1 1 1 1 1 1 0 0 1 1 0 0 1 0 1 0 1 0 0 1 0 0 0 0 |
| 24 | 16568968 | 1 1 1 1 1 1 0 0 1 1 0 1 0 0 1 0 1 0 0 0 1 0 0 0 |
| 24 | 16586916 | 1 1 1 1 1 1 0 1 0 0 0 1 1 0 0 0 1 0 1 0 0 1 0 0 |
| 24 | 16587080 | 1 1 1 1 1 1 0 1 0 0 0 1 1 0 0 1 0 1 0 0 1 0 0 0 |
| 24 | 16591048 | 1 1 1 1 1 1 0 1 0 0 1 0 1 0 0 0 1 1 0 0 1 0 0 0 |
| 24 | 16593192 | 1 1 1 1 1 1 0 1 0 0 1 1 0 0 0 1 0 0 1 0 1 0 0 0 |

A SIG field may be designed for uplink active transmission by the non-backscatter device. Because the uplink transmission is a trigger based transmission, the AMP AP may know the transmission information. In some examples, the non-backscatter device may convey the payload size to the AMP AP, such as the length of the data. The length of the data may be conveyed as a contiguous and flexible length value, such as in units of octets. In some examples, the length of data may be conveyed as discrete values (such as, 64 bits, 96 bits, 128 bits) for different implementations and expected payload sizes. In some examples, the non-backscatter device may transmit a PPDU with no SIG field, and the non-backscatter device may use a MAC header to convey the length. In another example, the non-backscatter device may transmit a PPDU with a SIG field that carries the length. In some examples, the SIG field may provide a fixed length, may add a cyclic redundancy check (CRC), may further add coding on top, and the waveform associated with the SIG field may be the same as the data field, such as having a same chip duration, OOK waveform, or Manchester waveform.

In some examples, the data field may include repetition and spreading code. For repetition, the repetition may be performed before the Manchester coding, such as, from 1 Mbps to 250 kbps, four 0 repetition 0000 or four 1 repetition 1111. After Manchester coding, the repetition becomes 01010101 and 10101010 operating at high rate. For the spreading code, a spreading code 0101 may be used for 4×spreading. For the spreading code, four 0 repetition 0101 is Manchester 01100110 and four 1 repetition 1010 is Manchester 10011001. For the spreading code, the chip duration may be scaled by 2× and may operate at a lower rate compared to repetition, and the transition between 0 and 1 or between 1 and 0 may be at a higher rate.

In some examples, the SYNC sequences may be encoded via a Manchester OOK encoding algorithm or the SYNC sequences may be encoded via an OOK encoding algorithm without Manchester encoding. For example, given a length-L bit sequence B (and its complementary sequence B̅=1−B), the length-2L Manchester encoded chip sequence W may be given as W(1:2:2L−1)=B̅ and W(2:2:2L)=B, and its complementary chip sequence W̅ may be given as W̅(1:2:2L−1)=B and W(2:2:2L)=B̅. the Manchester encoded sequence and its complementary sequence may be considered as sequences derived from the base sequence B through chip-interleaving of two sequences B and B̅.

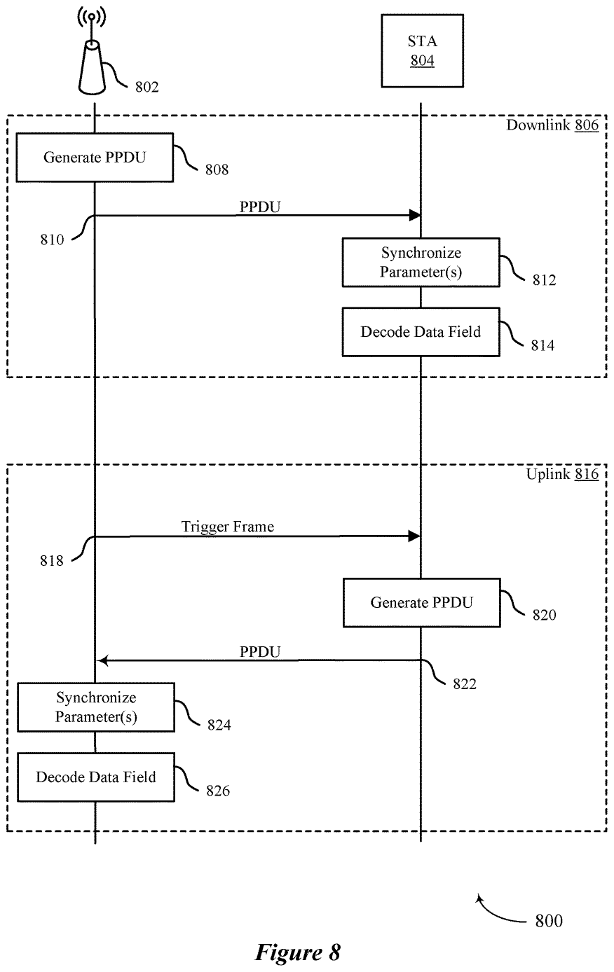

FIG. 8 shows an example of a process flow 800 that supports the ambient power synchronization field. For example, an AP 802 and a STA 804 may be examples of corresponding devices described with reference to FIGS. 1-7, may perform wireless communications in accordance with the process flow 800. In some examples, the STA 804 may be a backscatter device or a non-backscatter device. In the following description of the process flow 800, the operations between the AP 802 and STA 804 may be transmitted in a different order than the example order shown, or the operations performed by the AP 802 and the STA 804 may be performed in different orders or at different times. Some operations also may be omitted from the process flow 800, and other operations may be added to the process flow 800. In some examples, the STA may include or more transceivers configured to receive and transmit the PPDU. In some examples the AP 802 may include or more transceivers configured to transmit and receive the PPDU. Process flow 800 shows techniques related to communicating the ambient power synchronization field in downlink 806 operations and in uplink 816.

The downlink signaling and techniques are described with reference to 808-814. At 808, the AP 802 may generate a PPDU including a SYNC field and a data field. The SYNC field may include at least a sequence of on symbols and off symbols, where the sequence may include three consecutive on symbols or three consecutive off symbols. In some examples, the sequence may include three consecutive on symbols and three consecutive off symbols. In some examples, the sequence may not include four or more consecutive off symbols or four or more consecutive on symbols. In some examples, the sequence may include one or more of a base sequence or a logical complement of the base sequence. In some examples, at least one of: the sequence may include a pattern of one or more instances of the base sequence and one or more instances of the logical complement of the base sequence, or the pattern may indicate a size of the data field. In some examples, the base sequence may include an equal quantity of off symbols and on symbols. In some examples, a length of the base sequence may be an even quantity of symbols. In some examples, a first symbol of the sequence may be an on symbol.

At 810, the AP 802 may output the PPDU for transmission and the STA 804 may obtain, from the AP 802, the PPDU. The PPDU may include at least a SYNC field and a data field. In some examples, the sequence may be associated with a first data rate used to communicate the PPDU or a logical complement of the sequence may be associated with a second data rate used to communicate the PPDU. In some examples, the AP 802 may encode the sequence via a Manchester encoding algorithm before outputting the sequence. In some examples, the STA 804 may decode the sequence via a Manchester decoding algorithm after obtaining the sequence.

At 812, the STA 804 may synchronize one or more parameters based on the SYNC field. For example, the one or more parameters synchronized by the synchronization field may include one or more timing parameters, one or more frequency parameters, estimating channel characteristics, detecting one or more frames, or any combination thereof. In some examples, the synchronization field may allow the receiver to synchronize its timing with the incoming signal. Timing synchronization helps ensure that the receiver can correctly interpret the start and end of each bit in the data stream. In some examples, the synchronization field helps the receiver to adjust its local oscillator to match the frequency of the incoming signal. This may enable the receiver to compensate for any frequency offset between the transmitter and receiver, which can occur due to differences in their respective clocks. In some examples, the synchronization field provides information that the receiver can use to estimate the characteristics of the communication channel, such as signal strength and multipath effects. This may improve the decoding process and the overall reliability of the communication. In some examples, the synchronization field may help the receiver to detect the presence of a frame. For instance, the synchronization field may indicate that a valid frame is about to be received, allowing the receiver to prepare for processing the subsequent data in the data field.

At 814, the STA 804 may decode the data field of the PPDU based on the one or more parameters.

The uplink signaling and techniques are described with reference to 818-826. At 818, the STA may obtain a trigger frame. At 820, the STA 804 may generate, based on the trigger frame, a PPDU including a SYNC field and a data field. The SYNC field may include a sequence of on symbols and off symbols, where the sequence may include three consecutive on symbols or three consecutive off symbols. In some examples, the sequence may include three consecutive on symbols and three consecutive off symbols. In some examples, the sequence may not include four or more consecutive off symbols or four or more consecutive on symbols. In some examples, the sequence may include one or more of a base sequence or a logical complement of the base sequence. In some examples, at least one of: the sequence may include a pattern of one or more instances of the base sequence and one or more instances of the logical complement of the base sequence, or the pattern may indicate a size of the data field. In some examples, the base sequence may include an equal quantity of off symbols and on symbols. In some examples, a length of the base sequence may be an even quantity of symbols. In some examples, a first symbol of the sequence may be an on symbol.

At 822, the STA 804 may output the PPDU for transmission and the AP 802 may obtain, from the STA 804, the PPDU. The PPDU may include a SYNC field and a data field. In some examples, the sequence may be associated with a first data rate used to communicate the PPDU or a logical complement of the sequence may be associated with a second data rate used to communicate the PPDU. In some examples, the STA 804 may encode the sequence via a Manchester encoding algorithm before outputting the sequence. In some examples, the AP 802 may decode the sequence via a Manchester decoding algorithm after obtaining the sequence.

At 824, the AP 802 may synchronize one or more parameters based on the SYNC field. For example, the one or more parameters synchronized by the synchronization field may include one or more timing parameters, one or more frequency parameters, estimating channel characteristics, detecting one or more frames, or any combination thereof. In some examples, the synchronization field may allow the receiver to synchronize its timing with the incoming signal. Timing synchronization helps ensure that the receiver can correctly interpret the start and end of each bit in the data stream. In some examples, the synchronization field helps the receiver to adjust its local oscillator to match the frequency of the incoming signal. This may enable the receiver to compensate for any frequency offset between the transmitter and receiver, which can occur due to differences in their respective clocks. In some examples, the synchronization field provides information that the receiver can use to estimate the characteristics of the communication channel, such as signal strength and multipath effects. This may improve the decoding process and the overall reliability of the communication. In some examples, the synchronization field may help the receiver to detect the presence of a frame. For instance, the synchronization field may indicate that a valid frame is about to be received, allowing the receiver to prepare for processing the subsequent data in the data field.

At 826, the AP 802 may decode the data field of the PPDU based on the one or more parameters.

For either downlink 806 or uplink 816, in some examples, the SYNC field is one of: a first candidate sequence associated with a first data rate associated with the PPDU, a second candidate sequence associated with a second data rate associated with the PPDU, or a third candidate sequence associated with a third data rate associated with the PPDU. In some examples, the first candidate sequence and the second candidate sequence may be the same. In some examples, a length of the first candidate sequence may be scaled based on a symbol duration associated with the SYNC field. In some examples, the first candidate sequence and the second candidate sequence may be different. In some examples, the first candidate sequence and the second candidate sequence may have different lengths. In some examples, the second candidate sequence may be a logical complement of the first candidate sequence. In some examples, a length of the first candidate sequence, the second candidate sequence, or the third candidate sequence may be scaled based on a symbol duration associated with the SYNC field.

In some examples, the SYNC field is one of: a first candidate sequence associated with a first data rate associated with the PPDU, a second candidate sequence associated with a second data rate associated with the PPDU, or a third candidate sequence associated with a third data rate associated with the PPDU, and the first candidate sequence, the second candidate sequence, and the third candidate sequence may have a same symbol duration, where the first candidate sequence, the second candidate sequence, and the third candidate sequence may each have different lengths. In some examples, the first candidate sequence may include at least one of: more than one copy of the third candidate sequence, a complement of the third candidate sequence, a reverse ordering of the third candidate sequence, or a bit-wise repetition of the third candidate sequence. In some examples, the first candidate sequence, the second candidate sequence, and the third candidate sequence may include different patterns of on symbols and off symbols. In some examples, each of the second candidate sequence and the third candidate sequence may be shorter, lengthwise, than the first candidate sequence. In some examples, the first candidate sequence and the second candidate sequence may include a same pattern of on symbols and off symbols, and the third candidate sequence may be shorter in length than the first candidate sequence. In some examples, the first candidate sequence, the second candidate sequence, and the third candidate sequence may include a same pattern of on symbols and off symbols. In some examples, the first candidate sequence and the second candidate sequence may have a first symbol duration associated with the SYNC field and the third candidate sequence may have a second symbol duration associated with the SYNC field, where the first symbol duration may be different from the second symbol duration.

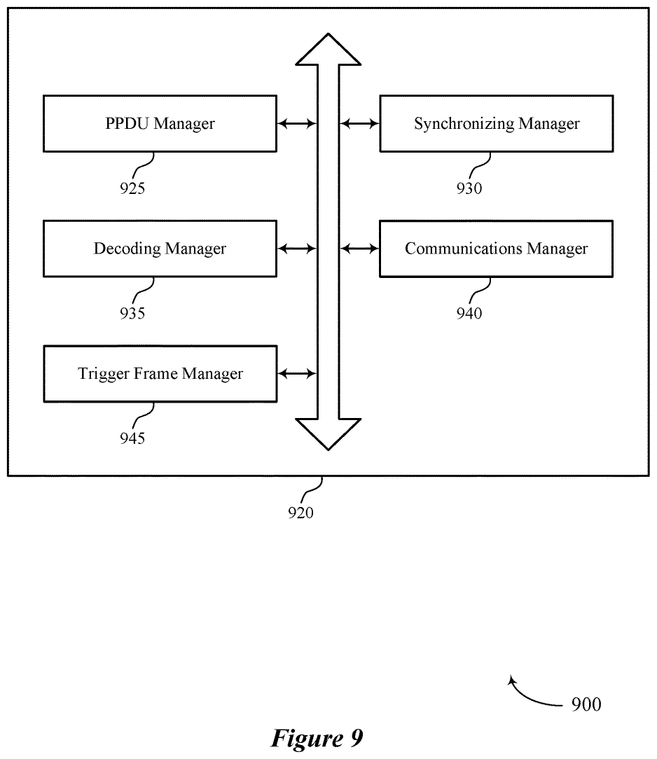

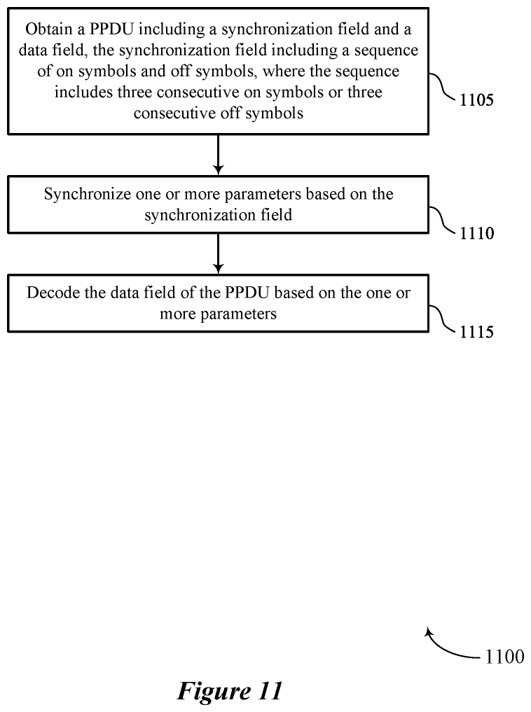

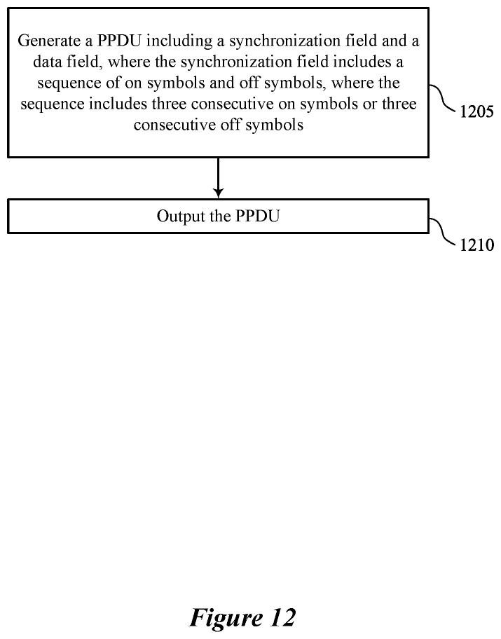

FIG. 9 shows a block diagram of an example wireless communication device 900 that supports AMP SYNC field. In some examples, the wireless communication device 900 is configured to perform the processes 1100 and 1200 described with reference to FIGS. 11 and 12, respectively.

Further, various components of the wireless communication device 900 may provide means for performing the methods described herein. In some examples, means for transmitting and/or receiving may include the transceivers and/or antenna(s) of the wireless communication device 900. In some examples, means for outputting or sending (such as means for outputting for transmission) and means for obtaining (such as means for obtaining after information is received from a different device) may include one or more interfaces of the wireless communication device 900 to output signals to other components or obtain signals from other components of the wireless communication device 900. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for synchronizing, means for decoding, means for encoding, means for generating, include a processing system, processor circuitry (including one or more processors), memory circuitry, and/or computer-readable media of the wireless communication device 900.

The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes a PPDU manager 925, a synchronizing manager 930, a decoding manager 935, a communication manager 940, and a trigger frame manager 945. Portions of one or more of the PPDU manager 925, the synchronizing manager 930, the decoding manager 935, the communication manager 940, and the trigger frame manager 945 may be implemented at least in part in hardware or firmware. For example, one or more of the PPDU manager 925, the synchronizing manager 930, the decoding manager 935, the communication manager 940, and the trigger frame manager 945 may be implemented at least in part by at least a processor or a modem. In some examples, portions of one or more of the PPDU manager 925, the synchronizing manager 930, the decoding manager 935, the communication manager 940, and the trigger frame manager 945 may be implemented at least in part by a processor and software in the form of processor-executable code stored in memory.

The wireless communication device 900 may support wireless communications in accordance with examples as disclosed herein. The PPDU manager 925 is configurable or configured to obtain a physical layer protocol data unit (PPDU) including at least a SYNC field and a data field, the SYNC field including a sequence of on symbols and off symbols, where the sequence includes three consecutive on symbols or three consecutive off symbols. The synchronizing manager 930 is configurable or configured to synchronize one or more parameters based on the SYNC field. The decoding manager 935 is configurable or configured to decode the data field of the PPDU based on the one or more parameters.

Additionally, or alternatively, the wireless communication device 900 may support wireless communications in accordance with examples as disclosed herein. The trigger frame manager 945 is configurable or configured to obtain a trigger frame. In some examples, the PPDU manager 925 is configurable or configured to generate, based on the trigger frame, a physical layer protocol data unit (PPDU) including at least a first synchronization field and a data field, the first synchronization field including a sequence of on-symbols and off-symbols, where the sequence does not include four consecutive off-symbols. The communications manager 940 is configurable or configured to output the PPDU.

In some examples, a symbol duration for a symbol in the PPDU is 2 microseconds.

In some examples, the sequence does not include eight consecutive off-symbols.

In some examples, a symbol duration for a symbol in the PPDU is 1 microsecond.

In some examples, the sequence includes one or more of a base sequence or a logical complement of the base sequence.

In some examples, the sequence includes a pattern of one or more instances of the base sequence.

In some examples, the sequence includes a pattern of one or more instances of the logical complement of the base sequence.

In some examples, the sequence includes a pattern of one or more instances of the base sequence and one or more instances of the logical complement of the base sequence.

In some examples, the pattern indicates a size of the data field.

In some examples, the base sequence includes an equal quantity of off symbols and on symbols.

In some examples, a length of the base sequence is an even quantity of symbols.

In some examples, a first symbol of the sequence is an on symbol.

In some examples, the PPDU includes a second synchronization field.

The wireless communication device 900 may support wireless communications in accordance with examples as disclosed herein. The PPDU manager 925 is configurable or configured to obtain a physical layer protocol data unit (PPDU) including at least a SYNC field and a data field, the SYNC field including a sequence of on symbols and off symbols, where the sequence includes three consecutive on symbols or three consecutive off symbols. The synchronizing manager 930 is configurable or configured to synchronize one or more parameters based on the SYNC field. The decoding manager 935 is configurable or configured to decode the data field of the PPDU based on the one or more parameters.

In some examples, the sequence includes three consecutive on symbols and three consecutive off symbols.

In some examples, the sequence does not include four or more consecutive off symbols or four or more consecutive on symbols.

In some examples, the sequence may include one or more of a base sequence or a logical complement of the base sequence.

In some examples, at least one of: the sequence may include a pattern of one or more instances of the base sequence and one or more instances of the logical complement of the base sequence, or the pattern may indicate a size of the data field.

In some examples, the base sequence may include an equal quantity of off symbols and on symbols.

In some examples, a length of the base sequence may include an even quantity of symbols.

In some examples, a first symbol of the sequence may be an on symbol.

In some examples, the sequence is associated with a first data rate used to communicate the PPDU or a logical complement of the sequence is associated with a second data rate used to communicate the PPDU.

In some examples, the decoding manager 935 is configurable or configured to decode the sequence via a Manchester decoding algorithm after obtaining the sequence.

Additionally, or alternatively, the wireless communication device 900 may support wireless communications in accordance with examples as disclosed herein. In some examples, the PPDU manager 925 is configurable or configured to generate a physical layer protocol data unit (PPDU) including at least a SYNC field and a data field, where the SYNC field includes a sequence of on symbols and off symbols, where the sequence includes three consecutive on symbols or three consecutive off symbols. The communication manager 940 is configurable or configured to output the PPDU.

In some examples, the sequence includes three consecutive on symbols and three consecutive off symbols.

In some examples, the sequence does not include four or more consecutive off symbols or four or more consecutive on symbols.

In some examples, the sequence may include one or more of a base sequence or a logical complement of the base sequence.

In some examples, at least one of: the sequence may include a pattern of one or more instances of the base sequence and one or more instances of the logical complement of the base sequence, or the pattern may indicate a size of the data field.

In some examples, the base sequence may include an equal quantity of off symbols and on symbols.

In some examples, a length of the base sequence may be an even quantity of symbols.

In some examples, a first symbol of the sequence is an on symbol

In some examples, the sequence in the SYNC field is one of a first candidate sequence associated with a first data rate associated with the PPDU, a second candidate sequence associated with a second data rate associated with the PPDU, or a third candidate sequence associated with a third data rate associated with the PPDU.

In some examples, the first candidate sequence and the second candidate sequence are the same.

In some examples, a length of the first candidate sequence is scaled based on a symbol duration associated with the SYNC field.

In some examples, the first candidate sequence and the second candidate sequence are different.

In some examples, the first candidate sequence and the second candidate sequence have different lengths.

In some examples, the second candidate sequence is a logical complement of the first candidate sequence.

In some examples, a length of the first candidate sequence, the second candidate sequence, or the third candidate sequence is scaled based on a symbol duration associated with the SYNC field.

In some examples, the first candidate sequence, the second candidate sequence, and the third candidate sequence have a same symbol duration. In some examples, the first candidate sequence, the second candidate sequence, and the third candidate sequence each have different lengths.

In some examples, the first candidate sequence includes at least one of more than one copy of the third candidate sequence, a complement of the third candidate sequence, a reverse ordering of the third candidate sequence, or a bit-wise repetition of the third candidate sequence.

In some examples, the first candidate sequence, the second candidate sequence, and the third candidate sequence include different patterns of on symbols and off symbols.

In some examples, each of the second candidate sequence and the third candidate sequence is shorter, lengthwise, than the first candidate sequence.

In some examples, the first candidate sequence and the second candidate sequence include a same pattern of on symbols and off symbols and the third candidate sequence is shorter in length than the first candidate sequence.

In some examples, the first candidate sequence, the second candidate sequence, and the third candidate sequence include a same pattern of on symbols and off symbols.

In some examples, the first candidate sequence and the second candidate sequence have a first symbol duration associated with the SYNC field and the third candidate sequence has a second symbol duration associated with the SYNC field. In some examples, the first symbol duration is different from the second symbol duration.

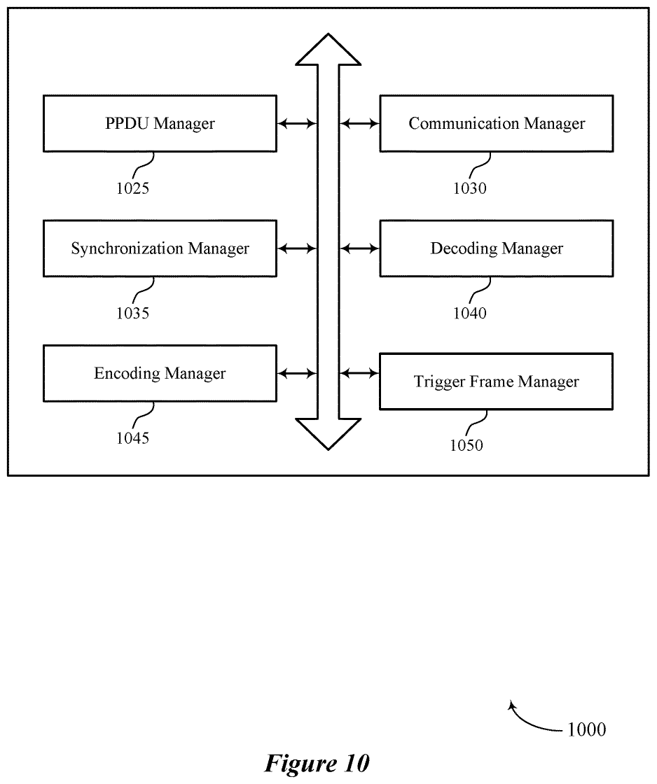

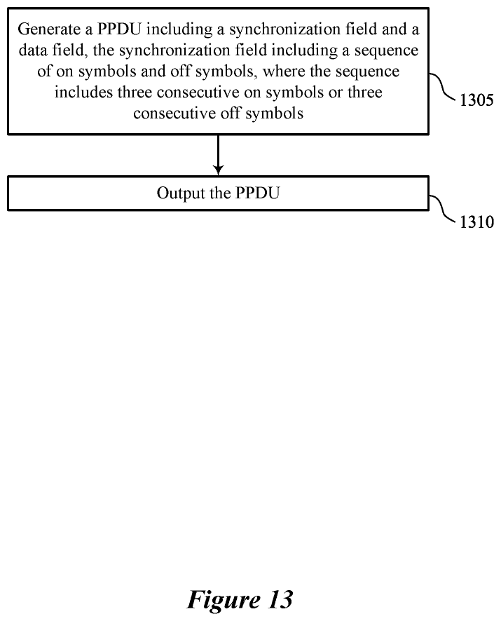

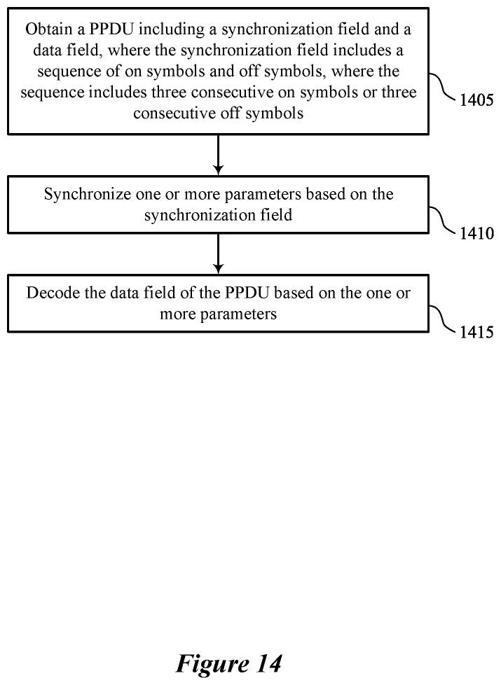

FIG. 10 shows a block diagram of an example wireless communication device 1000 that supports AMP SYNC field. In some examples, the wireless communication device 1000 is configured to perform the processes 1300 and 1600 described with reference to FIGS. 13 and 14, respectively.

Further, various components of the wireless communication device 1000 may provide means for performing the methods described herein. In some examples, means for transmitting and/or receiving may include the transceivers and/or antenna(s) of the wireless communication device 1000. In some examples, means for outputting or sending (such as means for outputting for transmission) and means for obtaining (such as means for obtaining after information is received from a different device) may include one or more interfaces of the wireless communication device 1000 to output signals to other components or obtain signals from other components of the wireless communication device 1000. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for synchronizing, means for decoding, means for encoding, means for generating, include a processing system, processor circuitry (including one or more processors), memory circuitry, and/or computer-readable media of the wireless communication device 1000.

The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a PPDU manager 1025, a communication manager 1030, a SYNC manager 1035, a decoding manager 1040, an encoding manager 1045, and a trigger frame manager 1050. Portions of one or more of the PPDU manager 1025, the communication manager 1030, the SYNC manager 1035, the decoding manager 1040, the encoding manager 1045, and the trigger frame manager 1050 may be implemented at least in part in hardware or firmware. For example, one or more of the PPDU manager 1025, the communication manager 1030, the SYNC manager 1035, the decoding manager 1040, the encoding manager 1045, and the trigger frame manager 1050 may be implemented at least in part by at least a processor or a modem. In some examples, portions of one or more of the PPDU manager 1025, the communication manager 1030, the SYNC manager 1035, the decoding manager 1040, the encoding manager 1045, and the trigger frame manager 1050 may be implemented at least in part by a processor and software in the form of processor-executable code stored in memory.

The wireless communication device 1000 may support wireless communications in accordance with examples as disclosed herein. The trigger frame manager 1050 is configurable or configured to obtain a trigger frame. The PPDU manager 1025 is configurable or configured to generate a physical layer protocol data unit (PPDU) including at least a SYNC field and a data field, the SYNC field including a sequence of on symbols and off symbols, where the sequence includes three consecutive on symbols or three consecutive off symbols. The communication manager 1030 is configurable or configured to output the PPDU.

In some examples, the sequence includes three consecutive on symbols and three consecutive off symbols.

In some examples, the sequence does not include four or more consecutive off symbols or four or more consecutive on symbols.

In some examples, the sequence may include one or more of a base sequence or a logical complement of the base sequence.

In some examples, at least one of: the sequence may include a pattern of one or more instances of the base sequence and one or more instances of the logical complement of the base sequence, or the pattern may indicate a size of the data field.

In some examples, the base sequence may include an equal quantity of off symbols and on symbols.

In some examples, a length of the base sequence may be an even quantity of symbols.

In some examples, a first symbol of the sequence may be an on symbol

In some examples, the sequence is associated with a first data rate used to communicate the PPDU or a logical complement of the sequence is associated with a second data rate used to communicate the PPDU.

In some examples, the encoding manager 1045 is configurable or configured to encode the sequence via a Manchester decoding algorithm after obtaining the sequence.

Additionally, or alternatively, the wireless communication device 1000 may support wireless communications in accordance with examples as disclosed herein. In some examples, the PPDU manager 1025 is configurable or configured to obtain a physical layer protocol data unit (PPDU) including at least a SYNC field and a data field, where the SYNC field includes a sequence of on symbols and off symbols, where the sequence includes three consecutive on symbols or three consecutive off symbols. The SYNC manager 1035 is configurable or configured to synchronize one or more parameters based on the SYNC field. The decoding manager 1040 is configurable or configured to decode the data field of the PPDU based on the one or more parameters.

In some examples, the sequence includes three consecutive on symbols and three consecutive off symbols.

In some examples, the sequence does not include four or more consecutive off symbols or four or more consecutive on symbols.

In some examples, the sequence may include one or more of a base sequence or a logical complement of the base sequence.

In some examples, at least one of: the sequence may include a pattern of one or more instances of the base sequence and one or more instances of the logical complement of the base sequence, or the pattern may indicate a size of the data field.

In some examples, the base sequence may include an equal quantity of off symbols and on symbols.

In some examples, a length of the base sequence may be an even quantity of symbols.

In some examples, a first symbol of the sequence may be an on symbol.

In some examples, the sequence in the SYNC field is one of a first candidate sequence associated with a first data rate associated with the PPDU, a second candidate sequence associated with a second data rate associated with the PPDU, or a third candidate sequence associated with a third data rate associated with the PPDU.

In some examples, the first candidate sequence and the second candidate sequence are the same.

In some examples, a length of the first candidate sequence is scaled based on a symbol duration associated with the SYNC field.

In some examples, the first candidate sequence and the second candidate sequence are different.

In some examples, the first candidate sequence and the second candidate sequence have different lengths.

In some examples, the second candidate sequence is a logical complement of the first candidate sequence.

In some examples, a length of the first candidate sequence, the second candidate sequence, or the third candidate sequence is scaled based on a symbol duration associated with the SYNC field.

In some examples, the first candidate sequence, the second candidate sequence, and the third candidate sequence have a same symbol duration. In some examples, the first candidate sequence, the second candidate sequence, and the third candidate sequence each have different lengths.

In some examples, the first candidate sequence includes at least one of more than one copy of the third candidate sequence, a complement of the third candidate sequence, a reverse ordering of the third candidate sequence, or a bit-wise repetition of the third candidate sequence.

In some examples, the first candidate sequence, the second candidate sequence, and the third candidate sequence include different patterns of on symbols and off symbols.

In some examples, each of the second candidate sequence and the third candidate sequence is shorter, lengthwise, than the first candidate sequence.

In some examples, the first candidate sequence and the second candidate sequence include a same pattern of on symbols and off symbols and the third candidate sequence is shorter in length than the first candidate sequence.

In some examples, the first candidate sequence, the second candidate sequence, and the third candidate sequence include a same pattern of on symbols and off symbols.

In some examples, the first candidate sequence and the second candidate sequence have a first symbol duration associated with the SYNC field and the third candidate sequence has a second symbol duration associated with the SYNC field. In some examples, the first symbol duration is different from the second symbol duration.

Additionally, or alternatively, the wireless communication device 1000 may support wireless communications in accordance with examples as disclosed herein. The trigger frame manager 1050 is configurable or configured to output a trigger frame. In some examples, the PPDU manager 1025 is configurable or configured to obtain a physical layer protocol data unit (PPDU) including at least a first synchronization field and a data field, where the first synchronization field includes a sequence of on symbols and off symbols, where the sequence does not include four consecutive off-symbols. The SYNC manager 1035 is configurable or configured to synchronize one or more parameters based on the first synchronization field. The decoding manager 1040 is configurable or configured to decode the data field of the PPDU based on the one or more parameters.

In some examples, a symbol duration for a symbol in the PPDU is 2 microseconds.

In some examples, the sequence does not include eight consecutive off-symbols.

In some examples, a symbol duration for a symbol in the PPDU is 1 microsecond.

In some examples, the sequence includes one or more instances of a base sequence.

In some examples, the sequence includes at least one of: a pattern of one or more instances of a base sequence, one or more instances of a logical complement of the base sequence, one or more instances of a reverse ordering of the base sequence, or one or more instances of a bit-wise repetition of the base sequence.

In some examples, a symbol duration for an individual symbol in the sequence is scaled to fit a length associated with the sequence.

In some examples, the sequence is scaled based on a symbol duration for an individual symbol in the sequence.

In some examples, the sequence includes a pattern of one or more instances of the base sequence and one or more instances of the logical complement of the base sequence, and the pattern indicates a size of the data field.

In some examples, the base sequence includes an equal quantity of off symbols and on symbols.

In some examples, a length of the base sequence is an even quantity of symbols.

In some examples, the sequence includes a pattern of one or more instances of a base sequence, one or more instances of a logical complement of the base sequence, one or more instances of a reverse ordering of the base sequence, one or more instances of a bit-wise repetition of the base sequence, or a combination thereof.

In some examples, the pattern indicates a size of the data field.

In some examples, a first symbol of the sequence is an on symbol.

In some examples, a first candidate sequence associated with a first data rate associated with the PPDU, a second candidate sequence associated with a second data rate associated with the PPDU, or a third candidate sequence associated with a third data rate associated with the PPDU.

In some examples, the first candidate sequence and the second candidate sequence are the same.

In some examples, a duration of the first synchronization field is scaled based on a symbol duration.

In some examples, the first candidate sequence and the second candidate sequence have different lengths.

In some examples, a length of the first candidate sequence, the second candidate sequence, or the third candidate sequence is scaled based on a symbol duration.

In some examples, the first candidate sequence, the second candidate sequence, and the third candidate sequence have a same symbol duration, the first candidate sequence, the second candidate sequence, and the third candidate sequence each have different lengths.

In some examples, the first candidate sequence comprises at least one of: more than one copy of a base sequence, a complement of the base sequence, a reverse ordering of the base sequence, or a bit-wise repetition of the base sequence.

In some examples, the first candidate sequence, the second candidate sequence, and the third candidate sequence have a same length.

In some examples, the first candidate sequence and the second candidate sequence have a first symbol duration associated with the first synchronization field and the third candidate sequence has a second symbol duration associated with the first synchronization field, the first symbol duration is different from the second symbol duration.

In some examples, the PPDU includes a second synchronization field.

In some examples, the data field includes a first portion and a second portion, and second synchronization field is between the first portion and the second portion

FIG. 11 shows a flowchart illustrating an example process 1100 performable by or at an apparatus that supports AMP SYNC field. The operations of the process 1100 may be implemented by an apparatus or its components as described herein. For example, the process 1100 may be performed by a wireless communication device, such as the wireless communication device 900 described with reference to FIG. 9, operating as or within a wireless STA. In some examples, the process 1100 may be performed by a wireless STA, such as one of the STAs 104 described with reference to FIG. 1.

In some examples, in 1105, the apparatus may obtain a PPDU including a SYNC field and a data field, the SYNC field including a sequence of on symbols and off symbols, where the sequence includes three consecutive on symbols or three consecutive off symbols. In some implementations, aspects of the operations of 1105 may be performed by a PPDU manager 925 as described with reference to FIG. 9.

In some examples, in 1110, the apparatus may synchronize one or more parameters based on the SYNC field. In some implementations, aspects of the operations of 1110 may be performed by a synchronizing manager 930 as described with reference to FIG. 9.

In some examples, in 1115, the apparatus may decode the data field of the PPDU based on the one or more parameters. In some implementations, aspects of the operations of 1115 may be performed by a decoding manager 935 as described with reference to FIG. 9.

FIG. 12 shows a flowchart illustrating an example process 1200 performable by or at an apparatus that supports AMP SYNC field. The operations of the process 1200 may be implemented by an apparatus or its components as described herein. For example, the process 1200 may be performed by a wireless communication device, such as the wireless communication device 900 described with reference to FIG. 9, operating as or within a wireless STA. In some examples, the process 1200 may be performed by a wireless STA, such as one of the STAs 104 described with reference to FIG. 1.

In some examples, in 1205, the apparatus may generate a PPDU including a SYNC field and a data field, where the SYNC field includes a sequence of on symbols and off symbols, where the sequence includes three consecutive on symbols or three consecutive off symbols. In some implementations, aspects of the operations of 1205 may be performed by a PPDU manager 925 as described with reference to FIG. 9.

In some examples, in 1210, the apparatus may output the PPDU. In some implementations, aspects of the operations of 1210 may be performed by a communication manager 940 as described with reference to FIG. 9.

FIG. 13 shows a flowchart illustrating an example process 1300 performable by or at an apparatus that supports AMP SYNC field. The operations of the process 1300 may be implemented by an apparatus or its components as described herein. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in 1305, the apparatus may generate a PPDU including at least a SYNC field and a data field, the SYNC field including a sequence of on symbols and off symbols, where the sequence includes three consecutive on symbols or three consecutive off symbols. In some implementations, aspects of the operations of 1305 may be performed by a PPDU manager 1025 as described with reference to FIG. 10.

In some examples, in 1310, the apparatus may output the PPDU. In some implementations, aspects of the operations of 1310 may be performed by a communication manager 1030 as described with reference to FIG. 10.

FIG. 14 shows a flowchart illustrating an example process 1400 performable by or at an apparatus that supports AMP SYNC field. The operations of the process 1400 may be implemented by an apparatus or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in 1405, the apparatus may obtain a PPDU including at least a SYNC field and a data field, where the SYNC field includes a sequence of on symbols and off symbols, where the sequence includes three consecutive on symbols or three consecutive off symbols. In some implementations, aspects of the operations of 1405 may be performed by a PPDU manager 1025 as described with reference to FIG. 10.

In some examples, in 1410, the apparatus may synchronize one or more parameters based on the SYNC field. In some implementations, aspects of the operations of 1410 may be performed by a SYNC manager 1035 as described with reference to FIG. 10.

In some examples, in 1415, the apparatus may decode the data field of the PPDU based on the one or more parameters. In some implementations, aspects of the operations of 1415 may be performed by a decoding manager 1040 as described with reference to FIG. 10.

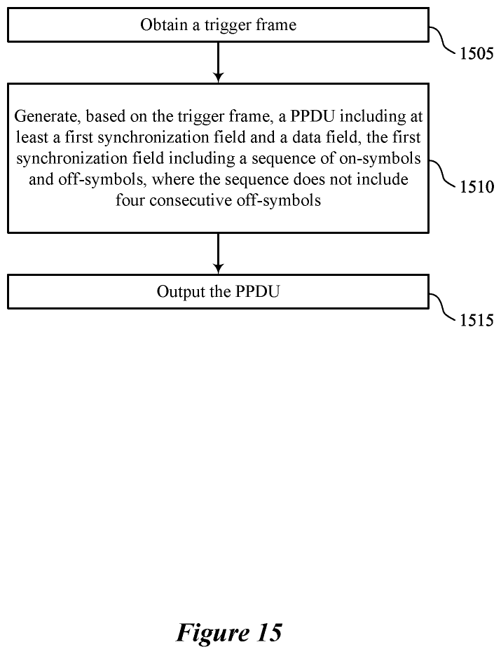

FIG. 15 shows a flowchart illustrating an example process 1500 performable by or at an apparatus that supports AMP SYNC field. The operations of the process 1500 may be implemented by an apparatus or its components as described herein. For example, the process 1500 may be performed by a wireless communication device, such as the wireless communication device 1000 described with reference to FIG. 10, operating as or within a wireless STA. In some examples, the process 1500 may be performed by a wireless STA, such as one of the STAs 104 described with reference to FIG. 1.

In some examples, in 1505, the apparatus may obtain a trigger frame. In some implementations, aspects of the operations of 1505 may be performed by a trigger frame manager 945 as described with reference to FIG. 9.

In some examples, in 1510, the apparatus may generate, based on the trigger frame, a PPDU including at least a first synchronization field and a data field, the first synchronization field including a sequence of on-symbols and off-symbols, where the sequence does not include four consecutive off-symbols. In some implementations, aspects of the operations of 1510 may be performed by a PPDU manager 925 as described with reference to FIG. 9.

In some examples, in 1515, the apparatus may output the PPDU. In some implementations, aspects of the operations of 1515 may be performed by a communications manager 940 as described with reference to FIG. 9.

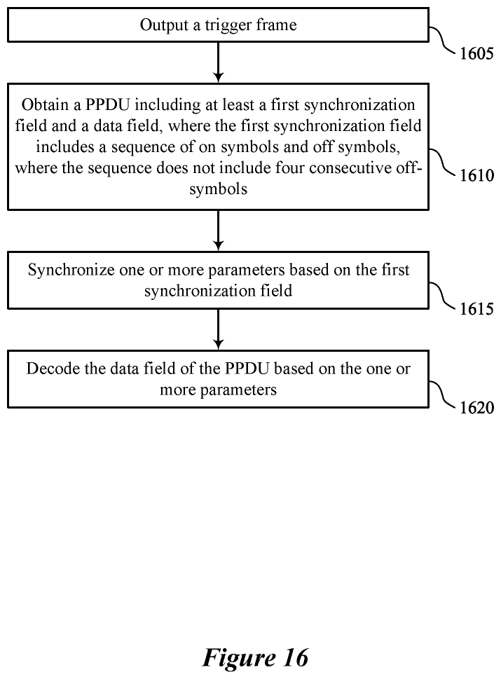

FIG. 16 shows a flowchart illustrating an example process 1600 performable by or at an apparatus that supports AMP SYNC field. The operations of the process 1600 may be implemented by an apparatus or its components as described herein. For example, the process 1600 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in 1605, the apparatus may output a trigger frame. In some implementations, aspects of the operations of 1605 may be performed by a trigger frame manager 1050 as described with reference to FIG. 10.

In some examples, in 1610, the apparatus may obtain a PPDU including at least a first synchronization field and a data field, where the first synchronization field includes a sequence of on symbols and off symbols, where the sequence does not include four consecutive off-symbols. In some implementations, aspects of the operations of 1610 may be performed by a PPDU manager 1025 as described with reference to FIG. 10.

In some examples, in 1615, the apparatus may synchronize one or more parameters based on the first synchronization field. In some implementations, aspects of the operations of 1615 may be performed by a SYNC manager 1035 as described with reference to FIG. 10.

In some examples, in 1620, the apparatus may decode the data field of the PPDU based on the one or more parameters. In some implementations, aspects of the operations of 1620 may be performed by a decoding manager 1040 as described with reference to FIG. 10.

Implementation examples are described in the following numbered clauses: The following provides an overview of aspects of the present disclosure:

Aspect 1: A method for wireless communications at a wireless node, comprising: obtaining a physical layer protocol data unit (PPDU) comprising at least a synchronization field and a data field, the synchronization field comprising a sequence of on symbols and off symbols, where the sequence includes three consecutive on symbols or three consecutive off symbols; synchronizing one or more parameters based on the synchronization field; and decoding the data field of the PPDU based on the one or more parameters.

Aspect 2: The method of aspect 1, where the sequence includes three consecutive on symbols and three consecutive off symbols.

Aspect 3: The method of any of aspects 1-2, where the sequence does not include four or more consecutive off symbols or four or more consecutive on symbols.

Aspect 4: The method of any of aspects 1-3, the sequence includes one or more of a base sequence or a logical complement of the base sequence.

Aspect 5: The method of aspect 4, at least one of: the sequence includes a pattern of one or more instances of the base sequence and one or more instances of the logical complement of the base sequence, or the pattern indicates a size of the data field.

Aspect 6: The method of aspects 4, the base sequence includes an equal quantity of off symbols and on symbols.

Aspect 7: The method of any of aspects 4, a length of the base sequence is an even quantity of symbols.

Aspect 8: The method of any of aspects 1-7, a first symbol of the sequence is an on symbol.

Aspect 9: The method of any of aspects 1-8, where the sequence is associated with a first data rate used to communicate the PPDU or a logical complement of the sequence is associated with a second data rate used to communicate the PPDU.

Aspect 10: The method of any of aspects 1-9, further comprising: decoding the sequence via a Manchester decoding algorithm after obtaining the sequence.

Aspect 11: A method for wireless communications at a wireless node, comprising: generating a physical layer protocol data unit (PPDU) comprising at least a synchronization field and a data field, where the synchronization field includes a sequence of on symbols and off symbols, where the sequence includes three consecutive on symbols or three consecutive off symbols; and outputting the PPDU.

Aspect 12: The method of aspect 11, where the sequence includes three consecutive on symbols and three consecutive off symbols.

Aspect 13: The method of any of aspects 11-12, where the sequence does not include four or more consecutive off symbols or four or more consecutive on symbols.

Aspect 14: The method of any of aspects 11-13, the sequence includes one or more of a base sequence or a logical complement of the base sequence.

Aspect 15: The method of aspect 14, at least one of: the sequence includes a pattern of one or more instances of the base sequence and one or more instances of the logical complement of the base sequence, or the pattern indicates a size of the data field.

Aspect 16: The method of aspects 14, the base sequence includes an equal quantity of off symbols and on symbols.

Aspect 17: The method of any of aspects 14, a length of the base sequence is an even quantity of symbols.

Aspect 18: The method of any of aspects 11-17, a first symbol of the sequence is an on symbol.

Aspect 19: The method of any of aspects 11-18, where the sequence in the synchronization field is one of a first candidate sequence associated with a first data rate associated with the PPDU, a second candidate sequence associated with a second data rate associated with the PPDU, or a third candidate sequence associated with a third data rate associated with the PPDU.

Aspect 20: The method of aspect 19, where the first candidate sequence and the second candidate sequence are the same.

Aspect 21: The method of aspect 20, where a length of the first candidate sequence is scaled based on a symbol duration associated with the synchronization field.

Aspect 22: The method of any of aspects 11-21, where the first candidate sequence and the second candidate sequence are different.

Aspect 23: The method of any of aspects 11-22, where the first candidate sequence and the second candidate sequence have different lengths.

Aspect 24: The method of any of aspects 11-23, where the second candidate sequence is a logical complement of the first candidate sequence.

Aspect 25: The method of any of aspects 11-24, where a length of the first candidate sequence, the second candidate sequence, or the third candidate sequence is scaled based at least in part on a symbol duration associated with the synchronization field.

Aspect 26: The method of any of aspects 11-25, where the first candidate sequence, the second candidate sequence, and the third candidate sequence have a same symbol duration, the first candidate sequence, the second candidate sequence, and the third candidate sequence each have different lengths.

Aspect 27: The method of aspect 26, where the first candidate sequence includes at least one of more than one copy of the third candidate sequence, a complement of the third candidate sequence, a reverse ordering of the third candidate sequence, or a bit-wise repetition of the third candidate sequence.

Aspect 28: The method of any of aspects 26-27, where the first candidate sequence, the second candidate sequence, and the third candidate sequence comprise different patterns of on symbols and off symbols.

Aspect 29: The method of any of aspects 26-28, where each of the second candidate sequence and the third candidate sequence is shorter, lengthwise, than the first candidate sequence.

Aspect 30: The method of any of aspects 26-29, where the first candidate sequence and the second candidate sequence comprise a same pattern of on symbols and off symbols and the third candidate sequence is shorter in length than the first candidate sequence.

Aspect 31: The method of any of aspects 26-30, where the first candidate sequence, the second candidate sequence, and the third candidate sequence comprise a same pattern of on symbols and off symbols.

Aspect 32: The method of any of aspects 26-31, where the first candidate sequence and the second candidate sequence have a first symbol duration associated with the synchronization field and the third candidate sequence has a second symbol duration associated with the synchronization field, the first symbol duration is different from the second symbol duration.

Aspect 33: A method for wireless communications at a wireless node, comprising: generating a physical layer protocol data unit (PPDU) comprising at least a synchronization field and a data field, the synchronization field comprising a sequence of on symbols and off symbols, where the sequence includes three consecutive on symbols or three consecutive off symbols; and outputting the PPDU.

Aspect 34: The method of aspect 33, where the sequence includes three consecutive on symbols and three consecutive off symbols.

Aspect 35: The method of any of aspects 33-34, where the sequence does not include four or more consecutive off symbols or four or more consecutive on symbols.

Aspect 36: The method of any of aspects 33-35, the sequence includes one or more of a base sequence or a logical complement of the base sequence.

Aspect 37: The method of aspect 36, at least one of: the sequence includes a pattern of one or more instances of the base sequence and one or more instances of the logical complement of the base sequence, or the pattern indicates a size of the data field.

Aspect 38: The method of aspects 36, the base sequence includes an equal quantity of off symbols and on symbols.

Aspect 39: The method of any of aspects 36, a length of the base sequence is an even quantity of symbols.

Aspect 40: The method of any of aspects 33-39, a first symbol of the sequence is an on symbol.

Aspect 41: The method of any of aspects 33-40, where the sequence is associated with a first data rate used to communicate the PPDU or a logical complement of the sequence is associated with a second data rate used to communicate the PPDU.

Aspect 42: The method of any of aspects 33-41, further comprising: encoding the sequence via a Manchester decoding algorithm after obtaining the sequence.

Aspect 43: A method for wireless communications at a wireless node, comprising: obtaining a physical layer protocol data unit (PPDU) comprising at least a synchronization field and a data field, where the synchronization field includes a sequence of on symbols and off symbols, where the sequence includes three consecutive on symbols or three consecutive off symbols; synchronizing one or more parameters based on the synchronization field; and decoding the data field of the PPDU based on the one or more parameters.

Aspect 44: The method of aspect 43, where the sequence includes three consecutive on symbols and three consecutive off symbols.

Aspect 45: The method of any of aspects 43-44, where the sequence does not include four or more consecutive off symbols or four or more consecutive on symbols.

Aspect 46: The method of any of aspects 43-45, the sequence includes one or more of a base sequence or a logical complement of the base sequence.

Aspect 47: The method of aspect 46, at least one of: the sequence includes a pattern of one or more instances of the base sequence and one or more instances of the logical complement of the base sequence, or the pattern indicates a size of the data field.

Aspect 48: The method of aspects 46, the base sequence includes an equal quantity of off symbols and on symbols.

Aspect 49: The method of any of aspects 46, a length of the base sequence is an even quantity of symbols.

Aspect 50: The method of any of aspects 43-49, a first symbol of the sequence is an on symbol.

Aspect 51: The method of any of aspects 43-49, where the sequence in the synchronization field is one of a first candidate sequence associated with a first data rate associated with the PPDU, a second candidate sequence associated with a second data rate associated with the PPDU, or a third candidate sequence associated with a third data rate associated with the PPDU.

Aspect 52: The method of aspect 51, where the first candidate sequence and the second candidate sequence are the same.

Aspect 53: The method of aspect 52, where a length of the first candidate sequence is scaled based on a symbol duration associated with the synchronization field.

Aspect 34: The method of any of aspects 51-53, where the first candidate sequence and the second candidate sequence are different.

Aspect 55: The method of any of aspects 51-54, where the first candidate sequence and the second candidate sequence have different lengths.

Aspect 56: The method of any of aspects 51-55, where the second candidate sequence is a logical complement of the first candidate sequence.

Aspect 57: The method of any of aspects 51-5, where a length of the first candidate sequence, the second candidate sequence, or the third candidate sequence is scaled based at least in part on a symbol duration associated with the synchronization field.

Aspect 58: The method of any of aspects 51-57, where the first candidate sequence, the second candidate sequence, and the third candidate sequence have a same symbol duration, the first candidate sequence, the second candidate sequence, and the third candidate sequence each have different lengths.

Aspect 59: The method of aspect 58, where the first candidate sequence includes at least one of more than one copy of the third candidate sequence, a complement of the third candidate sequence, a reverse ordering of the third candidate sequence, or a bit-wise repetition of the third candidate sequence.

Aspect 60: The method of any of aspects 58-59, where the first candidate sequence, the second candidate sequence, and the third candidate sequence comprise different patterns of on symbols and off symbols.

Aspect 61: The method of any of aspects 58-60, where each of the second candidate sequence and the third candidate sequence is shorter, lengthwise, than the first candidate sequence.

Aspect 62: The method of any of aspects 58-61, where the first candidate sequence and the second candidate sequence comprise a same pattern of on symbols and off symbols and the third candidate sequence is shorter in length than the first candidate sequence.

Aspect 63: The method of any of aspects 58-62, where the first candidate sequence, the second candidate sequence, and the third candidate sequence comprise a same pattern of on symbols and off symbols.

Aspect 64: The method of any of aspects 58-63, where the first candidate sequence and the second candidate sequence have a first symbol duration associated with the synchronization field and the third candidate sequence has a second symbol duration associated with the synchronization field, the first symbol duration is different from the second symbol duration.

Aspect 65: A wireless node (such as a station) for wireless communication, including one or more transceivers, and a processing system that includes processor circuitry and memory circuitry that stores code, the processing system configured to cause the wireless node to perform the method of any of aspects 1-10, wherein the one or more transceivers are configured to receive the PPDU.

Aspect 66: An apparatus for wireless communications, comprising a processing system that includes processor circuitry and memory circuitry that stores code, the processing system configured to cause the apparatus to perform a method of any of aspects 1-10.

Aspect 67: An apparatus for wireless communications, comprising at least one means for performing a method of any of aspects 1-10.

Aspect 68: A non-transitory computer-readable medium storing code for wireless communications, the code comprising instructions executable by one or more processors to perform a method of any of aspects 1-10.

Aspect 69: A wireless node (such as a station) for wireless communication, including one or more transceivers, and a processing system that includes processor circuitry and memory circuitry that stores code, the processing system configured to cause the wireless node to perform the method of any of aspects 11-32, wherein the one or more transceivers are configured to transmit the PPDU.

Aspect 70: An apparatus for wireless communications, comprising a processing system that includes processor circuitry and memory circuitry that stores code, the processing system configured to cause the apparatus to perform a method of any of aspects 11-32.

Aspect 71: An apparatus for wireless communications, comprising at least one means for performing a method of any of aspects 11-32.

Aspect 72: A non-transitory computer-readable medium storing code for wireless communications, the code comprising instructions executable by one or more processors to perform a method of any of aspects 11-32.

Aspect 73: A wireless node (such as an access point) for wireless communication, including one or more transceivers, and a processing system that includes processor circuitry and memory circuitry that stores code, the processing system configured to cause the wireless node to perform the method of any of aspects 33-42, wherein the one or more transceivers are configured to transmit the PPDU.

Aspect 74: An apparatus for wireless communications, comprising a processing system that includes processor circuitry and memory circuitry that stores code, the processing system configured to cause the apparatus to perform a method of any of aspects 33-42.

Aspect 75: An apparatus for wireless communications, comprising at least one means for performing a method of any of aspects 33-42.

Aspect 76: A non-transitory computer-readable medium storing code for wireless communications, the code comprising instructions executable by one or more processors to perform a method of any of aspects 33-42.

Aspect 77: A wireless node (such as an access point) for wireless communication, including one or more transceivers, and a processing system that includes processor circuitry and memory circuitry that stores code, the processing system configured to cause the wireless node to perform the method of any of aspects 43-64, wherein the one or more transceivers are configured to receive the PPDU.

Aspect 78: An apparatus for wireless communications, comprising a processing system that includes processor circuitry and memory circuitry that stores code, the processing system configured to cause the apparatus to perform a method of any of aspects 43-64.

Aspect 79: An apparatus for wireless communications, comprising at least one means for performing a method of any of aspects 43-64.

Aspect 80: A non-transitory computer-readable medium storing code for wireless communications, the code comprising instructions executable by one or more processors to perform a method of any of aspects 43-64.

Aspect 81: A method for wireless communications at a wireless node, comprising: obtaining a trigger frame; generating, based on the trigger frame, a physical layer protocol data unit (PPDU) comprising at least a first synchronization field and a data field, the first synchronization field comprising a sequence of on-symbols and off-symbols, wherein the sequence does not include four consecutive off-symbols; and outputting the PPDU.

Aspect 82: The method of aspect 81, wherein a symbol duration for a symbol in the PPDU is 2 microseconds

Aspect 83: The method of aspect 81, wherein the sequence does not include eight consecutive off-symbols.

Aspect 84: The method of aspect 81-83, wherein a symbol duration for a symbol in the PPDU is 1 microsecond and the sequence does not include eight consecutive off-symbols based on the symbol duration being 1 microsecond.

Aspect 85: The method of any of aspects 81-84, wherein the sequence comprises one or more of a base sequence or a logical complement of the base sequence.

Aspect 86: The method of aspect 85, wherein the sequence comprises a pattern of one or more instances of the base sequence.

Aspect 87: The method of aspect 85, wherein the sequence comprises a pattern of one or more instances of the logical complement of the base sequence.

Aspect 88: The method of aspect 85, where the sequence comprises a pattern of one or more instances of the base sequence and one or more instances of the logical complement of the base sequence.

Aspect 89: The method of aspects 86-88, wherein the pattern indicates a size of the data field.

Aspect 90: The method of any of aspects 85-89, wherein the base sequence comprises an equal quantity of off symbols and on symbols.

Aspect 91: The method of any of aspects 85-90, wherein a length of the base sequence is an even quantity of symbols.

Aspect 92: The method of any of aspects 85-91, wherein a first symbol of the sequence is an on symbol.

Aspect 93: The method of any of aspects 85-92, wherein the PPDU comprises a second synchronization field.

Aspect 94: A method for wireless communications at a wireless node, comprising: outputting a trigger frame; obtaining a physical layer protocol data unit (PPDU) comprising at least a first synchronization field and a data field, wherein the first synchronization field comprises a sequence of on symbols and off symbols, wherein the sequence does not include four consecutive off-symbols; synchronizing one or more parameters based on the first synchronization field; and decoding the data field of the PPDU based on the one or more parameters.

Aspect 95: The method of aspect 94, wherein a symbol duration for a symbol in the PPDU is 2 microseconds.

Aspect 96: The method of aspect 94, wherein the sequence does not include eight consecutive off-symbols.

Aspect 97: The method of aspect 94-96, wherein a symbol duration for a symbol in the PPDU is 1 microsecond and the sequence does not include eight consecutive off-symbols based on the symbol duration being 1 microsecond.

Aspect 98: The method of any of aspects 94-97, wherein the sequence comprises one or more instances of a base sequence.

Aspect 99: The method of aspects 94-98, wherein the sequence comprises at least one of: one or more instances of a base sequence, one or more instances of a logical complement of the base sequence, one or more instances of a reverse ordering of the base sequence, or one or more instances of a bit-wise repetition of the base sequence.

Aspect 100: The method of aspect 94-99, wherein a symbol duration for an individual symbol in the sequence is scaled to fit a length associated with the sequence.

Aspect 101: The method of aspect 94, wherein the sequence is scaled based on a symbol duration for an individual symbol in the sequence.

Aspect 102: The method of aspect 94, wherein the sequence comprises a pattern of one or more instances of the base sequence and one or more instances of the logical complement of the base sequence, and wherein the pattern indicates a size of the data field.

Aspect 103: The method of aspect 98, wherein the base sequence comprises an equal quantity of off symbols and on symbols.

Aspect 104: The method of any of aspects 98-103, wherein a length of the base sequence is an even quantity of symbols.

Aspect 105: The method of any of aspects 94-104, wherein a first symbol of the sequence is an on symbol.

Aspect 106: The method of any of aspects 94-105, wherein the sequence in the first synchronization field is one of a first candidate sequence associated with a first data rate associated with the PPDU, a second candidate sequence associated with a second data rate associated with the PPDU, or a third candidate sequence associated with a third data rate associated with the PPDU.

Aspect 107: The method of aspect 106, wherein the first candidate sequence and the second candidate sequence are the same.

Aspect 108: The method of any of aspects 106-107, wherein a duration of the first synchronization field is scaled based on a symbol duration.

Aspect 109: The method of any of aspects 106-108, wherein the first candidate sequence and the second candidate sequence have different lengths.

Aspect 110: The method of any of aspects 106-109, wherein a length of the first candidate sequence, the second candidate sequence, or the third candidate sequence is scaled based on a symbol duration.

Aspect 111: The method of any of aspects 106-110, wherein the first candidate sequence, the second candidate sequence, and the third candidate sequence have a same symbol duration, the first candidate sequence, the second candidate sequence, and the third candidate sequence each have different lengths.

Aspect 112: The method of aspect 111, wherein the first candidate sequence comprises at least one of: more than one copy of a base sequence, a complement of the base sequence, a reverse ordering of the base sequence, or a bit-wise repetition of the base sequence.

Aspect 113: The method of any of aspects 111-112, wherein the first candidate sequence, the second candidate sequence, and the third candidate sequence have a same length.

Aspect 114: The method of any of aspects 111-113, wherein the first candidate sequence and the second candidate sequence have a first symbol duration associated with the first synchronization field and the third candidate sequence has a second symbol duration associated with the first synchronization field, the first symbol duration is different from the second symbol duration.

Aspect 115: The method of any of aspects 94-114, wherein the PPDU comprises a second synchronization field.

Aspect 116: The method of aspect 115, wherein the data field comprises a first portion and a second portion, and wherein second synchronization field is between the first portion and the second portion.

Aspect 117: A wireless node (such as a station) for wireless communication, including one or more transceivers, and a processing system that includes processor circuitry and memory circuitry that stores code, the processing system configured to cause the wireless node to perform the method of any of aspects 81-93, wherein the one or more transceivers are configured to receive the trigger frame and transmit the PPDU.

Aspect 118: An apparatus for wireless communications, comprising a processing system that includes processor circuitry and memory circuitry that stores code, the processing system configured to cause the apparatus to perform a method of any of aspects 81-93.

Aspect 119: An apparatus for wireless communications, comprising at least one means for performing a method of any of aspects 81-93.

Aspect 120: A non-transitory computer-readable medium storing code for wireless communications, the code comprising instructions executable by one or more processors to perform a method of any of aspects 81-93.

Aspect 121: A wireless node (such as an access point) for wireless communication, including one or more transceivers, and a processing system that includes processor circuitry and memory circuitry that stores code, the processing system configured to cause the wireless node to perform the method of any of aspects 94-116, wherein the one or more transceivers are configured to transmit the trigger frame and receive the PPDU.

Aspect 122: An apparatus comprising a processing system that includes processor circuitry and memory circuitry that stores code, the processing system configured to cause the apparatus to perform a method of any of aspects 94-116.

Aspect 123: An apparatus comprising at least one means for performing a method of any of aspects 94-116.

Aspect 124: A non-transitory computer-readable medium storing code the code comprising instructions executable by one or more processors to perform a method of any of aspects 94-116.

Aspect 125: A method for wireless communications at a wireless node, comprising: obtaining a physical layer protocol data unit (PPDU) comprising at least a synchronization field and a data field, the synchronization field comprising a sequence of on symbols and off symbols, where the sequence comprises a first portion comprising one or more off symbols and a second portion comprising an equal quantity of on symbols and off symbols; synchronizing one or more parameters based on the synchronization field; and decoding the data field of the PPDU based on the one or more parameters.

Aspect 126: The method of aspect 125, where the first portion comprises at least one of one off symbols, two off symbols, or three off symbols.

Aspect 127: The method of any of aspects 125-126, where the second portion comprises an even quantity of symbols.

Aspect 128: The method of any of aspects 125-127, where the second portion comprises a Manchester encoded sequence.

Aspect 129: The method of any of aspects 125-128, where the sequence is associated with a data rate of 250 kb/s.

Aspect 130: The method of any of aspects 125-129, where a first symbol of the sequence is an off symbol.

Aspect 131: The method of any of aspects 125-130, where the sequence is associated with a first data rate used to communicate the PPDU or a logical complement of the sequence is associated with a second data rate used to communicate the PPDU.

Aspect 132: A wireless node (such as a station) for wireless communication, including one or more transceivers, and a processing system that includes processor circuitry and memory circuitry that stores code, the processing system configured to cause the wireless node to perform the method of any of aspects 125-130, wherein the one or more transceivers are configured to receive the PPDU.

Aspect 133: An apparatus for wireless communications, comprising a processing system that includes processor circuitry and memory circuitry that stores code, the processing system configured to cause the apparatus to perform a method of any of aspects 125-130.

Aspect 134: An apparatus for wireless communications, comprising at least one means for performing a method of any of aspects 125-130.

Aspect 135: A non-transitory computer-readable medium storing code for wireless communications, the code comprising instructions executable by one or more processors to perform a method of any of aspects 125-130.

Aspect 136: A method for wireless communications at a wireless node, comprising: obtaining a physical layer protocol data unit (PPDU) comprising at least a synchronization field and a data field, the synchronization field comprising a sequence of on symbols and off symbols, wherein the sequence comprises a first sequence of on symbols and off symbols associated with a first data rate, a second sequence of on symbols and off symbols associated with a second data rate, or both, wherein the second sequence comprises a logical complement of the first sequence; synchronizing one or more parameters based on the synchronization field; and decoding the data field of the PPDU based on the one or more parameters.

Aspect 137: The method of aspect 136, where the first data rate is 250 kb/s, the second data rate is 1 Mb/s, or both.

Aspect 138: The method of any of aspects 136-137, where a length of the sequence is 32 symbols.

Aspect 139: The method any of aspects 136-138, where the sequence satisfies at least one of a first condition that the sequence does not include four or more consecutive off symbols, four or more consecutive on symbols, or both, a second condition that the sequence comprises an equal quantity of off symbols and on symbols, and a third condition that a first symbol of the first sequence is an off symbol and where a first symbol of the second sequence is an on symbol.

Aspect 140: The method any of aspects 136-139, where the synchronization field further comprises a second sequence of on symbols and off symbols associated with a false alarm rate.

Aspect 141: The method of any of aspects 136-140, where the data field, the synchronization field, or both comprise a chip duration of 2 microseconds.

Aspect 142: A wireless node (e.g., STA), including one or more transceivers, and a processing system that includes processor circuitry and memory circuitry that stores code, the processing system configured to cause the wireless node to perform the method of any of aspects 136-141, where the one or more transceivers are configured to obtain the PPDU.

Aspect 143: An apparatus for wireless communications, comprising a processing system that includes processor circuitry and memory circuitry that stores code, the processing system configured to cause the apparatus to perform a method of any of aspects 136-141.

Aspect 144: An apparatus for wireless communications, comprising at least one means for performing a method of any of aspects 136-141.

Aspect 145: A non-transitory computer-readable medium storing code for wireless communications, the code comprising instructions executable by one or more processors to perform a method of any of aspects 136-141.

Aspect 146: A method for wireless communications at a wireless node, comprising: generating a physical layer protocol data unit (PPDU) comprising at least a synchronization field and a data field, the synchronization field comprising a sequence of on symbols and off symbols, wherein the sequence comprises a first sequence of on symbol and off symbols associated with a first data rate, a second sequence of on symbols and off symbols associated with a second data rate, or both, wherein the second sequence comprises a logical complement of the first sequence; and outputting the PPDU.

Aspect 147: The method of aspect 146, where the first data rate is 250 kb/s, the second data rate is 1 Mb/s, or both.

Aspect 148: The method of any of aspects 146-147, where a length of the sequence is 32 symbols.

Aspect 149: The method any of aspects 146-148, where the synchronization field further comprises a second sequence of on symbols and off symbols associated with a false alarm rate.

Aspect 150: The method of any of aspects 146-149, where the data field, the synchronization field, or both comprise a chip duration of 2 microseconds.

Aspect 151: A wireless node (e.g., AP), including one or more transceivers, and a processing system that includes processor circuitry and memory circuitry that stores code, the processing system configured to cause the wireless node to perform the method of any of aspects 146-150, where the one or more transceivers are configured to output the PPDU.

Aspect 152: An apparatus for wireless communications, comprising a processing system that includes processor circuitry and memory circuitry that stores code, the processing system configured to cause the apparatus to perform a method of any of aspects 146-150.

Aspect 153: An apparatus for wireless communications, comprising at least one means for performing a method of any of aspects 146-150.

Aspect 154: A non-transitory computer-readable medium storing code for wireless communications, the code comprising instructions executable by one or more processors to perform a method of any of aspects 146-150.

Aspect 155: A method for wireless communications at a wireless node, comprising: obtaining a trigger frame; generating, based on the trigger frame, a physical layer protocol data unit (PPDU) comprising at least a synchronization field and a data field, the synchronization field comprising a sequence of on symbols and off symbols, wherein the sequence comprises one or more repetitions of a base sequence; and outputting the PPDU.

Aspect 156: The method of aspect 155, where the base sequence comprises [11010100] and where the sequence comprises three repetitions of the base sequence.

Aspect 157: The method of aspect 155, where the base sequence comprises [111110100110011000010100], where the sequence comprises two repetitions of the base sequence.

Aspect 158: The method any of aspects 155-157, where a length of the base sequence is an even quantity of symbols.

Aspect 159: The method any of aspects 155-158, where the data field and the synchronization field comprise a same chip duration.

Aspect 160: The method any of aspects 155-159, where the data field corresponds to a data rate of 250 kb/s and comprising a chip duration of 1 microsecond, the data field comprising a 1/2 rate binary convolution coding and Manchester coding.

Aspect 161: The method any of aspects 155-159, where the data field corresponds to a data rate of 1 Mb/s and comprising a chip duration of 0.25 microseconds, the data field comprising a 1/2 rate binary convolution coding and Manchester coding.

Aspect 162: The method any of aspects 155-161, further comprising: obtaining, prior to the trigger frame and from a second wireless node, a first frame that indicates a capability of the second wireless node to support a center frequency shift associated with the transmission of the PPDU.

Aspect 163: The method any of aspects 155-162, where the trigger frame comprises an indication of one or more center frequency shift parameters comprising at least an indication of a baseband carrier frequency shift relative to a center of a 20 MHz channel associated with the transmission of the PPDU.

Aspect 164: A wireless node (e.g., STA), including one or more transceivers, and a processing system that includes processor circuitry and memory circuitry that stores code, the processing system configured to cause the wireless node to perform the method of any of aspects 155-163, where the one or more transceivers are configured to obtain the trigger frame and to output the PPDU.

Aspect 165: An apparatus for wireless communications, comprising a processing system that includes processor circuitry and memory circuitry that stores code, the processing system configured to cause the apparatus to perform a method of any of aspects 155-163.

Aspect 166: An apparatus for wireless communications, comprising at least one means for performing a method of any of aspects 155-163.

Aspect 167: A non-transitory computer-readable medium storing code for wireless communications, the code comprising instructions executable by one or more processors to perform a method of any of aspects 155-163.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a,b, or c” is intended to cover: a,b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty. As used herein, a singular noun is not to be construed as being limited to a single item but may refer to one or more items.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless node for wireless communications, comprising:
one or more transceivers; and
a processing system that includes processor circuitry and memory circuitry that stores code, the processing system configured to cause the wireless node to:
receive, via the one or more transceivers, a physical layer protocol data unit (PPDU) comprising at least a synchronization field and a data field, the synchronization field comprising a sequence of on symbols and off symbols, wherein the sequence comprises a first sequence of on symbols and off symbols associated with a first data rate, a second sequence of on symbols and off symbols associated with a second data rate, or both, wherein the second sequence comprises a logical complement of the first sequence;
synchronize one or more parameters based on the synchronization field; and
decode the data field of the PPDU based on the one or more parameters.

2. The wireless node of claim 1, wherein the first data rate is 250 kb/s, the second data rate is 1 Mb/s, or both.

3. The wireless node of claim 1, wherein a length of the sequence is 32 symbols.

4. The wireless node of claim 1, wherein the sequence satisfies at least one of:
a first condition that the sequence does not include four or more consecutive off symbols, four or more consecutive on symbols, or both,
a second condition that the sequence comprises an equal quantity of off symbols and on symbols, and
a third condition that a first symbol of the first sequence is an off symbol and wherein a first symbol of the second sequence is an on symbol.

5. The wireless node of claim 1, wherein the synchronization field further comprises a second sequence of on symbols and off symbols associated with a false alarm rate.

6. The wireless node of claim 1, wherein the data field, the synchronization field, or both comprise a chip duration of 2 microseconds.

7. A wireless node for wireless communications, comprising:
one or more transceivers; and
a processing system that includes processor circuitry and memory circuitry that stores code, the processing system configured to cause the wireless node to:
generate a physical layer protocol data unit (PPDU) comprising at least a synchronization field and a data field, the synchronization field comprising a sequence of on symbols and off symbols, wherein the sequence comprises a first sequence of on symbol and off symbols associated with a first data rate, a second sequence of on symbols and off symbols associated with a second data rate, or both, wherein the second sequence comprises a logical complement of the first sequence; and
transmit, via the one or more transceivers, the PPDU.

8. The wireless node of claim 7, wherein the first data rate is 250 kb/s, the second data rate is 1 Mb/s, or both.

9. The wireless node of claim 7, wherein a length of the sequence is 32 symbols.

10. The wireless node of claim 7, wherein the synchronization field further comprises a second sequence of on symbols and off symbols associated with a false alarm rate.

11. The wireless node of claim 7, wherein the data field, the synchronization field, or both comprise a chip duration of 2 microseconds.

12. A wireless node for wireless communications, comprising:
one or more transceivers; and
a processing system that includes processor circuitry and memory circuitry that stores code, the processing system configured to cause the wireless node to:
receive, via the one or more transceivers, a trigger frame;
generate, based on the trigger frame, a physical layer protocol data unit (PPDU) comprising at least a synchronization field and a data field, the synchronization field comprising a sequence of on symbols and off symbols, wherein the sequence comprises one or more repetitions of a base sequence; and
transmit, via the one or more transceivers, the PPDU.

13. The wireless node of claim 12, wherein the base sequence comprises [11010100] and wherein the sequence comprises three repetitions of the base sequence.

14. The wireless node of claim 12, wherein the base sequence comprises [111110100110011000010100], wherein the sequence comprises two repetitions of the base sequence.

15. The wireless node of claim 12, wherein a length of the base sequence is an even quantity of symbols.

16. The wireless node of claim 12, wherein the data field and the synchronization field comprise a same chip duration.

17. The wireless node of claim 12, wherein the data field corresponds to a data rate of 250 kb/s and comprising a chip duration of 1 microsecond, the data field comprising a 1/2 rate binary convolution coding and Manchester coding.

18. The wireless node of claim 12, wherein the data field corresponds to a data rate of 1 Mb/s and comprising a chip duration of 0.25 microseconds, the data field comprising a 1/2 rate binary convolution coding and Manchester coding.

19. The wireless node of claim 12, wherein the processing system is further configured to cause the wireless node to:
receive, via the one or more transceivers, prior to the trigger frame, and from a second wireless node, a first frame that indicates a capability of the second wireless node to support a center frequency shift associated with the transmission of the PPDU.

20. The wireless node of claim 12, wherein the trigger frame comprises an indication of one or more center frequency shift parameters comprising at least an indication of a baseband carrier frequency shift relative to a center of a 20 MHz channel associated with the transmission of the PPDU.
